(19) United States
(12) Patent Application Publication
(10) Pub. No.: US 2024/0051727 A1
(43) Pub. Date: Feb. 15, 2024

(54) Modular Meal System and Method of Making a Modular Meal System

(71) Applicant: H.J. Heinz Company Brands LLC, Pittsubrgh, PA (US)

(72) Inventors: Lauren Knezovich, Cranberry Township, PA (US); Josephine Pokrzywa, Chicago, IL (US); Mikhail Gershenzon, Murrysville, PA (US); Charles Wang, Wexford, PA (US); Luke Wallace, Pittsburgh, PA (US); Bayete Milhomme, Bakersfield, CA (US); Sean Magee, Chicago, IL (US); Audrey Burger, Chicago, IL (US); Ashleigh Gibson, Chicago, IL (US); Cornelia Diana Vasile, Wexford, PA (US); Kyra Lynn Selner, Pittsburgh, PA (US); Rachel Russell, Hurst, TX (US); John Frederick Vakiener, Penfield, NY (US)

(21) Appl. No.: 18/381,429

(22) Filed: Oct. 18, 2023

Related U.S. Application Data
(63) Continuation of application No. 17/358,335, filed on Jun. 25, 2021.
Application No. 17/358,335 is a continuation of application No. PCT/US2021/036362, filed on Jun. 8, 2021.
(60) Provisional application No. 63/163,492, filed on Mar. 19, 2021.
(60) Provisional application No. 63/036,544, filed on Jun. 9, 2020.

(51) Int. Cl. B65D 81/34; A23L 13/00; A23L 13/60; A23L 19/00; A23L 19/12; A23L 7/109; A23L 13/50; A21D 13/00; B65B 25/00

(52) U.S. Cl. CPC B65D 81/3453; A23L 13/06; A23L 13/67; A23L 19/03; A23L 19/14; A23L 7/111; A23L 13/55; A21D 13/00; B65B 25/001; A23V 2002/00; B65D 2581/3416

(57) ABSTRACT

An example modular meal system includes two or more modular meal components. Example modular meal components include a tray, a meal component disposed within the tray, and a sauce component disposed within the tray. The meal component is selected from a protein component, a starch component, a vegetable component, an appetizer component, and a dessert component. Each modular meal component is configured and/or formulated to reach at least 165° F. or at least 167° F. when heated from frozen for a heating time period within the range of from about 20 minutes to about 60 minutes and at a heating temperature within the range of about 350° F. to about 450° F.

### CROSS REFERENCE TO RELATED APPLICATIONS

This is a continuation of U.S. application Ser. No. 17/358,335, filed Jun. 25, 2021, which is a continuation of PCT/US2021/036362, filed Jun. 8, 2021, which claims the benefit of U.S. Provisional Application No. 63/163,492, filed Mar. 19, 2021, and claims the benefit of U.S. Provisional Application No. 63/036,544, filed Jun. 9, 2020, all of which are incorporated herein by reference in their entireties.

### FIELD

This application relates generally to frozen meals.

### BACKGROUND

Consumers want to cook delicious, balanced meals. However, it can be difficult to make several hot dishes and get them all to the table at the same time, particularly for dinner on busy weeknights. Some consumers do not want to cook a multi-component meal and want a convenient meal they can feel that they can feel good about serving to their families. Other consumers like to cook multi-component meals but do not always have the time to do so. On certain nights of the week, time constraints cause these consumers to look for an easy and quick full meal solution without much preparation or clean up. For example, consumers with young children may not want to cook a multi-component meal and/or may not always have the time to cook a multi-component meal.

### BRIEF DESCRIPTION OF THE DRAWINGS

FIG. 1A and FIG. 1B are cross-sectional views of an exemplary modular meal component;

FIGS. 2A and 2B are black and white reproductions of originally colored photographs of an example of 0.5 inch (maximum) vertical-cut chicken breast strips;

FIGS. 3A and 3B are black and white reproductions of originally colored photographs of an example of 0.5 inch (target) lateral or horizontal cut chicken breast;

FIGS. 4A and 4B are black and white reproductions of originally colored photographs of an example of 0.5 inch (maximum) lateral or horizontal cut chicken breast;

FIG. 5 is a graph of heating curves of potential sub-components illustrating temperature of the potential sub-components (° F., Y axis) over time (minutes, X axis); and

FIG. 6 through FIG. 8 are graphs of heating curves of trays with different surface areas illustrating temperature of a meal component within the trays (° F., Y axis) over time (minutes, X axis).

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein is a modular meal component. Each modular meal component is provided in a separate tray. In one approach, each modular meal component includes a protein component, a starch component, or a vegetable component. In one aspect, two or more of the modular meal components may be selected by a consumer, cooked by the consumer, and combined by the consumer to provide a meal. For example, the consumer can select a modular meal component including a protein component, a modular meal component including a starch component, and a modular meal component including a vegetable component. The modular meal components may be cooked and then combined by the consumer to provide a complete meal. In one aspect, the modular meal components can be cooked from frozen in a conventional oven by a consumer at the same time, at the same temperature, and for the same length of time. In another approach, the modular meal component may include an appetizer or a dessert. The appetizer component and dessert components may be used alone or combined with the other modular meal components (e.g., protein, starch, and vegetable components) to provide a meal.

Each modular meal component is also configured and/or formulated to reach at least 165° F. or at least 167° F. when heated from frozen for a heating time period within the range of from about 20 minutes to about 60 minutes and at a heating temperature within the range of about 350° F. to about 450° F. in a conventional oven. As such, the modular meal components may be mixed and matched by the consumer to create a complete meal. In another aspect, a set of modular meal components can be cooked from frozen in a conventional oven by a consumer at the same time, at the same temperature, and for the same length of time to provide a convenient meal.

In one approach, the modular meal component includes: a tray; a meal component disposed within the tray, the meal component being selected from a protein component, a starch component, a vegetable component, a dessert component, and an appetizer component; and a sauce component disposed within the tray; wherein the modular meal component is configured and/or formulated to reach at least 165° F. or at least 167° F. when heated from frozen for a heating time period within the range of from about 20 minutes to about 60 minutes and at a heating temperature within the range of about 350° F. to about 450° F., such as with a conventional oven.

In another approach, the modular meal component includes: a tray; and a meal component disposed within the tray, the meal component being selected from a protein component, a starch component, a vegetable component, a dessert component, and an appetizer component; wherein the modular meal component is configured and/or formulated to reach at least 165° F. or at least 167° F. when heated from frozen with one or more other modular meal components for a same heating time period and at a same heating temperature, the same heating time period being within the range of from about 20 minutes to about 60 minutes and the same heating temperature being within the range of about 350° F. to about 450° F.

In another aspect, the modular meal component includes a flexible film is used to hermetically seal the meal component and the sauce component within the tray.

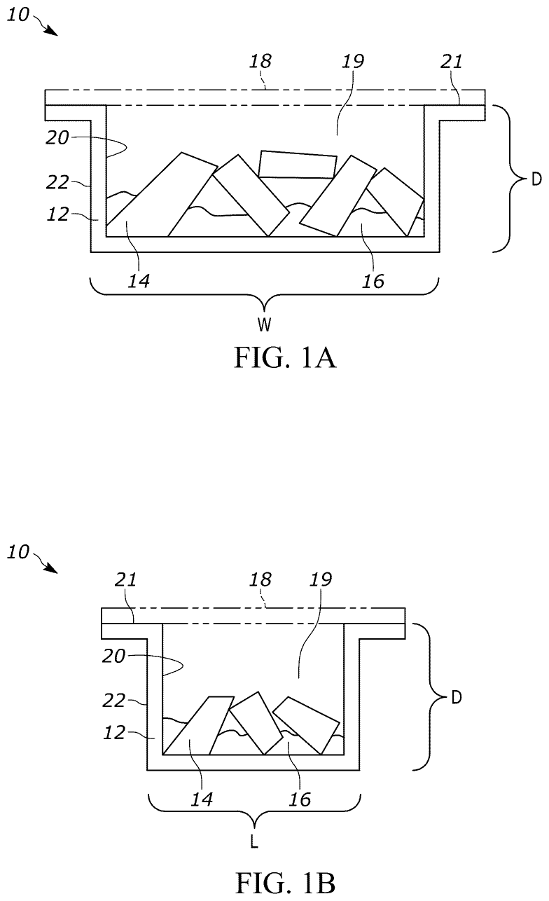

One example of the modular meal component 10 is shown in FIG. 1A and FIG. 1B. As shown in FIG. 1A and FIG. 1B, one example of the modular meal component 10 includes the tray 12, the meal component 14, and the sauce component 16. As also shown in FIG. 1A and FIG. 1B, the modular meal component 10 may also include a flexible film 18.

The modular meal component 10 includes the tray 12. The tray 12 includes a cavity 19 and a peripheral flange 21. The meal component 14 and the sauce component 16 are contained within the cavity 19, which defines an interior portion of the tray 12. By one approach, the peripheral flange 21 surrounds the cavity 19 when viewed from above. An exterior portion 22 of the tray 12 may extend from the peripheral flange 21.

The tray 12 may be any shape and/or size that is suitable to contain the meal and sauce components 14, 16. In some approaches, the shape and/or size of the tray 12 may be selected to facilitate heating the meal and sauce components 14, 16. In some examples, the cavity 19 of the tray 12 defines a space in the shape of a cube, a cuboid, or the like. In other examples, the space defined by the cavity 19 is similar to a cube or a cuboid but has rounded or curved edges. In still other examples, the cavity 19 of the tray 12 may define a space in the shape of a torus, a half-torus, a toroid, or the like. In some embodiments, the cavity 19 of the tray 12 may include a base and a sidewall. The sidewall extends from the peripheral flange 21 to the base and forms at least a portion of the cavity 19. In one approach the sidewall may be linear. In another approach, the sidewall may be sloped or curved. In one approach, the sidewall may be perpendicular or substantially perpendicular to the base. In another approach, the sidewall may meet the base at angle within the range of from about 160° to about 20°, the range of from about 140° to about 40°, the range of from about 120° to about 60°, or the range of from about 100° to about 80°. In some embodiments, the cavity 19 of the tray 12 is reinforced with ribbing.

In some embodiments, the peripheral flange 21 may be generally rectangular in shape with two lengthwise sides and two end sections. In addition, the peripheral flange 21 may include beveled corners.

As shown in FIG. 1A, the width W may measure a first cross-section of the tray 12. In an example, the first cross-section of the tray 12 may correspond with a y-axis of a coordinate system. As shown in FIG. 1B, the length L may measure a second cross-section of the tray 12. The second cross-section of the tray 12 may be perpendicular to the first cross-section of the tray 12. In an example, the second cross-section of the tray 12 may correspond with an x-axis of a coordinate system. As shown in FIGS. 1A and 1B, the depth D may measure a third cross-section of the tray 12. The third cross-section of the tray 12 may be perpendicular to both the first and second cross-sections of the tray 12. In an example, the third cross-section of the tray 12 may correspond with a z-axis of a coordinate system.

In some embodiments, the tray 12 may have the same or substantially the same width W at each point along the depth D of the tray 12. In other embodiments, the tray 12 may have different widths W at different points along the depth D of the tray 12. In one example, the width W at the top of the tray 12 by the peripheral flange 21 may be greater than the width W at the bottom of the tray 12 by the base. In some embodiments, the tray 12 may have the same or substantially the same length L at each point along the depth D of the tray 12. In other embodiments, the tray 12 may have different lengths L at different points along the depth D of the tray 12. In one example, the length L at the top of the tray 12 by the peripheral flange 21 may be greater than the length L at the bottom of the tray 12 by the base. In some embodiments, the tray 12 may have the same or substantially the same depth at each point along the width W and the length L of the tray 12.

In some examples, the tray 12 has a width W within the range of about 4 to about 16 inches, in another aspect about 5 inches to about 10 inches. In other examples, the tray 12 has a width W of about 9.75 inches or a width W of about 8.5 inches. In some examples, the tray 12 has a length L within the range of about 4 to about 16 inches, in another aspect about 5 inches to about 8 inches. In still other examples, the tray 12 has a length L of about 7.75 inches or a width W of about 6.5 inches. In some examples, the tray 12 has a depth D within the range of about 1 inch to about 5 inches, in another aspect about 1 inch to about 3 inches. In yet other examples, the tray 12 has a depth D of about 1.75 inches. In some examples, the tray 12 has a width W within the range of about 4 to about 16 inches, in another aspect about 5 inches to about 10 inches; a length L within the range of about 4 to about 16 inches, in another aspect about 5 inches to about 8 inches; and a depth D within the range of about 1 inch to about 5 inches, in another aspect about 1 inch to about 3 inches. In other examples, the tray 12 has a width W at the top of the tray 12 of about 9.75 inches, a width W at the bottom of the tray 12 of about 8.5 inches, a length L at the top of the tray 12 of about 7.75 inches, a length L at the bottom of the tray 12 of about 6.5 inches, and a depth D of about 1.75 inches.

In some embodiments, the tray 12 has a base surface area within the range of about 35 square inches to about 80 square inches (“sq in”). In some embodiments, the tray 12 has a base surface area within the range of about 40 sq in to about 75 sq in, about 45 sq in to about 65 sq in, or about 50 sq in to about 60 sq in. In some examples, when the tray 12 has a base surface area within these ranges, the tray 12 may be able to efficiently conduct heat to the meal component 14 and/or the sauce component 16. As such, the base surface area of the tray 12 can be selected to improve the heating efficiency of the modular meal component 10.

In some approaches, the tray 12 may be selected so that it may fit on commercial shelf space (e.g., a 10-inch by 9-inch shelf space) and provide sufficient base surface area to enable the meal component 14 and the sauce component 16 to reach a temperature at least 165° F. when heated from frozen for the heating time period and at the heating temperature.

In some examples, the tray 12 has a thickness within the range of about 75 nm to about 175 nm. In some examples, the tray 12 has a thickness within the range of about 100 nm to about 150 nm, or about 100 nm to about 120 nm. In some examples, the tray 12 may be coated and may have a total thickness of the tray and coating within the range of about 100 μm to about 200 μm, about 125 μm to about 180 μm, or about 125 μm to about 160 μm.

In one approach, the tray 12 includes aluminum. In one particular aspect, the tray 12 is an aluminum tray. In another approach, the tray 12 is a paper tray coated with aluminum.

In some examples, the tray 12 includes crystallized polyethylene terephthalate (CPET). In one particular aspect, the tray 12 is a CPET tray. In another approach, the tray 12 is a paper tray coated with CPET.

In some examples, the tray 12 includes paper. In some of these examples, the tray 12 is a paper tray with no coating. In others of these examples, the tray 12 is a paper tray coated with aluminum. In still others of these examples, the tray 12 is a paper tray coated with polyethylene terephthalate (PET). In any of these examples, the paper tray may be made from paperboard.

When the tray 12 includes aluminum, the aluminum may have a coating thereon. The coating may prevent the aluminum from reacting with acidic substances placed in the tray 12. In some examples, the coating may be clear and/or colorless. In some examples, the coating may be opaque.

In some embodiments, the tray 12 includes an epoxy coating. The epoxy coating may be any color. In some examples, the tray 12 includes a black and gold epoxy lacquer coating. The black and gold epoxy lacquer coating may include a black epoxy lacquer and a gold epoxy lacquer. In some examples the black and gold epoxy lacquer coating is Alucoat® CS, from Coppice Alupack Ltd. In some embodiments, the tray 12 is an aluminum tray coated with a black and gold epoxy lacquer. In some examples, when the tray 12 is an aluminum tray coated with a black and gold epoxy lacquer, the tray 12 may enable high heat conductivity to the meal component 14 and the sauce component 16. In some examples, when the tray 12 is an aluminum tray coated with a black and gold epoxy lacquer, oxidation of the tray 12 may be reduced or prevented (as compared to an aluminum tray without a black and gold epoxy lacquer coating).

In some examples, the tray 12 includes a silver coating. In some examples, the tray 12 is an aluminum tray coated with the silver coating.

When the tray 12 is a paper tray coated with aluminum or an aluminum tray coated with a black and gold epoxy lacquer, the coating may be disposed on the interior portion 20 of the tray 12 and/or on the exterior portion 22 of the tray 12. When the coating is disposed on the interior portion 20 of the tray 12, at least part of the coating is disposed between the paper or aluminum (respectively) and the meal and sauce components 14, 16. When the coating is disposed on the exterior portion 22 of the tray 12, the paper or aluminum (respectively) is disposed between at least part of the coating and the meal and sauce components 14, 16.

In one aspect, the coating (e.g., the aluminum coating or the black and gold epoxy lacquer coating) may be a continuous coating or a patterned coating. When the coating is a continuous coating, the coating may cover all or substantially all of the interior portion 20 of the tray 12 and/or on the exterior portion 22 of the tray 12. The coating may cover substantially all of the interior portion 20 and/or on the exterior portion 22 when at least 80%, at least 85%, at least 90%, at least 95%, at least 98%, or at least 99% of the portion(s) is/are covered by the coating. When the coating is a patterned coating any suitable pattern may be used. Examples of the pattern may include grid patterns, plus “+” sign or cross patterns, fuse or star patterns, lined patterns, circular patterns, herringbone patterns, chevron patterns, Greek key patterns, gingham patterns, houndstooth patterns, quatrefoil patterns, scale patterns, and other geometric patterns.

In some examples, the coating (e.g., the aluminum coating or the black and gold epoxy lacquer coating) has a coating thickness within the range of about 50 μm to about 500 μm. In other examples, the coating has a coating thickness within the range of about 110 μm to about 180 μm, within the range of about 140 μm to about 200 μm, or the range of from about 160 μm to about 180 μm. In some examples, the black and gold epoxy lacquer coating has a coating thickness within the range of about 3 g/m² and 6 g/m².

The modular meal component 10 also includes the meal component 14. In some approaches, the meal component 14 is disposed within the tray 12. In some approaches, at least some of the meal component 14 is directly disposed within the tray 12. At least some of the meal component 14 may be considered to be directly disposed within the tray 12 when there is no barrier or other structure between at least some of the meal component 14 and the tray 12.

In some examples, the meal component 14 is disposed within the tray 12 and is selected from a protein component, a starch component, or a vegetable component. In some approaches, the meal component may include a combination of two or more of those components. In other examples, the meal component 14 may be selected from an appetizer component or a dessert component.

In some examples, the meal component 14 comprises a protein component. Any suitable protein component may be used in the modular meal component 10. Examples of suitable protein components include chicken, beef, pork, finfish, shellfish, and plant-based protein sources. Chicken may include drumstick, wing, thigh and/or breast meat. Beef may include chuck, shank, brisket, short plate, flank, loin, sirloin, the round, and/or rib meat. Pork may include shoulder, loin, belly, and/or leg meat. Finfish may be tilapia, salmon, cod, haddock, tuna, flounder, halibut, catfish, snapper, whiting, ocean perch, grouper, seabass, redfish, whitefish, pollock, etc. Shellfish may be shrimp, crayfish, crab, lobster, clams, scallops, oysters, mussels, etc. Plant-based protein sources include tofu, seitan, textured vegetable protein, tempeh, and the like, as well as plant-based versions of hot dogs, sausages, burgers, cutlets, patties, roasts, etc.

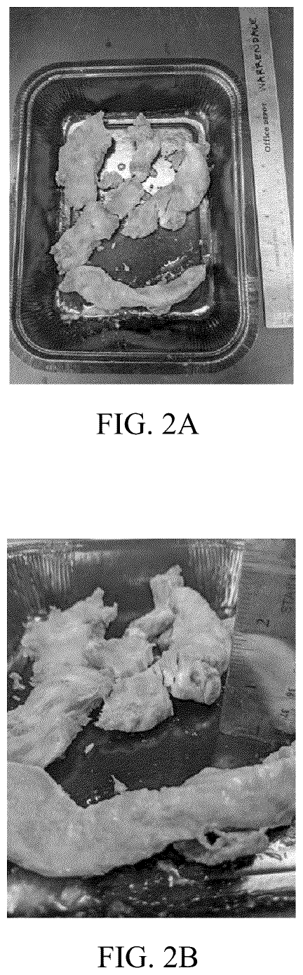

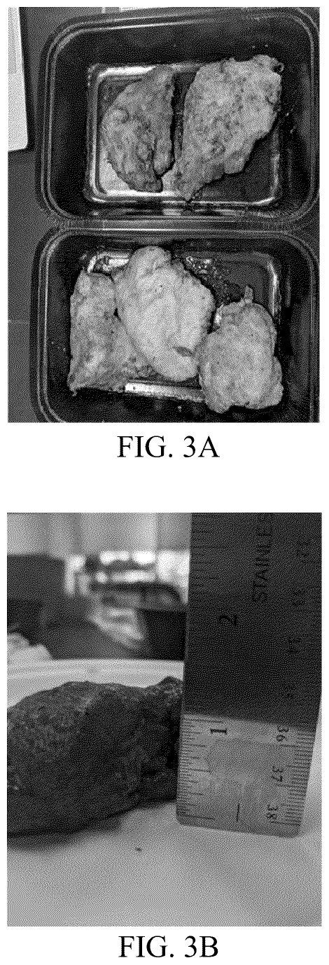

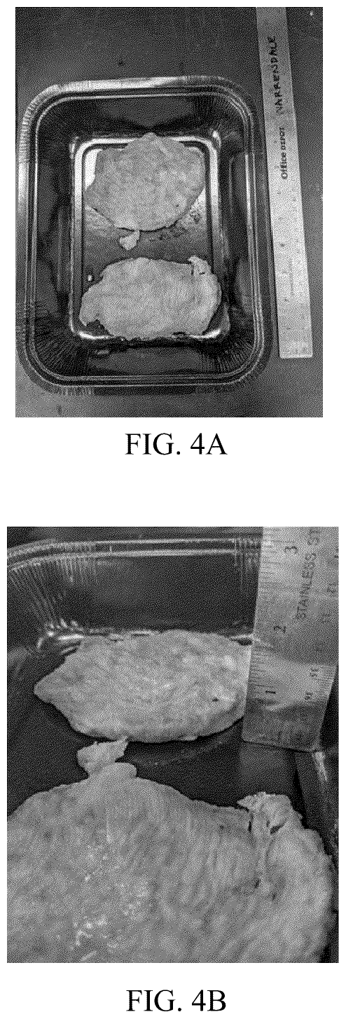

The protein component may be cut in any suitable way. At least in some approaches, the protein component is cut and sized to allow for thorough heating (e.g., to reach an internal temperature of at least 165° F.) in the allotted cooking time. In some examples, the protein component may be cut vertically in strips rather than laterally or horizontally. An example of 0.5 inch (maximum) vertical-cut chicken breast strips is shown in FIG. 2A and FIG. 2B. An example of 0.5 inch (target) lateral or horizontal cut chicken breast is shown in FIG. 3A and FIG. 3B, and an example of 0.5 inch (maximum) lateral or horizontal cut chicken breast is shown in FIG. 4A and FIG. 4B. In some examples, the vertical-cut strips of the protein component have a diameter of about 0.75 inches or about 0.5 inches. The protein component may further include a sauce, if desired.

In some examples, the meal component 14 comprises a starch component. Any suitable starch component may be used in the modular meal component 10. Examples of suitable starch components include potatoes, pasta, rice, and bread. Potatoes may include red bliss, russets, Yukon gold, la ratte, kennebec, cranberry red, all blue, red thumb, Russian banana, German butterball, purple majesty, rounded red potatoes, sweet potatoes, etc. Pasta may include fettuccine, orecchiette, tortellini, linguine, farfalle (also referred to as bowtie), rigatoni, penne, ziti, ravioli, fusilli, conchiglie (also referred to as shells), macaroni, gemelli, rice noodles, Lo Mein noodles, etc. Rice may include brown rice, jasmine rice, wild rice, basmati, black rice, white rice, egg fried rice, etc. Bread may include white bread, French bread, naan, biscuits, cornbread, cheese and garlic bread, rolls, etc. The starch component may further include a sauce, if desired.

In some examples, the meal component 14 comprises a vegetable component. Any suitable vegetable component may be used in the modular meal component 10. Examples of suitable vegetable components include broccoli, green beans, asparagus, corn, carrots, cauliflower, Brussel sprouts, edamame, red bell pepper, green bell pepper, etc. The vegetable component may further include a sauce, if desired.

In some examples, the meal component 14 is the protein component, and the protein component is selected from chicken, beef, pork, finfish, shellfish, plant-based protein, and a combination thereof; or the meal component 14 is the starch component, and the starch component is selected from potatoes, pasta, rice, bread, and a combination thereof; or the meal component 14 is the vegetable component, and the vegetable component is selected from broccoli, green beans, asparagus, corn, carrots, cauliflower, Brussel sprouts, edamame, red bell pepper, green bell pepper, and a combination thereof.

In some examples, the meal component 14 does not include any artificial ingredients. In these examples, the meal component 14 does not include any artificial flavor, artificial sweetener, artificial food coloring, or artificial preservatives.

In some examples, the meal component 14 is provided in individual pieces that are separated by air pockets. In some of these examples, the meal component 14 comprises a protein component. In an example, the protein component being cut vertically in strips rather than laterally or horizontally may enable pieces of the protein component to be separated by air pockets, thereby improving the rate of heating the protein component.

In some examples, the modular meal component 10 includes 3 to 6 servings of the meal component 14. In other examples, the modular meal component 10 includes 4 to 6 servings of meal component 14. In still other examples, the modular meal component 10 includes 5 servings of meal component 14. In any of these examples, the size of a serving may correspond to the serving size set by the USDA for the particular meal component 14. In some examples, the modular meal component 10 includes from about 90 g to about 1170 g of the meal and sauce components 14, 16.

The modular meal component 10 may also include the sauce component 16. As used herein, the sauce component refers to any food component(s) that is/are liquid at 150° F. In some examples, the sauce component 16 may be characterized as a toss or a drizzle. In some embodiments, the sauce component 16 may be absorbed by the meal component 14. In these embodiments, the sauce component 16 may be partially absorbed (e.g., greater than 0 wt % to less than 90 wt % of the sauce component is absorbed), substantially absorbed (e.g., 90 wt % to less than 100 wt % of the sauce component is absorbed), or completely absorbed (e.g., 100 wt % of the sauce component is absorbed) by the meal component 14. In these embodiments, the sauce component 16 may be absorbed by the meal component 14 before and/or during the cooking of the modular meal component 10. In other embodiments, the sauce component 16 is not absorbed (e.g., 0 wt % of the sauce component is absorbed) by the meal component 14.

In some approaches, the sauce component 16 is disposed within the tray 12. In some approaches, at least some of the sauce component 16 is directly disposed within the tray 12. At least some of the sauce component 16 may be considered to be directly disposed in the tray 12 when there is no barrier or other structure between at least some of the sauce component 16 and the tray 12.

Any suitable sauce component 16 may be used in the modular meal component 10. In some examples, the sauce component 16 includes one or more of a cheese sauce, a marinara sauce, a sweet and sour sauce, a barbeque sauce, a gravy, a tartar sauce, a mushroom sauce, a pesto sauce, a cream sauce, a fajita sauce, a teriyaki sauce, milk, honey, oil, butter, lemon juice, lime juice, and combinations thereof. In some examples, the oil may be soybean oil, olive oil, canola oil, coconut oil, grapeseed oil, safflower oil, etc. At least in one approach, the oil and/or butter is selected to provide the desired melting profile for the sauce component. For example, a ratio of butter to oil may be selected to provide a desired melting profile for the sauce component. In one aspect, the sauce component may include a higher amount of saturated fat than non-saturated fat when it is desired to slow the rate of heating of the sauce component.

In some examples, the sauce component 16 includes saturated fat in an amount within the range of about 7 wt % to about 9 wt % (based on the total weight of the sauce component 16). In some of these examples, the sauce component 16 is the cheese sauce. In others of these examples, the sauce component 16 is the cheese sauce and the meal component 14 is pasta.

In some examples, the sauce component 16 includes unsaturated fat in an amount within the range of about 12 wt % to about 22 wt % (based on the total weight of the sauce component 16). In some of these examples, the sauce component 16 is the cheese sauce. In others of these examples, the sauce component 16 is the cheese sauce and the meal component 14 is pasta.

In some approaches, the sauce component 16 has a total fat content within the range of 0 g to about 25 g, per 100 g of the sauce component 16. In some approaches, the sauce component 16 has a total fat content within the range of 0 g to about 10 g, 0 g to about 5 g, about 2 g to about 10 g, about 2 g to about 5 g, about 5 g to about 15 g, about 10 g to about 25 g, about 10 g to about 20 g, or about 15 g to about 20 g, per 100 g of the sauce component 16. In some approaches, the sauce component 16 comprises a cheese sauce (e.g., a mac and cheese sauce) and has a total fat content within the range of about 10 g to about 25 g, or about 15 g to about 20 g, per 100 g of the sauce component 16. In some embodiments, it has been unexpectedly found that increasing the total fat content of the sauce component 16 may increase the ability of the sauce component 16 to conduct heat to the meal component 14. As such, the fat content of sauce component 16 can be specifically selected to provide the necessary heat conductivity to a particular modular meal component so that it fully cooks (i.e., to an internal temperature of above 165° F.) within the selected cook time and cook temperature. In this respect, the fat content of the sauce component 16 can be increased or decreased as needed to achieve the desired cooking parameters. Exemplary ingredients that may be included to impact the total fat content include, for example, vegetable oil, butter, milk, whole milk, half & half milk, cream, butter fat, condensed milk, and combinations thereof. The type of food ingredient that may be used to achieve the desired fat content of the sauce component 16 is not particularly limited and will depend in large part on the desired flavor, viscosity, and type of sauce being made.

In some approaches, the sauce component 16 has a total sugar content (by dry weight of the sugar) within the range of 0 g to about 30 g, per 100 g of the sauce component 16. As used herein, the term “sugar” is intended to have an inclusive meaning, including, for example, monosaccharides, disaccharides, polysaccharides, fructose, dextrose, corn syrup solids, corn syrup, maple syrup, brown rice syrup, invert syrup, agave, honey, mizuame, sucrose, glucose, lactose, molasses, maltose, galactose, and combinations thereof, in either liquid or solid form. In some approaches, sugar in solid or dry form may be desired. The amount of sugar included may be impacted, at least in part, by the total solids content of the remaining ingredients of the sauce component 16. For instance, when the remaining ingredients of the sauce component 16 have a generally low solids content, sugar may be added to increase the total solids of the sauce component 16 to achieve a desired total solids content. The amount of sugar included may also be impacted, at least in part, by the flavor of the sauce component 16. For instance, the sugar content may be increased or decrease to achieve a desired taste or flavor. In some approaches, the sauce component 16 has a total sugar content within the range of 0 g to about 10 g, 0 g to about 5 g, about 15 g to about 30 g, or about 20 g to about 25 g, per 100 g of the sauce component 16. In some examples, when the sauce component 16 has a total sugar content within these ranges, the sauce component 16 has a desirable viscosity, total solids content, and flavor. Increasing the sugar content may also decrease the water activity of the sauce component 16 to achieve desired water activity values.

Similarly, other ingredients, such as starch, protein powder, milk powder, whey protein, cheese, cheese powder, salt, milk solids, and tomato paste—depending in part on the flavor profile of the sauce component—may be included to increase the total solids content and to achieve a desirable viscosity, which may improve the heat conductivity of the sauce component 16. These ingredients may also decrease the water activity of the sauce component 16. The type of food ingredient that may be used to achieve the desired total solids content of the sauce component 16 is not particularly limited and will depend in large part on the desired flavor, viscosity, and type of sauce being made.

In some examples, the sauce component 16 includes starch in an amount within the range of about 0.5 wt % to about 2.5 wt %, about 0.75 to about 2.0 wt %, or about 1 wt % to about 1.5 wt % (based on the total weight of the sauce component 16). In other examples, the sauce component 16 includes starch in an amount within the range of 1 wt % to 1.25 wt % (based on the total weight of the sauce component 16). For example, one or more of arrowroot starch, corn starch, tapioca flour, potato starch, resistant starch, or modified starch, can be included. Such modifications generally include acid modifications or enzyme modifications. For example, suitable starches include granular cookup starches, crosslinked starches, substituted starches, and starches that are both crosslinked and substituted. The starch selected will depend in part on the desired viscosity of the sauce component 16.

In some approaches, the sauce component 16 has a total protein content within the range of 0 g to about 15 g, per 100 g of the sauce component 16. In some approaches, the sauce component 16 has a total protein content within the range of 0 g to about 10 g, 0 g to about 5 g, per 100 g of the sauce component 16.

In some embodiments, the sauce component 16 has a total solids content within the range of about 10% to about 45%, when measured at 70° F. In some embodiments, the sauce component 16 has a total solids content within the range of about 10% to about 40%, about 10% to about 35%, about 10% to about 30%, about 10% to about 20%, about 15% to about 20%, about 15% to about 25%, about 20% to about 45%, about 20% to about 30%, about 25% to about 45%, about 30% to about 45%, about 30% to about 40%, about 35% to about 45%, or about 40% to about 45%, when measured at 70° F. The total solids content can be adjusted as needed to achieve a desired viscosity and heat conductivity characteristics during cooking in a given modular meal component. In some embodiments, the total solids content of the sauce component 16 may be measured by a refractometer. In some embodiments, the percentage of total solids of the sauce component 16 may be based on the total weight of the sauce component.

In some examples, the sauce component 16 has a viscosity within the range of about 480 centipoise (cP) to about 1850 cP at room temperature (e.g., 68° F. to 75° F., or 70° F.). In some of these examples, the viscosity of the sauce component 16 is measured with a Brookfield DV3T viscometer using a H2 spindle, at 10 rotations per minute (RPM) and room temperature (e.g., 68° F. to 75° F., or 70° F.). In some of these examples, the sauce component 16 is the cheese sauce. In others of these examples, the sauce component 16 is the cheese sauce and the meal component 14 is broccoli. In still others of these examples, the sauce component 16 includes olive oil. In yet others of these examples, the sauce component 16 includes olive oil, and the meal component 14 is potatoes.

In some approaches, the sauce component 16 has a viscosity within the range of about 3 cm to about 14 cm, when measured at 70° F. with a Bostwick Consistometer using a 100 g sample and a 30 second time interval. In some approaches, the sauce component 16 has a viscosity within the range of about 3 cm to about 6.75 cm, about 3 cm to about 6.5 cm, about 3 cm to about 6 cm, about 3 cm to about 5.5 cm, about 3 cm to about 5 cm, about 3 cm to about 4.5 cm, or about 3 cm to about 4 cm, when measured at 70° F. with a Bostwick Consistometer using a 100 g sample and a 30 second time interval. In some approaches, the sauce component 16 has a viscosity within the range of about 6.75 cm to about 14 cm, when measured at 70° F. with a Bostwick Consistometer using a 100 g sample and a 30 second time interval. In some approaches, the sauce component 16 has a viscosity within the range of about 6.75 cm to about 12 cm, or about 6.5 cm to about 10.5 cm, when measured at 70° F. with a Bostwick Consistometer using a 100 g sample and a 30 second time interval. In some approaches, the sauce component 16 has a viscosity within the range of about 4.5 cm to about 8.5 cm, when measured at 70° F. with a Bostwick Consistometer using a 100 g sample and a 30 second time interval. In some approaches, the sauce component 16 has a viscosity of about 4 cm, about 4.5 cm, about 6.5 cm, about 7.5 cm, or about 8.5 cm, when measured at 70° F. with a Bostwick Consistometer using a 100 g sample and a 30 second time interval. In some examples, when the sauce component 16 has a viscosity within these ranges, the sauce component 16 may be able to efficiently conduct heat to the meal component 14. As such, the viscosity of the sauce component 16 can be selected to improve the heating efficiency of the modular meal component 10.

In any of the examples disclosed herein, the Bostwick Consistometer used to measure viscosity may be a stainless steel Bostwick Consistometer with a graduation series at precise intervals of 0.5 cm. In some of these examples, the Bostwick Consistometer may be a CSC Scientific 2492500 Bostwick Consistometer.

In some embodiments, the sauce component 16 has a moisture content within the range of about 55% to about 95%, about 60% to about 95%, about 60% to about 70%, about 65% to about 90%, about 65% to about 75%, about 70% to about 85%, about 70% to about 80%, or about 80% to about 95% (based on the total weight of the sauce component 16). In some examples, when the sauce component 16 has a moisture content within these ranges, the sauce component 16 may be able to efficiently conduct heat to the meal component 14. As such, the moisture content of the sauce component 16 can be selected to improve the heating efficiency of the modular meal component 10.

The cheese sauce may include any suitable cheese. In some examples, the cheese includes one or more of cheddar (such as mild, medium, sharp, extra-sharp, white cheddar, New York cheddar, and Vermont cheddar), parmesan, swiss (e.g., gruyere), Monterey jack, and combinations thereof. In addition to the cheese, the cheese sauce may also include one or more of milk, butter, and flour. In some examples, the marinara sauce may include one or more of tomatoes, garlic, and onions. In some examples, the sweet and sour sauce may include one or more of pineapple juice, sugar, vinegar, tomato sauce, ketchup, and thickener (e.g., cornstarch, tapioca starch, etc.). In some examples, the barbeque sauce may include sweetener (e.g., brown sugar, honey, molasses, or any combination thereof), ketchup, vinegar (e.g., apple cider vinegar, red wine vinegar, rice vinegar, or combination thereof), and Worcestershire. In some examples, the gravy may include one or more of meat juice, butter, flour, and stock. In some examples, the tartar sauce may include one or more of mayonnaise, onion, pickle relish, and lemon juice. The sauces may include one or more of herbs, salt, pepper, and spices to provide the desired flavor profile.

In some of these examples, the sauce component 16 is the cheese sauce. In others of these examples, the sauce component 16 is the cheese sauce and the meal component 14 is broccoli. In still others of these examples, the sauce component 16 includes olive oil. In yet others of these examples, the sauce component 16 includes olive oil, and the meal component 14 is potatoes.

In some examples, the sauce component 16 does not include any artificial ingredients. In these examples, sauce component 16 does not include any artificial flavor, artificial sweetener, artificial food coloring, or artificial preservatives.

In some examples, the meal component 14 and the sauce component 16 are precooked before being added to the tray 12. As used herein, “precooked” means previously exposed to a thermal micro kill step. In one approach, the precooked meal component 14 and the precooked sauce component 16 may be fully cooked such that they are suitable for human consumption. As an example, when the meal component 14 comprises the vegetable component, the precooking of the vegetable component may include blanching the vegetable component. As another example, when the meal component 14 comprises the protein component, the protein component has been cooked to an internal temperature of at least 165° F. to kill any microbes. As still another example, when the meal component 14 comprises the starch component, the precooking of the starch component may include blanching or parbaking (e.g., baking to about 80% of a full bake, or about 90% of a full bake) the starch component. In one approach, when the starch component includes pasta or potatoes, the starch component may be blanched. In another approach, when the starch component includes bread, the starch component may be partially baked.

In some embodiments, the meal component 14 and the sauce component 16 are disposed together within the tray 12. The meal component 14 and the sauce component 16 may be considered to be disposed together within the tray 12 when there is no barrier or other structure between the meal component 14 and the sauce component 16. In some examples, there is no barrier or other structure between the meal component 14 and the sauce component 16. In some examples, there is no barrier or other structure holding the meal component 14 above or separated from the sauce component 16. An example of the meal component 14 and the sauce component 16 being disposed together within the tray 12 is shown in FIG. 1A and FIG. 1B.

In some examples, a portion the sauce component 16 may be disposed underneath a portion of the meal component 14. In some approaches, at least some of the sauce component 16 may be disposed underneath at least some of the meal component 14. In some approaches, substantially all of the sauce component 16 may be disposed underneath or substantially underneath substantially all of the meal component 14. In some embodiments, about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14. An example of substantially all of the sauce component 16 being disposed substantially underneath substantially all of the meal component 14 is shown in FIG. 1A and FIG. 1B.

In some embodiments, the meal component 14 comprises a protein component, and about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14. In some embodiments, the meal component 14 comprises a protein component, the sauce component 16 comprises a marinara sauce, and about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14.

In some embodiments, the sauce component 16 has a viscosity within the range of about 3 cm to about 14 cm, when measured at 70° F. with a Bostwick Consistometer using a 100 g sample and a 30 second time interval, and about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14. In some embodiments, the sauce component 16 has a viscosity within the range of about 6.75 cm to about 14 cm, when measured at 70° F. with a Bostwick Consistometer using a 100 g sample and a 30 second time interval, and about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14. It has been unexpectedly found that, when the sauce component is less viscous (e.g., has a viscosity within the range of about 6.75 cm to about 14 cm when measured at 70° F. with a Bostwick Consistometer using a 100 g sample and a 30 second time interval), disposing substantially all of the sauce component 16 underneath or substantially underneath substantially all of the meal component 14 may improve the heating efficiency of the modular meal component 10.

In some embodiments, the sauce component 16 has a total solids content within the range of about 15% to about 45%, when measured at 70° F., and about 85% to 100%, about 90% to 100%, about 95% to 100%, or about 100% of the sauce component 16 is disposed underneath or substantially underneath about 85% to 100%, about 90% to 100%, about 95% to 100%, or about 100% of the meal component 14.

In some examples, a first portion of the sauce component 16 may be disposed underneath the meal component 14, and a second portion the sauce component 16 may be disposed atop the meal component 14. In some approaches, about half of the sauce component 16 may be disposed underneath or substantially underneath all or substantially all of the meal component 14 and the remaining about half of the sauce component 16 may be disposed atop all or substantially all of the meal component 14. In some examples, disposing about half of the sauce component 16 underneath or substantially underneath all or substantially all of the meal component 14 and disposing the remaining about half of the sauce component 16 atop all or substantially all of the meal component 14 may improve the quality characteristics (e.g., the texture and organoleptic properties) of the modular meal component 10.

In some approaches, about half of the sauce component 16 may be disposed underneath or substantially underneath at least some of the meal component 14. In some embodiments, about 40% to about 60%, about 45% to about 55%, or about 50% of the sauce component 16 may be disposed underneath or substantially underneath at least some of the meal component 14. In some approaches, about half of the sauce component 16 may be disposed underneath or substantially underneath substantially all of the meal component 14. In some embodiments, about 40% to about 60%, about 45% to about 55%, or about 50% of the sauce component 16 may be disposed underneath or substantially underneath about 85% to 100%, about 90% to 100%, about 95% to 100%, or about 100% of the meal component 14.

In some approaches, about half of the sauce component 16 may be disposed atop or substantially atop at least some of the meal component 14. In some embodiments, about 40% to about 60%, about 45% to about 55%, or about 50% of the sauce component 16 may be disposed atop or substantially atop at least some of the meal component 14. In some approaches, about half of the sauce component 16 may be disposed atop or substantially atop substantially all of the meal component 14. In some embodiments, about 40% to about 60%, about 45% to about 55%, or about 50% of the sauce component 16 may be disposed atop or substantially atop about 85% to 100%, about 90% to 100%, about 95% to 100%, or about 100% of the meal component 14.

In some embodiments, the meal component 14 comprises a starch component, about 40% to about 60%, about 45% to about 55%, or about 50% of the sauce component 16 may be disposed underneath or substantially underneath about 85% to 100%, about 90% to 100%, about 95% to 100%, or about 100% of the meal component 14, and about 40% to about 60%, about 45% to about 55%, or about 50% of the sauce component 16 may be disposed atop or substantially atop about 85% to 100%, about 90% to 100%, about 95% to 100%, or about 100% of the meal component 14. In some embodiments, the meal component 14 comprises potatoes, about 40% to about 60%, about 45% to about 55%, or about 50% of the sauce component 16 may be disposed underneath or substantially underneath about 85% to 100%, about 90% to 100%, about 95% to 100%, or about 100% of the meal component 14, and about 40% to about 60%, about 45% to about 55%, or about 50% of the sauce component 16 may be disposed atop or substantially atop about 85% to 100%, about 90% to 100%, about 95% to 100%, or about 100% of the meal component 14.

In some embodiments, the sauce component 16 has a viscosity within the range of about 3 cm to about 14 cm, when measured at 70° F. with a Bostwick Consistometer using a 100 g sample and a 30 second time interval, about 40% to about 60%, about 45% to about 55%, or about 50% of the sauce component 16 may be disposed underneath or substantially underneath about 85% to 100%, about 90% to 100%, about 95% to 100%, or about 100% of the meal component 14, and about 40% to about 60%, about 45% to about 55%, or about 50% of the sauce component 16 may be disposed atop or substantially atop about 85% to 100%, about 90% to 100%, about 95% to 100%, or about 100% of the meal component 14. In some embodiments, the sauce component 16 has a viscosity within the range of about 6.5 cm to about 10.5 cm, when measured at 70° F. with a Bostwick Consistometer using a 100 g sample and a 30 second time interval, about 40% to about 60%, about 45% to about 55%, or about 50% of the sauce component 16 may be disposed underneath or substantially underneath about 85% to 100%, about 90% to 100%, about 95% to 100%, or about 100% of the meal component 14, and about 40% to about 60%, about 45% to about 55%, or about 50% of the sauce component 16 may be disposed atop or substantially atop about 85% to 100%, about 90% to 100%, about 95% to 100%, or about 100% of the meal component 14.

In some embodiments, the sauce component 16 has a total solids within the range of about 20% to about 30%, when measured at 70° F.; and about 40% to about 60%, about 45% to about 55%, or about 50% of the sauce component 16 may be disposed underneath or substantially underneath about 85% to 100%, about 90% to 100%, about 95% to 100%, or about 100% of the meal component 14; and about 40% to about 60%, about 45% to about 55%, or about 50% of the sauce component 16 may be disposed atop or substantially atop about 85% to 100%, about 90% to 100%, about 95% to 100%, or about 100% of the meal component 14.

In some approaches, the sauce component 16 may be layered in with the meal component 14. In some embodiments, about 20% to about 45%, about 28% to about 38%, about 30% to about 35%, or about 33% of the sauce component 16 may be disposed underneath or substantially underneath at least some of the meal component 14. In some embodiments, about 28% to about 38%, about 30% to about 35%, or about 33% of the sauce component 16 may be disposed underneath or substantially underneath substantially all of the meal component 14. In some embodiments, about 28% to about 38%, about 30% to about 35%, or about 33% of the sauce component 16 may be disposed underneath or substantially underneath about 85% to 100%, about 90% to 100%, about 95% to 100%, or about 100% of the meal component 14.

In some embodiments, about 20% to about 45%, about 28% to about 38%, about 30% to about 35%, or about 33% of the sauce component 16 may be disposed atop or substantially atop at least some of the meal component 14. In some embodiments, about 28% to about 38%, about 30% to about 35%, or about 33% of the sauce component 16 may be disposed atop or substantially atop substantially all of the meal component 14. In some embodiments, about 28% to about 38%, about 30% to about 35%, or about 33% of the sauce component 16 may be disposed atop or substantially atop about 85% to 100%, about 90% to 100%, about 95% to 100%, or about 100% of the meal component 14.

In some embodiments, about 15% to about 35%, about 20% to about 30%, or about 25% of the sauce component 16 may be disposed underneath or substantially underneath at least some of the meal component 14. In some embodiments, about 15% to about 35%, about 20% to about 30%, or about 25% of the sauce component 16 may be disposed underneath or substantially underneath substantially all of the meal component 14. In some embodiments, about 15% to about 35%, about 20% to about 30%, or about 25% of the sauce component 16 may be disposed underneath or substantially underneath about 85% to 100%, about 90% to 100%, about 95% to 100%, or about 100% of the meal component 14.

In some embodiments, about 15% to about 35%, about 20% to about 30%, or about 25% of the sauce component 16 may be disposed atop or substantially atop at least some of the meal component 14. In some embodiments, about 15% to about 35%, about 20% to about 30%, or about 25% of the sauce component 16 may be disposed atop or substantially atop substantially all of the meal component 14. In some embodiments, about 15% to about 35%, about 20% to about 30%, or about 25% of the sauce component 16 may be disposed atop or substantially atop about 85% to 100%, about 90% to 100%, about 95% to 100%, or about 100% of the meal component 14.

In some approaches, the sauce component 16 may be mixed with the meal component 14 before the sauce component 16 and the meal component 14 are added to the tray 12. In some embodiments the sauce component 16 may coat all or substantially all of the meal component 14. In some examples, mixing the sauce component 16 with the meal component 14 before they are added to the tray 12 may improve the quality characteristics (e.g., the texture and organoleptic properties) of the modular meal component 10.

In some embodiments, the meal component 14 comprises a starch component, and the sauce component 16 is mixed with the meal component 14 before the sauce component 16 and the meal component 14 are added to the tray 12. In some embodiments, the meal component 14 comprises pasta, and the sauce component 16 is mixed with the meal component 14 before the sauce component 16 and the meal component 14 are added to the tray 12.

In some embodiments, the sauce component 16 has a viscosity within the range of about 3 cm to about 14 cm, when measured at 70° F. with a Bostwick Consistometer using a 100 g sample and a 30 second time interval, and the sauce component 16 is mixed with the meal component 14 before the sauce component 16 and the meal component 14 are added to the tray 12. In some embodiments, the sauce component 16 has a viscosity within the range of about 4.5 cm to about 8.5 cm, when measured at 70° F. with a Bostwick Consistometer using a 100 g sample and a 30 second time interval, and the sauce component 16 is mixed with the meal component 14 before the sauce component 16 and the meal component 14 are added to the tray 12.

In some embodiments, the sauce component 16 has a total solids content within the range of about 30% to about 40%, when measured at 70° F., and the sauce component 16 is mixed with the meal component 14 before the sauce component 16 and the meal component 14 are added to the tray 12.

In some examples, the modular meal component 10 further includes a topping. In some approaches, the topping is disposed within the tray 12. In some embodiments, the topping may be disposed atop the meal component 14 and the sauce component 16. Any suitable topping may be used in the modular meal component 10. In some examples, the topping includes one or more of a cheese, blend of cheeses, breadcrumbs, bacon, green onions, etc.

In some approaches, a meal component 14 and a sauce component 16 are combined to form a particular dish. Some examples of meal and sauce component combinations and the dishes they form are shown in Table 1.

TABLE 1

| | | Sauce | |
|---|---|---|---|
| Meal component 14 | | component 16 | Dish |
| Protein | Chicken | Marinara sauce | Chicken parmesan |
| component | | | |
| Protein | Chicken | Honey | Honey baked chicken |
| component | | | |
| Protein | Chicken | Honey barbeque | Honey barbeque |
| component | | sauce | chicken |
| Protein | Chicken | Mushroom sauce | Mushroom Chicken |
| component | | | |
| Protein | Chicken | Pesto sauce | Pesto Chicken |
| component | | | |
| Protein | Chicken | Cream sauce | Chicken cordon bleu |
| component | | | |
| Protein | Chicken | Sweet and sour | Sweet and sour |
| component | | sauce | chicken |
| Protein | Beef brisket | Barbeque sauce | Barbeque beef brisket |
| component | | | |
| Protein | Beef | Marinara sauce, | Meat loaf |
| component | | or gravy | |
| Protein | Beef | Ketchup barbeque | Ketchup barbeque |
| component | | meatloaf sauce | meatloaf balls |
| Protein | Beef | Marinara sauce | Meatballs with |
| component | | | marinara |
| Protein | Beef | Fajita sauce | Fajita beef |
| component | | | |
| Protein | Beef | Sauce | Steak bites |
| component | | | |
| Protein | Pork | Barbeque sauce | Barbeque pulled pork |
| component | | | |
| Protein | Turkey | Gravy | Turkey and gravy |
| component | | | |
| Protein | Shrimp | Garlic lemon | Shrimp scampi |
| component | | butter sauce | |
| Protein | Tilapia | Sauce | Breaded tilapia |
| component | | | |
| Protein | Salmon | Lemon juice | Breaded salmon |
| component | | | |
| Protein | Cod | Sauce | Breaded cod |
| component | | | |
| Protein | Haddock | Sauce | Breaded haddock |
| component | | | |
| Protein | Salmon | Teriyaki sauce | Teriyaki salmon |
| component | | | |
| Starch component | Potatoes | Butter and milk | Buttery mashed |
| | | | potatoes |
| Starch component | Rounded red | Oil/herb/cheese/ | Parmesan crusted red |
| | potatoes | seasoning blend | potatoes |
| Starch component | Potatoes | Cheese sauce | Loaded potato skins |
| Starch component | Potatoes | Oil/herb/cheese/ | Rosemary roasted |
| | | seasoning blend | potatoes |
| Starch component | Rounded red | Sauce | Roasted red potatoes |
| | potatoes | | |
| Starch component | Sweet | Sauce | Roasted sweet |
| | potatoes | | potatoes |
| Starch component | Sweet | Sauce | Baked sweet potato |
| | potatoes | | |
| Starch component | Potatoes | Cream sauce | Scalloped potatoes |
| Starch component | Pasta | Red sauce, or | Pasta |
| | | white sauce | |
| Starch component | Noodles | Sauce | Asian stir fry noodles |
| Starch component | Macaroni | Mac and cheese | Mac and cheese |
| | pasta | sauce | |
| Starch component | Pasta | Cheese sauce | Sharp white cheddar |
| | | | mac and cheese |
| Starch component | Tortellini | Cheese sauce | Three cheese tortellini |
| Starch component | Rice | Sauce | Rice |
| Starch component | Rice | Sauce | Mixed vegetable |
| | | | fried rice |
| Starch component | Rice | Oil | Egg fried rice |
| Starch component | Rice | Cheese sauce | Cheesy rice casserole |
| Starch component | Bread | Garlic butter sauce | Garlic bread |
| Starch component | Bread | Butter | Parmesan and |
| | | | mozzarella garlic |
| | | | bread |
| Starch component | Rolls | Butter | Southern butter rolls |
| Starch component | Bread sticks | Butter | Bread sticks |
| Vegetable | Broccoli | Cheese sauce | Cheddar broccoli |
| component | | | |
| Vegetable | Broccoli | Oil/herb/spice/ | Roasted garlic and |
| component | | cheese toss | parmesan broccoli |
| Vegetable | Green beans | Butter | Buttery green beans |
| component | | | |
| Vegetable | Green beans | Savory cream | Savory green beans |
| component | | sauce | |
| Vegetable | Asparagus | Oil/seasoning/ | Garlic roasted |
| component | | herbs toss | asparagus |
| Vegetable | Corn | Butter | Corn on the cob or |
| component | | | Corn off the cob |
| Vegetable | Corn | Cheese sauce | Cheesy corn casserole |
| component | | | |
| Vegetable | Carrots | Honey sauce | Honey glazed carrots |
| component | | | |
| Vegetable | Cauliflower | Oil/herb/cheese | Parmesan crusted |
| component | | seasoning toss | cauliflower |
| Vegetable | Brussel | Oil/herb/cheese | Bacon and parmesan |
| component | sprouts | seasoning toss | Brussel sprouts |
| Vegetable | Edamame | Spicy Asian sauce | Sweet and spicy |
| component | | | edamame |

In some examples, the meal component 14 comprises the protein component, and the weight ratio of the protein component to a sauce component 16 is in the range of 4:1 to 1:1; or the meal component 14 comprises the starch component, and the weight ratio of the starch component to the sauce component 16 is in the range of 10:1 to 1:2; or the meal component 14 comprises the vegetable component, and the weight ratio of the vegetable component to the sauce component 16 is in the range of 10:1 to 1:2. In some examples, the combination of the meal component 14 and the sauce component 16 (or the combination of the meal component 14, the sauce component 16, and the topping) has a solids content within the range of about 5 wt % to about 50 wt %. In other examples, the combination of the meal component 14 and the sauce component 16 (or the combination of the meal component 14, the sauce component 16, and the topping) has a solids content within the range of about 16 wt % to about 28.5 wt %. In some embodiments, the solids content of the combination of the meal component 14 and the sauce component 16 (or the combination of the meal component 14, the sauce component 16, and the topping) may be measured at room temperature (e.g., 70° F.).

In some embodiments, the modular meal component 10 does not include the sauce component 16.

In some approaches, the meal component 14 is disposed within the tray 12 and is selected from an appetizer component or a dessert component.

In some examples, the meal component 14 comprises an appetizer component. Any suitable appetizer component may be used in the modular meal component 10. Examples of suitable appetizer components include garlic knots, fried cheese curds, etc.

In some examples, the meal component 14 comprises a dessert component. Any suitable dessert component may be used in the modular meal component 10. Examples of suitable dessert components include cookies, cakes, and pastries. Cookies may include chocolate chip cookie, sugar cookies, oatmeal raisin cookies, peanut butter cookies shortbread cookies, gingerbread cookies, etc. Cakes may include chocolate cake, molten lava chocolate cake, flourless cake, carrot cake, red velvet cake, angel food cake, marble cake, pound cake, coconut cake, sponge cake, banana cake, lemon cake, cheesecake, brownies, blondies, etc. Pastries may include crisps, strudel, baklava, etc.

The dessert component may further include a sauce, if desired. Examples of a sauce component 16 that may be used with the dessert component include chocolate sauce, fudge sauce, caramel sauce, vanilla sauce, lemon sauce, raspberry sauces, strawberry sauce, etc.

In some approaches, the dessert component and any sauce component used therewith may be uncooked. For example, when the dessert component includes cookies, the cookies may be in the form of cookie dough that will bake into cookies when the modular meal component 10 is heated from frozen for a heating time period within the range of from about 20 minutes to about 60 minutes and at a heating temperature within the range of about 350° F. to about 500° F. in a conventional oven. As another example, when the dessert component includes cake, the cake may be in the form of cake batter that will bake into cake when the modular meal component 10 is heated from frozen for a heating time period within the range of from about 20 minutes to about 60 minutes and at a heating temperature within the range of about 350° F. to about 500° F. in a conventional oven.

In some approaches, a dessert component and a sauce component 16 are combined to form a particular dish. Some examples of dessert and sauce component combinations and the dishes they form are shown in Table 2.

TABLE 2

| | | Sauce component | |
|---|---|---|---|
| Meal component 14 | | 16 | Dish |
| Dessert | Chocolate chip | Fudge sauce | Chocolate chip cookie |
| component | cookie dough | | bake |
| Dessert | Crisp dough and | Caramel sauce | Cinnamon apple crisp |
| component | apple pie filling | | |
| Dessert | Molten lava | Chocolate sauce | Molten lava chocolate |
| component | chocolate cake batter | | cake |

In some examples, the modular meal component 10 includes sodium in an amount less than or equal to 425 mg per USDA serving. In other examples, the modular meal component 10 includes the protein component and includes sodium in an amount less than or equal to 425 mg per USDA serving. In still other examples, the modular meal component 10 includes the starch component and includes sodium in an amount less than or equal to 375 mg per USDA serving. In yet other examples, the modular meal component 10 includes the vegetable component and includes sodium in an amount less than or equal to 150 mg per USDA serving. The total amount of sodium included in the modular meal component 10 may be included in the combination of the meal component 14 and the sauce component 16 or in the combination of the meal component 14, the sauce component 16, and the topping.

In some examples, the modular meal component 10 includes fat in an amount less than or equal to 11 g per USDA serving. In other examples, the modular meal component 10 includes the protein component and includes fat in an amount less than or equal to 11 g per USDA serving. In still other examples, the modular meal component 10 includes the starch component and includes fat in an amount less than or equal to 8 g per USDA serving. In yet other examples, the modular meal component 10 includes the vegetable component and includes fat in an amount less than or equal to 4 g per USDA serving. The total amount of fat included in the modular meal component 10 may be included in the combination of the meal component 14 and the sauce component 16 or in the combination of the meal component 14, the sauce component 16, and the topping.

In some examples, the modular meal component 10 includes saturated fat in an amount less than or equal to 4 g per USDA serving. In other examples, the modular meal component 10 includes the protein component and includes saturated fat in an amount less than or equal to 3 g per USDA serving. In still other examples, the modular meal component 10 includes the starch component and includes saturated fat in an amount less than or equal to 4 g per USDA serving. In yet other examples, the modular meal component 10 includes the vegetable component and includes saturated fat in an amount less than or equal to 2 g per USDA serving. The total amount of saturated fat included in the modular meal component 10 may be included in the combination of the meal component 14 and the sauce component 16 or in the combination of the meal component 14, the sauce component 16, and the topping.

In some examples, the modular meal component 10 includes the protein component and includes protein in an amount greater than 15 g per USDA serving. The total amount of protein included in the modular meal component 10 may be included in the combination of the meal component 14 and the sauce component 16 or in the combination of the meal component 14, the sauce component 16, and the topping.

In some examples, the modular meal component 10 has less than or equal to 350 calories per USDA serving. In other examples, the modular meal component 10 includes the protein component and has less than or equal to 250 calories per USDA serving. In still other examples, the modular meal component 10 includes the starch component and has less than or equal to 350 calories per USDA serving. In yet other examples, the modular meal component 10 includes the vegetable component and has less than or equal to 150 calories per USDA serving. The total amount of calories included in the modular meal component 10 may be included in the combination of the meal component 14 and the sauce component 16 or in the combination of the meal component 14, the sauce component 16, and the topping. As used herein, the unit “calorie” is equivalent to 4,186.8 joules.

In some examples, the modular meal component 10 further includes a flexible film 18 that seals the meal component 14 and the sauce component 16 within the tray 12. The flexible film 18 generally provides a barrier to protect the quality and integrity of the food product disposed in the tray 12. The flexible film 18 may also provide a barrier that retains steam within the tray 12 during heating of the modular meal component 10.

The flexible film 18 may be one or a combination of polymer materials. For example, the flexible film 18 may include polyester, polyvinyl alcohol, ethylene vinyl alcohol, polyvinylidene chloride, polypropylene, polyethylene, and/or nylon. In one embodiment, the flexible film 18 is a heat-sealable polyester film. The flexible film 18 may be a single layer or multilayer film. In some examples, the flexible film 18 may have an anti-fog treatment applied thereon. In some examples, the flexible film 18 may be stable at temperatures up to at least 460° F., or up to at least 464° F. To improve the seal integrity of the final modular meal component, the flexible film 18 may be formed from a material that is compatible with the tray material. A flexible film material that is compatible with the composition of the formed tray 12 may help to bond the flexible film 18 to the formed tray 12 in order to effectively seal the flexible film 18 to the formed tray 12. In one embodiment, the flexible film 18 is KPEEL™ 7G+AF (a heat-sealable polyester film with an anti-fog treatment available from KM Packaging Services Ltd.).

In some examples, the flexible film 18 may be attached to the peripheral flange 21. In one embodiment, the flexible film 18 has an upper surface and a lower surface, the lower surface may have a sealant disposed thereon, such that the lower surface of the flexible film 18 is hermetically sealed to the upper flange to seal the meal component 14 and the sauce component 16 within the tray 18. In some examples, the sealant disposed on the lower surface of the flexible film 18 may be a heat-activated sealant or a heat-sealable sealant. In these examples, the lower surface of the flexible film 18 may be disposed on the upper flange of tray 12 and heat may be applied through the upper surface of the flexible film 18 to hermetically seal the flexible film 18 to the upper flange. In some embodiments, the upper surface of the peripheral flange 21 of the tray 12 may be linear to permit the flexible film 18 to be sealed thereto without openings. In some approaches, the flexible film 18 is hermetically sealed to the upper flange, and the hermetical seal has a seal strength within the range of from about 10 inches of mercury to about 15 inches of mercury (“inHg”, as measure by a vacuum test, as set forth in modified ASTM D3078-02 test (modified by running the test dry, i.e., without using water)). In some examples, the seal has a seal strength of at least 13 inHg. In some examples, the sealant used to hermetically seal the flexible film 18 to the upper flange is capable of sealing the flexible film 18 to the upper flange of the tray 18 with a seal strength within the range of from about 10 inHg to about 15 inHg.

In some examples, the modular meal component 10 may further include an aluminum lid. The aluminum lid may provide a barrier to retain steam during heating of the modular meal component 10. In some embodiments, the aluminum lid may sit on the upper surface of the peripheral flange 21 of the tray 12.

In some embodiments, the modular meal component 10 may include the flexible film 18 hermetically sealed to the upper flange of the tray 12 with a seal strength within the range of from about 10 inHg to about 15 inHg, and the modular meal component 10 may have a moisture content that enables the meal component 14, or the meal component 14 and the sauce component 16, to be steamed and then dry roasted. In some embodiments, the modular meal component 10 has a total moisture content within the range of about 40% to about 95%, or about 45% to about 90% (based on the total weight of the combination of the meal component 14 and the sauce component 16 or the combination of the meal component 14, the sauce component 16, and the topping). In some examples, when the modular meal component 10 has a moisture content within these ranges, the meal component 14, or the meal component 14 and the sauce component 16, may be steamed and then dry roasted when the modular meal component 10 is heated from frozen for a heating time period within the range of from about 20 minutes to about 60 minutes and at a heating temperature within the range of about 350° F. to about 450° F. The total amount of moisture included in the modular meal component 10 may be included in the combination of the meal component 14 and the sauce component 16 or in the combination of the meal component 14, the sauce component 16, and the topping.

In some examples, the modular meal component 10 includes the protein component and has a moisture content within the range of about 55% to about 80%, about 60% to about 75%, about 60% to about 72%, about 60% to about 70% (based on the total weight of the combination of the meal component 14 and the sauce component 16 or the combination of the meal component 14, the sauce component 16, and the topping). In some examples, when the modular meal component 10 includes the protein component and has a moisture content within these ranges, the meal component 14 (or the meal component 14 and the sauce component 16) may be steamed and then dry roasted when the modular meal component 10 is heated from frozen for a heating time period within the range of from about 20 minutes to about 60 minutes and at a heating temperature within the range of about 350° F. to about 450° F.

In some examples, the modular meal component 10 includes the starch component and has a moisture content within the range of about 40% to about 70%, about 45% to about 65%, or about 49% to about 65% (based on the total weight of the combination of the meal component 14 and the sauce component 16 or the combination of the meal component 14, the sauce component 16, and the topping). In some examples, when the modular meal component 10 includes the starch component and has a moisture content within these ranges, the meal component 14 (or the meal component 14 and the sauce component 16) may be steamed and then dry roasted when the modular meal component 10 is heated from frozen for a heating time period within the range of from about 20 minutes to about 60 minutes and at a heating temperature within the range of about 350° F. to about 450° F.

In some examples, the modular meal component 10 includes the vegetable component and has a moisture content within the range of about 70% to about 95%, about 75% to about 90%, or about 75% to about 87.5% (based on the total weight of the combination of the meal component 14 and the sauce component 16 or the combination of the meal component 14, the sauce component 16, and the topping). In some examples, when the modular meal component 10 includes the vegetable component and has a moisture content within these ranges, the meal component 14 (or the meal component 14 and the sauce component 16) may be steamed and then dry roasted when the modular meal component 10 is heated from frozen for a heating time period within the range of from about 20 minutes to about 60 minutes and at a heating temperature within the range of about 350° F. to about 450° F.

As the modular meal component 10 is heated, at least some of the moisture contained therein may evaporate and form steam. When the modular meal component 10 includes the flexible film 18 hermetically sealed to the upper flange of the tray 12, the flexible film 18 may retain the steam within the tray 12. When the modular meal component 10 has sufficient moisture content, the meal component 14 and the sauce component 16, may be heated (i.e., steamed) by the retained steam.

When the meal component 14 and the sauce component 16 are heated by retained steam, the meal component 14 and the sauce component 16 are heated more homogenously and at higher temperature than they would be if the steam could escape the tray 12. As an example, heating the meal component 14 and the sauce component 16 with retained steam may heat the meal component 14 and the sauce component 16 at a temperature of least about 200° F. As another example, heating the meal component 14 and the sauce component 16 with retained steam may heat the meal component 14 and the sauce component 16 at a temperature of about 220° F.

As the modular meal component 10 continues to be heated, more of the moisture contained in the modular meal component 10 evaporates, and the steam produced causes the air pressure within the tray 12 to increase. When heating of the modular meal component 10 generates sufficient steam, the air pressure within the tray 12 may become greater than the seal strength, causing the seal to break and the flexible film 18 to lift from the upper flange to form a vent. When the vent is formed, most of the steam that had been retained within the tray 12, as well as most of any new steam formed through the evaporation of more of the moisture contained in the modular meal component 10, may escape through the vent. When the heating of the modular meal component 10 is continued after most of the steam has escaped through the vent, the meal component 14 and the sauce component 16 may be dry roasted for a period of time during the heating process.

Dry roasting the meal component 14 and the sauce component 16 may give the meal component 14 (or the meal component 14 and the sauce component 16) desirable organoleptic properties (e.g., mouthfeel, aroma, and taste) and/or texture. As an example, the dry roasting may cause the meal component 14 to have a crispy texture or a crunchy texture and roasted flavor notes.

In some approaches, the modular meal component 10 is configured and/or formulated so that the vent forms at a point within the heating time period sufficient to reach at least 165° F. when heated from frozen for a heating time period within the range of from about 20 minutes to about 60 minutes and at a heating temperature within the range of about 350° F. to about 450° F. Before the vent forms the meal component 14 and the sauce component 16 are heated more homogenously and at higher temperature than after the vent forms. If the vent forms too early in the heating time period, the meal component 14 may be unable to reach at least 165° F. during the heating time period. If the vent does not form in the heating time period, the meal component 14 (or the meal component 14 and the sauce component 16) may be unable to achieve desirable organoleptic properties and/or texture. In some examples, the meal component 14 (or the meal component 14 and the sauce component 16) may be selected to achieve desirable organoleptic properties and/or texture without the vent forming.

When the vent is formed is determined, at least in part, by (i) the moisture content of the modular meal component 10, (ii) the strength of the seal of the flexible film to the upper flange of the tray 18, and (iii) the temperature at which the modular meal component 10 is heated.

In some examples, the modular meal component 10 has a seal strength and a moisture content that causes the vent to form after the modular meal component 10 has been heated at a heating temperature within the range of about 350° F. to about 450° F. for about 60% to about 99% of the heating time period, for about 70% to about 99% of the heating time period, for about 75% to about 99% of the heating time period, for about 80% to about 99% of the heating time period, for about 90% to about 99% of the heating time period, or for about 95% to about 99% of the heating time period. In some examples, the modular meal component 10 has a seal strength and a moisture content that causes the vent to form after the modular meal component 10 has been heated at a heating temperature of about 415° F. to about 435° F., in another aspect about 425° F., for about 60% to about 99% of the heating time period, for about 70% to about 99% of the heating time period, for about 75% to about 99% of the heating time period, for about 80% to about 99% of the heating time period, for about 90% to about 99% of the heating time period, or for about 95% to about 99% of the heating time period.

In some examples, the modular meal component 10 has a seal strength and a moisture content that causes the vent to form after the modular meal component 10 has been heated at a heating temperature within the range of about 350° F. to about 450° F. for a heating time period within the range of from about 20 minutes to about 59 minutes, for a heating time period within the range of from about 20 minutes to about 50 minutes, for a heating time period within the range of from about 20 minutes to about 40 minutes, for a heating time period within the range of from about 20 minutes to about 30 minutes, or for a heating time period within the range of from about 25 minutes to about 28 minutes. In some examples, the modular meal component 10 has a seal strength and a moisture content that causes the vent to form after the modular meal component 10 has been heated at a heating temperature of about 415° F. to about 435° F., in another aspect about 425° F., for a heating time period within the range of from about 20 minutes to about 59 minutes, for a heating time period within the range of from about 20 minutes to about 50 minutes, for a heating time period within the range of from about 20 minutes to about 40 minutes, for a heating time period within the range of from about 20 minutes to about 30 minutes, or for a heating time period within the range of from about 25 minutes to about 28 minutes.

In the examples described above, the vent may form without intervention from the consumer during the heating process (i.e., without piercing, cutting, or partially removing the film from the upper flange).

In some embodiments, it has been unexpectedly found that, when the modular meal component 10 has seal strength within the range of from about 10 inHg to about 15 inHg and a moisture content within the range of about 40% to about 95% (based on the total weight of the combination of the meal component 14 and the sauce component 16 or the combination of the meal component 14, the sauce component 16, and the topping) the vent to forms after a heating time period within the above ranges. As such, the seal strength and/or the moisture content can be selected such that the meal component 14 (or the meal component 14 and the sauce component 16) are steamed and then dry roasted when modular meal component 10 is heated from frozen for a heating time period within the range of from about 20 minutes to about 60 minutes and at a heating temperature within the range of about 350° F. to about 450° F.

In some embodiments, the seal does not break and the vent is not formed during the heating process. In this approach, the steam produced from the modular meal component remains trapped under the film and accelerates the cooking of the modular meal component throughout the cook time.

The modular meal component 10 is configured and/or formulated to reach an internal temperature of at least 165° F. when heated from frozen for a heating time period within the range of from about 20 minutes to about 60 minutes and at a heating temperature within the range of about 350° F. to about 500° F. in a conventional oven. In some examples, the modular meal component is configured and/or formulated to reach at least 165° F. when heated from frozen for a heating time period within the range of from about 20 minutes to about 40 minutes and at a temperature within the range of about 350° F. to about 475° F. in a conventional oven. In some examples, the modular meal component is configured and/or formulated to reach at least 165° F. when heated from frozen for a heating time period of about 30 minutes and a temperature of about 425° F. in a conventional oven.

In some examples, the modular meal component 10 is configured and/or formulated to reach at least 165° F. when heated from frozen for the heating time period and at a heating temperature. In other examples, the modular meal component 10 is configured and/or formulated to reach at least 167° F., at least 168° F., at least 169° F., or at least 170° F. when heated from frozen for the heating time period and at a heating temperature. As used herein, the modular meal component 10 being configured and/or formulated to reach at least a temperature (e.g., at least 165° F.) means that the meal component 14 in each of nine equally-sized zones of the tray 12 reaches at least the specified temperature (e.g., at least 165° F.). A grid defining the nine equally-sized zones may be created by dividing each of the width and the length of a tray into three equal sections. The internal temperature of the thickest portion of the meal component in each of the equally-sized zones may be measured. If each internal temperature is measured to be at least the specified temperature (e.g., at least 165° F.), the modular meal component 10 may be considered to be configured and/or formulated to reach at least the specified temperature (e.g., at least 165° F.).

In some examples, the heating time period is within the range of from about 20 minutes to about 60 minutes. In other examples, the heating time period is within the range of from about 20 minutes to about 50 minutes, the range of from about 20 minutes to about 45 minutes, the range of from about 20 minutes to about 40 minutes, or the range of from about 25 minutes to about 35 minutes. In still other examples, the heating time period is about 30 minutes.

In some examples, the heating temperature is within the range of about 350° F. to about 500° F. In other examples, the heating temperature is within the range of about 350° F. to about 475° F., the range of about 375° F. to about 475° F., the range of about 400° F. to about 460° F., or the range of about 400° F. to about 450° F. In still other examples, the heating temperature is about 425° F.

In some examples, the modular meal component 10 is configured and/or formulated to reach at least 165° F. (in another aspect, at least 167° F., at least 168° F., at least 169° F., or at least 170° F.) when heated from frozen in a conventional oven for the heating time period and at a heating temperature. In other examples, the modular meal component 10 is configured and/or formulated to reach at least 165° F. (in another aspect, at least 167° F., at least 168° F., at least 169° F., or at least 170° F.) when three modular meal components are heated together from frozen in a conventional oven for the heating time period and at a heating temperature. In still other examples, the modular meal component 10 is configured and/or formulated to reach at least 165° F. (in another aspect, at least 167° F., at least 168° F., at least 169° F., or at least 170° F.) when heated from frozen in a conventional oven for the heating time period and at a heating temperature without intervention (e.g., without stirring or turning the modular meal component 10).

A consumer may select a set of modular meal components to create a meal. The consumer may cook each modular meal component in the set in a conventional oven at the same time, at the same temperature, and for the same length of time. In some examples, a consumer may select two or more, in another aspect three or more, in another aspect four or more, modular meal components to provide a meal. The modular meal components may be selected from a protein component, a starch component, a vegetable component, an appetizer component, and a dessert component. In one of these examples. the consumer may select a modular meal component that includes a protein component, a modular meal component that includes a starch component, and a modular meal component that includes a vegetable component for the meal. In others of these examples, the consumer may select other combinations of the modular meal components for the meal. One example of another combination includes a modular meal component that includes a protein component, a modular meal component that includes a first vegetable component, and a modular meal component that includes a second vegetable component. Another example of a combination includes a modular meal component that includes a protein component, a modular meal component that includes a first starch component, and a modular meal component that includes a second starch component. Some specific examples of other combinations of modular meal components are shown in Table 3. In Table 3, the modular meal components are identified by the protein dish, starch dish, or vegetable dish formed from the combination of the meal component 14 and the sauce component 16.

TABLE 3

| | Starch dishes that may be selected | Vegetable dishes that may be |
|---|---|---|
| Protein | in combination with the protein | selected in combination with the |
| dish | dish | protein dish |
| Chicken | Buttery mashed potatoes, Parmesan | Roasted garlic and parmesan |
| parmesan | crusted potatoes, Three cheese | broccoli, Buttery green beans, Garlic |
| | tortellini, Parmesan and mozzarella | roasted asparagus, Corn on the cob, |
| | garlic bread, Southern butter rolls, | Corn casserole, Parmesan crusted |
| | or a combination thereof | cauliflower, Bacon and parmesan |
| | | Brussel sprouts, or a combination |
| | | thereof |
| Honey | Buttery mashed potatoes, Parmesan | Cheddar broccoli, Roasted garlic and |
| baked | crusted potatoes, Three cheese | parmesan broccoli, Buttery green |
| chicken | tortellini, Parmesan and mozzarella | beans, Garlic roasted asparagus, |
| | garlic bread, Southern butter rolls, | Corn on the cob, Corn casserole, |
| | Loaded potato skins, Egg fried rice, | Parmesan crusted cauliflower, Bacon |
| | or a combination thereof | and parmesan Brussel sprouts, or a |
| | | combination thereof |
| Barbeque | Buttery mashed potatoes, Parmesan | Cheddar broccoli, Roasted garlic and |
| beef | crusted potatoes, Sharp white | parmesan broccoli, Buttery green |
| brisket | cheddar mac and cheese, Parmesan | beans, Garlic roasted asparagus, |
| | and mozzarella garlic bread, | Corn on the cob, Corn casserole, |
| | Southern butter rolls, Loaded potato | Honey glazed carrots, Parmesan |
| | skins, Cheesy rice casserole, or a | crusted cauliflower, Bacon and |
| | combination thereof | parmesan Brussel sprouts, or a |
| | | combination thereof |
| Parmesan | Buttery mashed potatoes, Parmesan | Cheddar broccoli, Roasted garlic and |
| crusted | crusted potatoes, Sharp white | parmesan broccoli, Buttery green |
| pork | cheddar mac and cheese, Three | beans, Garlic roasted asparagus, |
| chops | cheese tortellini, Parmesan and | Corn on the cob, Corn casserole, |
| | mozzarella garlic bread, Southern | Honey glazed carrots, Parmesan |
| | butter rolls, Loaded potato skins, | crusted cauliflower, Bacon and |
| | Cheesy rice casserole, Egg fried rice, | parmesan Brussel sprouts, or a |
| | or a combination thereof | combination thereof |
| Shrimp | Buttery mashed potatoes, Parmesan | Cheddar broccoli, Roasted garlic and |
| scampi | crusted potatoes, Three cheese | parmesan broccoli, Buttery green |
| | tortellini, Parmesan and mozzarella | beans, Garlic roasted asparagus, |
| | garlic bread, Southern butter rolls, | Corn on the cob, Corn casserole, |
| | Loaded potato skins, Cheesy rice | Parmesan crusted cauliflower, Bacon |
| | casserole, Egg fried rice, or a | and parmesan Brussel sprouts, or a |
| | combination thereof | combination thereof |
| Sweet and | Parmesan crusted potatoes, Egg | Roasted garlic and parmesan |
| sour | fried rice, or a combination thereof | broccoli, Buttery green beans, Garlic |
| chicken | | roasted asparagus, or a combination |
| | | thereof |
| Meat loaf | Buttery mashed potatoes, Parmesan | Cheddar broccoli, Roasted garlic and |
| | crusted potatoes, Sharp white | parmesan broccoli, Buttery green |
| | cheddar mac and cheese, Parmesan | beans, Garlic roasted asparagus, |
| | and mozzarella garlic bread, | Corn on the cob, Corn casserole, |
| | Southern butter rolls, Loaded potato | Honey glazed carrots, Parmesan |
| | skins, or a combination thereof | crusted cauliflower, Bacon and |
| | | parmesan Brussel sprouts, or a |
| | | combination thereof |
| Barbeque | Buttery mashed potatoes, Parmesan | Cheddar broccoli, Roasted garlic and |
| pulled | crusted potatoes, Sharp white | parmesan broccoli, Buttery green |
| pork | cheddar mac and cheese, Three | beans, Garlic roasted asparagus, |
| | cheese tortellini, Parmesan and | Corn on the cob, Corn casserole, |
| | mozzarella garlic bread, Southern | Honey glazed carrots, Parmesan |
| | butter rolls, Loaded potato skins, or | crusted cauliflower, Bacon and |
| | a combination thereof | parmesan Brussel sprouts, or a |
| | | combination thereof |
| Breaded | Buttery mashed potatoes, Parmesan | Cheddar broccoli, Roasted garlic and |
| fish | crusted potatoes, Sharp white | parmesan broccoli, Buttery green |
| | cheddar mac and cheese, Three | beans, Garlic roasted asparagus, |
| | cheese tortellini, Parmesan and | Corn on the cob, Corn casserole, |
| | mozzarella garlic bread, Southern | Parmesan crusted cauliflower, Bacon |
| | butter rolls, Egg fried rice, or a | and parmesan Brussel sprouts, or a |
| | combination thereof | combination thereof |

At least in some approaches, each modular meal component 10 is configured and/or formulated to reach the same internal temperature as other modular meal components when heated at the same time, at the same temperature, and for the same length of time in a conventional oven. For example, each modular meal component 10 may be configured and/or formulated to reach at least 165° F. (in another aspect, at least 167° F., at least 168° F., at least 169° F., or at least 170° F.) when heated from frozen for the heating time period and at a heating temperature. The formulation and/or configuration of a modular meal component 10 may need to be adjusted to provide a heating time that matches and/or is compatible with the heating time of the other modular meal components.

The modular meal component 10 may be configured and/or formulated to reach at least 165° F. (in another aspect, at least 167° F., at least 168° F., at least 169° F., or at least 170° F.) when heated from frozen for the heating time period and at the heating temperature by adjusting the characteristics and/or formulation of the modular meal component 10 to improve or reduce heating efficiency. Improved heating efficiency may reduce the heating time and/or heating temperature needed to achieve the desired temperature. Reduced heating efficiency may increase the heating time and/or heating temperature needed to achieve the desired temperature.

In one approach, one characteristic of the modular meal component 10 that may be adjusted is whether the modular meal component 10 includes the flexible film 18 during cooking. At least in some approaches, the inclusion of flexible film 18 on the modular meal component 10 may improve heating efficiency. As such, the flexible film 18 may be included in the modular meal component 10 to improve heating efficiency or excluded from the modular meal component 10 to reduce heating efficiency, as may be needed for a particular meal component.

In another approach, a characteristic of the modular meal component 10 that may be adjusted is the tray material. The inclusion of aluminum in the tray 12 may improve heating efficiency. As such, aluminum may be included in the tray 12 to improve heating efficiency or excluded from the tray 12 to reduce heating efficiency. Further, the amount of aluminum included in the tray 12 may be increased to improve heating efficiency or decreased to reduce heating efficiency. The tray 12 may also be coated (e.g., with a black and gold epoxy lacquer coating) to improve heating efficiency.

In another example, a characteristic of the modular meal component 10 that may be adjusted is the tray base surface area. Increasing the base surface area of the tray 12 may improve heating efficiency.

In another approach, the formulation of the modular meal component 10 may be adjusted is by adjusting the density of the combination of the meal component 14 and the sauce component 16. Denser components heat less efficiently than less dense components. As such, the density of the combination of the meal component 14 and the sauce component 16 may be decreased to improve heating efficiency or increased to reduce heating efficiency.

In another approach, the weight ratio of the meal component 14 to the sauce component 16 may be selected to provide a desired product density. The meal component 14 may be denser than the sauce component 16. As such, the weight ratio of the meal component 14 to the sauce component 16 may be decreased to reduce the density of the combination or increased to increase the density of the combination.

As another example, when the meal component 14 comprises pasta, the density of the combination of the meal component 14 and the sauce component 16 may be decreased by selecting a less dense noodle shape (e.g., conchiglie/shells) or increased by selecting a more dense noodle shape (e.g., gemelli).

In another approach, the modular meal component configuration may be adjusted by adjusting the air exposure of the combination of the meal component 14 and/or the amount of air pocket inclusion in the meal component 14. Air exposure and/or air pockets may improve heating efficiency. As such, the amount of air exposure and/or air pockets may be increased to improve heating efficiency or decreased to reduce heating efficiency.

One way the amount of air exposure may be adjusted is by adjusting the order of addition of the meal component 14 and the sauce component 16. The amount of air exposure of the meal component 14 may be increase by adding the sauce component 16 to the tray 18 before adding the meal component 14 to the tray 18 or decreased by adding the meal component 14 to the tray 18 before adding the sauce component 16.

Another way the amount of air pockets can be adjusted is by changing the way the meal component 14 (e.g., a protein component) is cut. For example, lateral or horizontal cut protein components may result in fewer air pockets, while vertical-cut protein components may result more air pockets.

Another way the modular meal component configuration may be adjusted is by adjusting the amount of overlap of pieces of the meal component 14. Overlap of pieces of the meal component 14 may reduce heating efficiency. As such, the amount of the overlap of pieces of the meal component 14 may be decreased to improve heating efficiency or increased to reduce heating efficiency.

One way the amount of overlap can adjusted is by changing the way the meal component 14 (e.g., a protein component) is cut. For example, lateral or horizontal cut protein components may result in more overlap, while vertical-cut protein components may result less overlap. Another way the amount of overlap may be adjusted is by adjusting the weight ratio of the meal component 14 to the sauce component 16. When less of the meal component 14 is included, there may be less overlap of pieces of the meal component 14. As such, the weight ratio of the meal component 14 to the sauce component 16 may be decreased to reduce overlap of pieces of the meal component 14 or increased to increase overlap of pieces of the meal component 14.

In another approach, the configuration of the modular meal component 10 may be adjusted by adjusting the order in which the meal component 14 and the sauce component 16 are added to the tray 12. The order in which the meal component 14 and the sauce component 16 are added to the tray 12 may reduce or prevent the meal component and/or sauce component forming ice blocks which thaw and cook in a slower and less uniform manner. By reducing or preventing the formation of ice blocks, more uniform heating and improved heating efficiency of the modular meal component 10 may be achieved. When the sauce component 16 is less viscous (e.g., has a viscosity within the range of about 6.75 cm to about 14 cm when measured at 70° F. with a Bostwick Consistometer using a 100 g sample and a 30 second time interval), the sauce component 16 may form more ice blocks than would form if the sauce component 16 was more viscous (e.g., had a viscosity within the range of about 3 cm to about 6.75 cm when measured at 70° F. with a Bostwick Consistometer using a 100 g sample and a 30 second time interval). As such, when the sauce component 16 is less viscous, the sauce component 16 may be added to the tray 12 before the meal component 14, and then the meal component 14 is added to the tray 12 atop the sauce component 16 to reduce or prevent the formation of ice blocks.

In some examples, the sauce component 16 may conduct heat to the meal component 14. In these examples, coating all or substantially all of the meal component 14 with the sauce component 16, may improve the heating efficiency of the modular meal component 10. In some examples, the sauce component 16 may insulate the meal component 14 from heat. In these examples, reducing the amount of the sauce component 16 atop the meal component 14, may improve the heating efficiency of the modular meal component 10.

In some examples, the sauce component 16 is added to the tray 12 before the meal component 14, and then the meal component 14 is added to the tray 12 atop the sauce component 16. In some examples, a first portion (e.g., about half, about 40% to about 60%, about 45% to about 55%, or about 50%) of the sauce component 16 is added to the tray 12 before the meal component 14, then the meal component 14 is added to the tray 12 atop the first portion of the sauce component 16, and then a second portion (e.g., the remaining amount) of the sauce component 16 is added to the tray 12 atop the meal component 14. In some examples, the sauce component 16 and the meal component 14 are added to the tray 12 in alternating layers of the sauce component 16 and the meal component 14. In these examples, any number of layers of each of the sauce component 16 and the meal component 14 may be used. In some examples, 2 to 5 layers, 3 layers, or 4 layers of each of the sauce component 16 and the meal component 14 are added alternatingly to the tray 12. In some examples, the sauce component 16 and the meal component 14 are mixed together before the sauce component 16 and the meal component 14 are added to the tray 12.

Still another way the formulation may be adjusted is by adjusting the amount of starch and/or saturated fat in the sauce component 16. It has been unexpectedly found that more starch and less saturated fat in the sauce component 16 may improve heating efficiency. As such, the amount of starch in the sauce component 16 may be increased and/or the amount of saturated fat in the sauce component 16 may be decreased to improve heating efficiency. Further, the amount of starch in the sauce component 16 may be decreased and/or the amount of saturated fat in the sauce component 16 may be increased to reduce heating efficiency. In some embodiments, the sauce component 16 is the cheese sauce, and the amount of starch in the cheese sauce is increased and/or the amount of saturated fat in the cheese sauce is decreased to improve heating efficiency.

Another way the formulation may be adjusted is by adjusting the amount of unsaturated fat and/or saturated fat in the sauce component 16. It has been unexpectedly found that more unsaturated fat and less saturated fat in the sauce component 16 may improve heating efficiency. As such, the amount of unsaturated fat in the sauce component 16 may be increased and/or the amount of saturated fat in the sauce component 16 may be decreased to improve heating efficiency. Further, the amount of unsaturated fat in the sauce component 16 may be decreased and/or the amount of saturated fat in the sauce component 16 may be increased to reduce heating efficiency.

Additionally, the formulation may be adjusted is by adjusting the total fat content in the sauce component 16. It has been unexpectedly found that increasing the total fat content of the sauce component 16 may improve heating efficiency. As such, the total fat content in the sauce component 16 may be increased to improve heating efficiency. Further, the total fat content in the sauce component 16 may be decreased to reduce heating efficiency.

Another way the formulation may be adjusted is by adjusting the total sugar content in the sauce component 16. In some embodiments, increasing the total sugar content of the sauce component 16 may increase the total solids content and the viscosity of the sauce component 16, which may improve heating efficiency. As such, the total sugar content in the sauce component 16 may be increased to improve heating efficiency. Further, the total sugar content in the sauce component 16 may be decreased to reduce heating efficiency.

Still another way the formulation may be adjusted is by adjusting the total solids in the sauce component 16. It has been unexpectedly found that increasing the total solids of the sauce component 16 may improve heating efficiency. As such, the total solids in the sauce component 16 may be increased to improve heating efficiency. Further, the total solids in the sauce component 16 may be decreased to reduce heating efficiency.

Yet another way the formulation may be adjusted, when the meal component 14 is pasta, is by adjusting the pasta yield. The pasta yield is calculated by dividing the weight of the pasta before it is cooked by the weight of the pasta after it is cooked. As such, the pasta yield includes the weight of the water the pasta absorbs during cooking. A greater pasta yield may reduce heating efficiency. As such, the pasta yield may be decreased to improve heating efficiency or increased to reduce heating efficiency.

Another way the formulation may be adjusted is by is by adjusting the viscosity of the sauce component 16. A less viscous sauce component 16 (e.g., having a viscosity within the range of about 6.75 cm to about 14 cm when measured at 70° F. with a Bostwick Consistometer using a 100 g sample and a 30 second time interval) may reduce or prevent the formation of ice blocks when the modular meal component 10 is frozen, which may improve heating efficiency. A more viscous sauce component 16 (e.g., having a viscosity within the range of about 3 cm to about 6.75 cm when measured at 70° F. with a Bostwick Consistometer using a 100 g sample and a 30 second time interval) may increase the ability of the sauce component 16 to conduct heat to the meal component 14. As such, the viscosity of the sauce component 16 may be selected to improve or reduce heating efficiency.

In another approach, modular meal component 10 may be configured and/or formulated to reach at least 165° F. or at least 167° F. by adjusting the seal strength of the flexible film 18 to the upper flange of the tray 12 and/or adjusting the moisture content of the modular meal component 10. If the seal strength is too weak (e.g., less than 10 inHg) and/or the moisture content is too high (e.g., greater than 95%), then the seal may break and vent too early and the modular meal component 10 may be unable to reach at least 165° F. or at least 167° F. during the heating time period. If the seal strength is too strong (e.g., greater than 15 inHg) and/or the moisture content is too low (e.g., less than 40%), then the seal may not break or vent and the modular meal component 10 may be unable to achieve desirable organoleptic properties and/or texture. As such, the seal strength of the flexible film 18 to the upper flange of the tray 12 and/or the moisture content of the modular meal component 10 may be selected to produce the desired heating efficiency and organoleptic properties.

The modular meal component 10 is configured and/or formulated to be heated in a conventional oven (e.g., a gas conventional oven or an electric conventional oven). The modular meal component 10 may not be configured and/or formulated to be heated in a microwave oven.

In some examples, the modular meal component 10 may come with instructions to heat the modular meal component in a conventional oven. In some examples, the modular meal component 10 may come with instructions to one or more of the following: (i) keep the modular meal component 10 frozen until ready for cooking, (ii) preheat a conventional oven to the heating temperature (e.g., a heating temperature within the range of about 350° F. to about 450° F., within the range of about 415° F. to about 435° F., or of about 425° F.), (iii) do not vent or remove the flexible film 18 before or during heating, (iv) do not rotate or stir the modular meal component 10, or otherwise intervene during heating, (v) place a number (e.g., 2, 3, or 4) modular meal components in the preheated conventional oven, (vi) bake for the heating time period (e.g., heating time period within the range of from about 20 minutes to about 60 minutes, within the range of from 20 minutes to about 40 minutes, of about 30 minutes), (vii) remove the modular meal components from the conventional oven, and (viii) let the modular meal component 10 stand for a period of time (e.g., about 1 minute) before serving.

In some approaches, the modular meal component 10 may come with instructions to heat the modular meal components side by side in a conventional oven or stacked upon each other in a conventional oven. Heating the modular meal components side by side in a conventional oven improves heating efficiency as compared to the heating efficiency when heating the modular meal components stacked upon each other in a conventional oven. Further, a modular meal component stacked in the middle of two other modular meal components will have a reduced heating efficiency as compared to the heating efficiency of such a modular meal component placed on the top or bottom of stack. As such, the modular meal component 10 may come with instructions to place the modular meal components in the conventional oven in a configuration that may help achieve the desired heating efficiency of the modular meal components.

The modular meal component 10 also has desirable quality and sensory characteristics. The meal component 14 and sauce component 16 may each have good color and texture. The meal component 14 and sauce component 16 may each have good organoleptic properties. The meal component 14 and sauce component 16 may each be considered “acceptable” to be eaten by a consumer. The has desirable quality and sensory characteristics of the modular meal component 10 may be affected by the inclusion of flexible film 18, the amount of air exposure, the amount of starch and/or saturated fat in the sauce component 16, the amount of unsaturated fat and/or saturated fat in the sauce component 16, and/or the pasta yield. As such, these factors may be adjusted so that desirable quality and sensory characteristics are achieved, while the modular meal component 10 is configured and/or formulated to reach at least 165° F. (at least 167° F., at least 168° F., at least 169° F., or at least 170° F.) when heated from frozen for the heating time period and at the heating temperature.

The modular meal component 10 may be frozen. In some examples, the modular meal component 10 may be frozen at a temperature within the range of about 0° F. to about 10° F. In other examples, the modular meal component 10 may be frozen at a temperature within the range of about 0° F. to about 5° F., or the range of about 5° F. to about 10° F. In still other examples, the modular meal component 10 may be frozen at a temperature of about 0° F. In some examples, sub-components of the modular meal component 10 may be individually quick frozen (IQF) before they are added to the modular meal component 10. In some examples, sub-components of the modular meal component 10 may be dehydrofrozen before they are added to the modular meal component 10. When the modular meal component 10 is frozen, the modular meal component 10 may have a shelf-life of at least about 18 months.

As disclosed herein is a modular meal set. Some examples of a modular meal set include: a first modular meal component including: a first tray; a first meal component disposed within the first tray; and a first sauce component disposed within the first tray; a second modular meal component including: a second tray; a second meal component disposed within the second tray; and a second sauce component disposed within the second tray; and a third modular meal component including: a third tray; a third meal component disposed within the third tray; and a third sauce component disposed within the third tray; wherein the first meal component, the second meal component, and the third meal component are each independently selected from a protein component, a starch component, and a vegetable component; and wherein each of the first, second, and third modular meal components is configured and/or formulated to reach at least 165° F. or at least 167° F. when heated together from frozen for a heating time period within the range of from about 20 minutes to about 60 minutes and at a heating temperature within the range of about 350° F. to about 450° F.

The first modular meal component, the second modular meal component, and the third modular meal component may each be as described above in any of the examples of the modular meal component 10. The first tray, the second tray, and the third tray may each be as described above in any of the examples of the tray 12. The first meal component, second meal component, and the third meal component may each be as described above in any of the examples of the meal component 14. The first sauce component, second sauce component, and the third sauce component may each be as described above in any of the examples of the sauce component 16.

In some examples, the first tray, the second tray, and the third tray are substantially similar to each other. In some examples, each tray may be formed from the same materials (e.g., aluminum and/or paper) and may have the same or similar (e.g., width, length, and depth). Dimensions may be considered to be similar to if they are with 1% of each other. In other examples, the trays may be different. In some examples, trays may be differentiated based on the meal component they include. In some of these examples, different tray colors may be used to denote the meal component included in a tray. In others of these examples, words printed on a tray may be used to denote the meal component included in the tray.

In some examples, the first modular meal component is a protein component; the second modular meal component is a starch component; and the third modular meal component is a vegetable component. In other examples, other combinations of meal components may be included in the modular meal set.

Also disclosed herein is a method of making a modular meal system. Some examples of a method of making a modular meal component include: configuring and/or formulating two or more modular meal components to each include a combination of a meal component and a sauce component that is capable of reaching at least 165° F. or at least 167° F. when heated from frozen for a heating time period within the range of from about 20 minutes to about 60 minutes and at a heating temperature within the range of about 350° F. to about 450° F.; and making each of the modular meal components by: precooking each of the meal component and the sauce component; and adding each of the meal component and the sauce component to a tray to form the modular meal component.

In some embodiments, the method includes configuring and/or formulating three or more modular meal components to each include in a combination of a meal component and a sauce component that is capable of reaching at least 165° F. or at least 167° F. when heated from frozen for a heating time period within the range of from about 20 minutes to about 60 minutes and at a heating temperature within the range of about 350° F. to about 450° F.

In some approaches, the modular meal system includes a first modular meal component and a second modular meal component, and the method includes: formulating the first modular meal component to include a combination of a first meal component and a first sauce component that is capable of reaching at least 165° F. when heated from frozen for a heating time period within the range of from about 20 minutes to about 60 minutes and at a heating temperature within the range of about 350° F. to about 450° F.; formulating the second modular meal component to include a combination of a second meal component and a second sauce component that is capable of reaching at least 165° F. when heated for the same heating time period and the same heating temperature as the first modular meal component; preparing the first modular meal component by adding each of the first meal component and the first sauce component to a first tray to form the first modular meal component; and preparing the second modular meal component by adding each of the second meal component and the second sauce component to a second tray to form the second modular meal component.

In some approaches, the modular meal system includes formulating a third modular meal component to include a combination of a third meal component and a third sauce component that is capable of reaching at least 165° F. when heated for the same heating time period and the same heating temperature as the first and second modular meal components; and preparing the third modular meal component by adding each of the third meal component and the third sauce component to a third tray to form the third modular meal component.

In some embodiments of the method, the heating time period for the first modular meal component and the second modular meal component is about 25 to about 35 minutes and the heating temperature is about 400° F. to about 450° F. In some embodiments of the method, the heating time period for the first modular meal component, the second modular meal component, and the third modular meal component is about 25 to about 35 minutes and the heating temperature is about 400° F. to about 450° F. In some embodiments of the method, the heating time period for the first modular meal component and the second modular meal component is about 30 minutes and the heating temperature is about 425° F.

In some examples of the method, formulating the first modular meal component comprises selecting a total solids content and viscosity of the first sauce component to enable the first modular meal component to reach at least 165° F. when heated from frozen in the heating time period; and wherein formulating the second modular meal component comprises selecting a total solids content and viscosity of the second sauce component to enable the second modular meal component to reach at least 165° F. when heated from frozen in the same heating time period as the first modular meal component. In some examples of the method, formulating the third modular meal component comprises selecting a total solids content and viscosity of the third sauce component to enable the third modular meal component to reach at least 165° F. when heated from frozen in the heating time period.

In some examples of the method, formulating the first modular meal component comprises selecting a total solids content, total fat content, and viscosity of the first sauce component to enable the first modular meal component to reach at least 165° F. when heated from frozen in the heating time period; and wherein formulating the second modular meal component comprises selecting a total solids content, total fat content, and viscosity of the second sauce component to enable the second modular meal component to reach at least 165° F. when heated from frozen in the same heating time period as the first modular meal component. In some examples of the method, formulating the third modular meal component comprises selecting a total solids content, total fat content, and viscosity of the third sauce component to enable the third modular meal component to reach at least 165° F. when heated from frozen in the heating time period. In some approaches, the total solids content, total fat content, and viscosity of the first sauce component are different from the total solids content, total fat content, and viscosity of the second sauce component.

In some embodiments of the method, the first meal component comprises the protein component, and the protein component is selected from chicken, beef, pork, finfish, shellfish, plant-based protein, and a combination thereof; and the second meal component comprises: the starch component, and the starch component is selected from potatoes, pasta, rice, bread, and a combination thereof; or the vegetable component, and the vegetable component is selected from broccoli, green beans, asparagus, corn, carrots, cauliflower, Brussel sprouts, edamame, red bell pepper, green bell pepper, and a combination thereof. In some embodiments of the method, the first meal component comprises the protein component, and the protein component is selected from chicken, beef, pork, finfish, shellfish, plant-based protein, and a combination thereof; and the second meal component comprises the starch component, and the starch component is selected from potatoes, pasta, rice, bread, and a combination thereof; and the third meal component comprises the vegetable component, and the vegetable component is selected from broccoli, green beans, asparagus, corn, carrots, cauliflower, Brussel sprouts, edamame, red bell pepper, green bell pepper, and a combination thereof.

In some approaches, the first sauce component and the second sauce component has a set of characteristics selected from one of the following groups: (a) a total fat content within the range of 0 g to about 5 g, per 100 g of the sauce component; a total solids content within the range of about 35% to about 45% at 70° F.; have a viscosity within the range of about 3 cm to about 6 cm, when measured at 70° F. with a Bostwick Consistometer using a 100 g sample and a 30 second time interval; and a moisture content within the range of about 65% to about 75%; or (b) a total fat content within the range of 0 g to about 10 g, per 100 g of the sauce component; a total solids content within the range of about 10% to about 20% at 70° F.; have a viscosity within the range of about 6.75 cm to about 12 cm, when measured at 70° F. with a Bostwick Consistometer using a 100 g sample and a 30 second time interval; and a moisture content within the range of about 80% to about 95%; or (c) a total fat content within the range of 5 g to about 15 g, per 100 g of the sauce component; a total solids content within the range of about 15% to about 20% at 70° F.; have a viscosity within the range of about 4.5 cm to about 8.5 cm, when measured at 70° F. with a Bostwick Consistometer using a 100 g sample and a 30 second time interval; and a moisture content within the range of about 70% to about 80%; or (d) a total fat content within the range of 15 g to about 20 g, per 100 g of the sauce component; a total solids content within the range of about 30% to about 40% at 70° F.; have a viscosity within the range of about 4.5 cm to about 8.5 cm, when measured at 70° F. with a Bostwick Consistometer using a 100 g sample and a 30 second time interval; and a moisture content within the range of about 60% to about 70%; or (e) a total fat content within the range of 10 g to about 20 g, per 100 g of the sauce component; a total solids content within the range of about 20% to about 30% at 70° F.; have a viscosity within the range of about 6.5 cm to about 10.5 cm, when measured at 70° F. with a Bostwick Consistometer using a 100 g sample and a 30 second time interval; and a moisture content within the range of about 70% to about 80%. In some approaches, the first sauce component and the second sauce component do not have the same set of characteristics.

In some approaches, the third sauce component has a set of characteristics selected from one of the following groups: (a) a total fat content within the range of 0 g to about 5 g, per 100 g of the sauce component; a total solids content within the range of about 35% to about 45% at 70° F.; have a viscosity within the range of about 3 cm to about 6 cm, when measured at 70° F. with a Bostwick Consistometer using a 100 g sample and a 30 second time interval; and a moisture content within the range of about 65% to about 75%; or (b) a total fat content within the range of 0 g to about 10 g, per 100 g of the sauce component; a total solids content within the range of about 10% to about 20% at 70° F.; have a viscosity within the range of about 6.75 cm to about 12 cm, when measured at 70° F. with a Bostwick Consistometer using a 100 g sample and a 30 second time interval; and a moisture content within the range of about 80% to about 95%; or (c) a total fat content within the range of 5 g to about 15 g, per 100 g of the sauce component; a total solids content within the range of about 15% to about 20% at 70° F.; have a viscosity within the range of about 4.5 cm to about 8.5 cm, when measured at 70° F. with a Bostwick Consistometer using a 100 g sample and a 30 second time interval; and a moisture content within the range of about 70% to about 80%; or (d) a total fat content within the range of 15 g to about 20 g, per 100 g of the sauce component; a total solids content within the range of about 30% to about 40% at 70° F.; have a viscosity within the range of about 4.5 cm to about 8.5 cm, when measured at 70° F. with a Bostwick Consistometer using a 100 g sample and a 30 second time interval; and a moisture content within the range of about 60% to about 70%; or (e) a total fat content within the range of 10 g to about 20 g, per 100 g of the sauce component; a total solids content within the range of about 20% to about 30% at 70° F.; have a viscosity within the range of about 6.5 cm to about 10.5 cm, when measured at 70° F. with a Bostwick Consistometer using a 100 g sample and a 30 second time interval; and a moisture content within the range of about 70% to about 80%. In some approaches, the first sauce component, the second sauce component, and the third sauce component do not have the same set of characteristics.

In some examples, making each of the modular meal components further includes hermetically sealing the meal component and the sauce component within the tray with a flexible film.

The modular meal component (including the first, second, and third modular meal components), the meal component (including the first, second, and third meal components), the sauce component (including the first, second, and third sauce components), the tray (including the first, second, and third trays), and the flexible film (including first, second, and third flexible films) may each be described above in any of the examples disclosed herein and may be included in any example of the modular meal component, the modular meal system, the modular meal set, or the method of making a modular meal system.

Configuring and/or formulating the combination of the meal component and the sauce component may be accomplished by adjusting formulation as described above. The meal component and the sauce component may be precooked separately or together.

The meal component and the sauce component may be added to the tray together or in any order. In some examples, the sauce component is added to the tray before the meal component is added to the tray. In these examples, the method may include adding the sauce component to the tray, and then adding the meal component to the tray atop the sauce component. In some examples, a first portion (e.g., about half or about 40% to about 60%) of the sauce component is added to the tray before the meal component is added to the tray, and a second portion (e.g., the remaining portion or the remaining about half) of the sauce component is added to the tray after the meal component is added to the tray. In these examples, the method may include adding a first portion of the sauce component to the tray, then adding the meal component to the tray atop the first portion of the sauce component, and then adding a second portion of the sauce component to the tray atop the meal component. In some examples, the sauce component and the meal component are added to the tray in alternating layers of the sauce component and the meal component. In these examples, the method may include adding alternating layers of the sauce component and the meal component to the tray. In these examples, any number of layers of the sauce component and the meal component may be used. In some examples, 2 to 5 layers, 3 layers, or 4 layers of each of the sauce component and the meal component are added to the tray. In some examples, the sauce component and the meal component are mixed together before they are added to the tray. In these examples, the method may include mixing the sauce component with the meal component to form a mixture, and then adding the mixture to the tray.

In some embodiments, the method may further include adding a topping to the tray. In some examples, the topping may be added atop the meal component and the sauce component. The topping may be described above in any of the examples disclosed herein.

In some examples, the method further includes freezing each of the modular meal components. For example, freezing of the modular meal component may be accomplished at a temperature within the range of about 0° F. to about 10° F. In some examples, freezing of the modular meal component may be accomplished at a temperature within the range of about 0° F. to about 5° F., or the range of about 5° F. to about 10° F. In other examples, freezing of the modular meal component may be accomplished at a temperature of about 0° F. In some examples, components or sub-components (e.g., the meal component) may be individually quick frozen (IQF) or dehydrofrozen before they are added to the tray.

To further illustrate the present disclosure, examples are given herein. It is to be understood that these examples are provided for illustrative purposes and are not to be construed as limiting the scope of the present disclosure.

### EXAMPLES

### Example 1

Multiple modular meal components were prepared to test the effect of different factors on the final temperature of the meal component. The general testing method included: (i) freezing the modular meal components to a temperature within the range of 5° F. to 100° F., heating two frozen modular meal components in a conventional oven for 30 minutes at 425° F., (ii) placing the heated modular meal components on a cloth-insulated lab bench surface, and (iii) measuring temperatures of the meal component using a thermocouple. The temperatures were measured as quickly as possible after the trays were removed from the oven. In each tray, the temperature in each of nine equally-sized zones was measured and recorded. A grid defining the nine equally-sized zones was created by dividing each of the width and the length of a tray into three equal sections. The temperature of each zone was measured by inserting the thermocouple into the thickest portion of the meal component in the zone avoiding air pockets. The testing order and oven position for each tray was randomized. The center zone was typically the coldest zone in each tray.

First, the effect on heating efficiency of using a paperboard tray with a width of 10 inches and a length of 9 inches versus using a paperboard tray with a width of 10 inches and a length of 9.5 inches was tested across several dishes (mac and cheese, broccoli with cheese sauce, honey barbeque chicken, potato wedges, and tortellini). The effect of heating with and without a flexible film was also tested. The trays were weighed before and after heating to determine moisture loss.

It was discovered that whether a flexible film was used had a greater effect on the final temperatures than the which size tray was used. It was also discovered that the presence of a plastic lid had a greater effect on dishes that included a larger amount of the sauce component (mac and cheese, broccoli with cheese sauce, honey barbeque chicken). For these dishes, the presence of a flexible film raised the final temperatures up to 20° F. to 30° F. hotter than the final temperatures that were achieved when a flexible film was not used. It is believed that this increase in final temperatures may have been due, at least in part, to the flexible film retaining steam, which assists in heating. The dishes that had a flexible film had lower percent water losses that those that did not have a flexible film, further indicating that the dishes that had a flexible film retained steam.

While the presence of the flexible film raised the final temperatures, the retained steam may result in other effects on the dishes. It was discovered that the broccoli was greener and had better texture when the flexible film was not present.

It was further discovered that the greater degree of ingredient overlap in the smaller trays resulted in cold spots.

Second, the effect on heating efficiency of using ten different tray designs was tested with mashed potatoes as the dish. The ten tray designs included: (1) a 9.5 inches (length) by 10 inches (width) paperboard tray, (2) a 9.5 inches (length) by 10 inches (width) paperboard tray with aluminum tape in a “+” sign on the interior portion, (3) a 9.5 inches (length) by 10 inches (width) paperboard tray with the interior lined with aluminum foil, (4) a 9.5 inches (length) by 10 inches (width) paperboard tray with a raised center that completely excluded the center from containing product (the meal component or the sauce component), (5) a 9.5 inches (length) by 10 inches (width) paperboard tray with a slightly raised center upon which product (the meal component and the sauce component) could sit, (6) a 9.5 inches (length) by 10 inches (width) aluminum tray, (7) a 9.5 inches (length) by 10 inches (width) paper tray with a layer of aluminum foil lining, (8) a 9.5 inches (length) by 10 inches (width) paper tray with a slightly raised center upon which product (the meal component and the sauce component) could sit and aluminum tape in a “+” sign on the interior portion, (9) a 9.5 inches (length) by 10 inches (width) paper tray with aluminum tape in a grid on the interior portion, and (10) a 9.5 inches (length) by 10 inches (width) paper tray with aluminum tape in a “+” sign on the interior portion. Some of the tray were designed to potentially help heat the center (typically the coldest zone in each tray).

It was discovered that including aluminum in the tray design increased the heating efficiency. Lining the trays with aluminum foil or adding aluminum tape increased the final temperatures. Further, the aluminum tray (tray design 6) resulted in the highest final temperatures.

It was also discovered that raising the center of the trays either completely to excluded product from the center or slightly such that product could sit on it did not result in higher final temperatures and just moved the cold spot away from the center of the trays.

Third, the effect on heating efficiency of using four different noodle shapes was tested with mac and cheese as the dish. The four noodle shapes included: (1) gemelli—a dense, curly noodle, (2) conchiglie/shells—a thin, flat noodle with a larger exposed surface, (3) rigatoni—a tube-shaped noodle, (4) farfalle/bowtie—a smaller noodle that packs tightly together with the sauce.

It was discovered that the conchiglie/shells pasta resulted in the highest final temperatures. It is believed that this increase in final temperatures may have been due, at least in part, to the conchiglie/shells pasta being less densely packed and more exposed to air than the other types of pasta.

While the air exposure raised the final temperatures, the air exposure may result in other effects on the dishes. It was discovered that the conchiglie/shells pasta resulted in more crisping and burning than the other types of pasta.

It was also discovered that the gemelli pasta resulted in the lowest final temperatures. It is believed that this decrease in final temperatures may have been due, at least in part, to the gemelli noodles being more dense that the other pasta noodles and the gemelli pasta being more densely packed with the sauce component than the other types of pasta.

While the conchiglie/shells pasta resulted in the highest final temperatures and that the gemelli pasta resulted in the lowest final temperatures, the difference between the final temperatures of the pastas was slight.

It was further discovered that the gemelli pasta resulted in desirable sensory characteristics. It is believed that the desirable sensory characteristics may have been due, at least in part, to the reduction in air exposure of the gemelli pasta. The shape of the gemelli pasta allowed it to be submerged under the cheese sauce. The shape and ridges of the gemelli pasta also allowed the cheese sauce to cling to it better than the other pasta.

Fourth, the effect on heating efficiency of the order of addition of the meal component and the sauce component was tested with mac and cheese (with conchiglie/shells noodles and gemelli noodles) as the dish. Adding the pasta to the tray first and then adding the cheese sauce was compared to adding the cheese sauce to the tray first and then adding the pasta.

It was discovered that adding the cheese sauce to the tray before adding the pasta resulted in higher final temperatures than adding the pasta to the tray before adding the cheese sauce. It was also discovered that that adding the cheese sauce to the tray before adding the pasta resulted in more dryness and crisping than adding the pasta to the tray before adding the cheese sauce. It is believed that these results may have been due, at least in part, to the pasta having greater air exposure when the cheese sauce is added to the tray before the pasta than when the pasta is added to the tray before the cheese sauce.

Fifth, the effect on heating efficiency of using two different tray designs was tested with barbeque chicken as the dish. The two tray designs included: (1) a 8.5 inches (length) by 10 inches (width) paper tray, and (2) a 7.75 inches (length) by 9.75 inches (width)) aluminum tray.

It was discovered that where the chicken overlapped the final temperature was reduced. The smaller tray included more points of overlap than the larger tray.

Sixth, the effect on heating efficiency of different sauce compositions was tested with mac and cheese as the dish in paper trays and aluminum trays. The sauce compositions included: (1) a sauce with more starch, and (2) a sauce with more saturated fat.

It was found that the sauce with more starch resulted in higher final temperatures than the sauce with more saturated fat.

Seventh, the effect on heating efficiency of the chicken to sauce ratio was tested with barbeque chicken as the dish.

It was found that reducing the chicken to sauce ratio increased the final temperatures of the dish. It is believed that this result may have been due, at least in part, to the lowering of the overall density of the dish and the reduction in overlap of the chicken when less chicken was included in the tray.

Eighth, the effect on heating efficiency of two different chicken fill weights was tested with whole breast slices. The two chicken fill weights included: (1) a 5 serving (700 g) fill weight, and (2) a 4 serving (560 g) fill weight.

It was discovered that the different fill weights resulted in little difference in the final temperatures of the chicken. It was also found that thinner chicken pieces had higher final temperatures than the thicker chicken pieces.

Ninth, the effect on heating efficiency of two different ways to cut chicken breast was tested. The two ways to cut chicken breast included: (1) 0.5 inch vertical-cut chicken strips, and (2) lateral whole-breast slices with a maximum thickness of 0.5 inches.

It was discovered that the vertical-cut chicken strips resulted in higher final temperatures than the lateral whole-breast slices even though the lateral whole-breast slices were thinner than the vertical-cut chicken strips. It is believed that this result may have been due, at least in part, to there being less overlap of chicken pieces with the vertical-cut chicken strips than with the lateral whole-breast slices.

### Example 2

Additional modular meal components were prepared to test the effect on heating efficiency of the percentage of oil in the sauce component and of the pasta yield with mac and cheese as the dish. Each of the modular meal components included: a 10 inch (width) paperboard black tray, pasta as the meal component, and cheese sauce as the sauce component. Each of the modular meal components included 5 cups of mac and cheese.

In some of the modular meal components, the cheese sauce was formulated without oil. In others of the modular meal components, the cheese sauce was formulated to include soybean oil (e.g., 15 wt %, 20 wt %, 25 wt % oil).

For each of the modular meal components, the pasta yield was also determined. The pasta yield is calculated by dividing the weight of the pasta before it is cooked by the weight of the pasta after it is cooked.

The amount of oil included in the cheese sauce and the pasta yield of each of the modular meal components is shown in Table 4.

TABLE 4

| | Amount of oil | |
|---|---|---|
| | included in | |
| Modular meal component | cheese sauce | Pasta yield |
| Modular meal component 1 | 15 wt % | 230% |
| (MMC 1) | | |
| Modular meal component 2 | 20 wt % | 230% |
| (MMC 2) | | |
| Modular meal component 3 | 25 wt % | 230% |
| (MMC 3) | | |
| Modular meal component 4 | 0 wt % | 275% |
| (MMC 4) | | |
| Modular meal component 5 | 0 wt % | 275% |
| (MMC 5) | | |
| Modular meal component 6 | 0 wt % | 350% |
| (MMC 6) | | |
| Modular meal component 7 | 0 wt % | 350% |
| (MMC 7) | | |
| Modular meal component 8 | 0 wt % | 425% |
| (MMC 8) | | |
| Modular meal component 9 | 0 wt % | 425% |
| (MMC 9) | | |

Each of the modular meal components was frozen at a temperature within the range of 0° F. to 10° F. Then, each of the modular meal components was heated in a conventional oven for 30 minutes at 425° F. with one other frozen modular meal component. The temperatures of the pasta were measured as quickly as possible after the trays were removed from the oven. In each modular meal component, the temperature in each of ten equally-sized zones was measured and recorded. A grid defining the ten equally-sized zones was created by dividing the width of a tray into five equal sections and the length of a tray into two equal sections. The temperature of each zone was measured by inserting the thermocouple into the thickest portion of the pasta avoiding air pockets. The testing order and oven position for each tray was randomized.

The temperatures of the pasta in each of the modular meal components are shown in Table 5.

TABLE 5

| | MMC | MMC | MMC | MMC | MMC | MMC | MMC | MMC | MMC |
|---|---|---|---|---|---|---|---|---|---|
| | 1 | 2 | 3 | 4 | 5 | 6 | 7 | 8 | 9 |
| Temp. in zone 1 | 195 | 200 | 207 | 161 | 205 | 208 | 195 | 199 | 153 |
| (in ° F.) | | | | | | | | | |
| Temp. in zone 2 | 194 | 196 | 199 | 173 | 195 | 193 | 176 | 166 | 155 |
| (in ° F.) | | | | | | | | | |
| Temp. in zone 3 | 210 | 200 | 209 | 197 | 209 | 206 | 194 | 178 | 153 |
| (in ° F.) | | | | | | | | | |
| Temp. in zone 4 | 205 | 188 | 189 | 178 | 208 | 192 | 154 | 173 | 162 |
| (in ° F.) | | | | | | | | | |
| Temp. in zone 5 | 177 | 170 | 183 | 159 | 185 | 173 | 140 | 146 | 138 |
| (in ° F.) | | | | | | | | | |
| Temp. in zone 6 | 192 | 200 | 194 | 175 | 196 | 198 | 178 | 182 | 150 |
| (in ° F.) | | | | | | | | | |
| Temp. in zone 7 | 195 | 206 | 209 | 193 | 204 | 199 | 175 | 190 | 166 |
| (in ° F.) | | | | | | | | | |
| Temp. in zone 8 | 206 | 198 | 206 | 186 | 200 | 181 | 150 | 177 | 142 |
| (in ° F.) | | | | | | | | | |
| Temp. in zone 9 | 207 | 200 | 204 | 200 | 210 | 202 | 163 | 187 | 153 |
| (in ° F.) | | | | | | | | | |
| Temp. in zone 10 | 177 | 176 | 178 | 166 | 180 | 163 | 137 | 153 | 130 |
| (in ° F.) | | | | | | | | | |
| Average temp. | 195.8 | 193.4 | 197.8 | 178.8 | 199.2 | 191.5 | 166.2 | 175.1 | 150.2 |
| (in ° F.) | | | | | | | | | |

As shown in Table 5, each of the modular meal components that included soybean oil (MMC 1, MMC 2, and MMC 3) were able to reach a temperature of at least 167° F. when heated from frozen for 30 minutes at 425° F. As also shown in Table 5, the modular meal components that had lower pasta yields had higher final temperatures.

The quality characteristics of each of the modular meal components were also scored on a pass/fail basis. The quality characteristics score is based on the firmness/softness of the pasta and indicates whether the mac and cheese in the modular meal component would be considered “acceptable” to be eaten by a consumer. The quality characteristics scores for the modular meal components are shown in Table 6.

TABLE 6

| | Quality |
|---|---|
| | characteristics |
| Modular meal component | score |
| MMC 1 | Pass |
| MMC 2 | Pass |
| MMC 3 | Pass |
| MMC 4 | Pass |
| MMC 5 | Pass |
| MMC 6 | Pass |
| MMC 7 | Pass |
| MMC 8 | Fail |
| MMC 9 | Fail |

As shown in Table 6 each of the modular meal components that included soybean oil (MMC 1, MMC 2, and MMC 3) achieved a passing score for quality characteristics. As also shown in Table 6, the modular meal components that had the highest past yields (MMC 8 and MMC 9) received failing scores for quality characteristics, while the modular meal components that had lower pasta yields achieved passing scores for quality characteristics.

### Example 3

Heating studies were preformed to determine the heating curves of potential sub-components of the modular meal components. The potential sub-components were water/ice, broccoli, tri-cut red potatoes, vertical-cut chicken strips, cheese sauce, and honey barbeque sauce. The potential sub-components were generated by freezing the potential sub-components at a temperature within the range of 0° F. to 10° F. and then heating the frozen potential sub-components in a conventional oven at 425° F. The temperatures of the potential sub-components were measure after certain time intervals of heating to generate a heating curve for each of the potential sub-components.

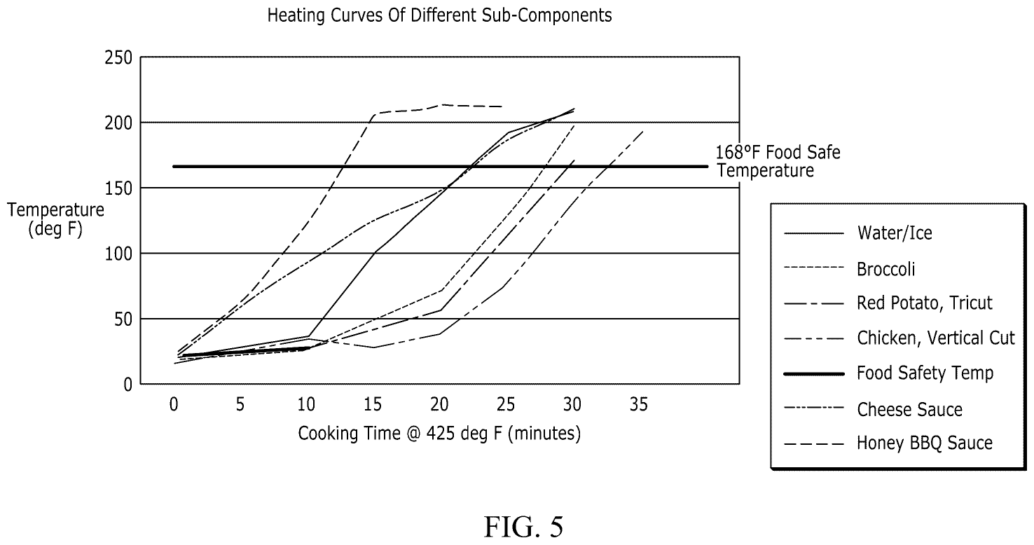

The heating curve of each of the potential sub-components in shown in FIG. 5. As shown in FIG. 5, potential meal components, such as chicken, broccoli, and potatoes heated more slowly that potential sauce components, such as water/ice, cheese sauce, and honey barbeque sauce.

Additional heating studies were preformed to determine the effect on heating efficiency of the mass of other meals in the oven. In these heating studies, one tray of frozen russet potatoes (550 g) and two trays of ice were heated together in a conventional oven for 30 minutes at 425° F. Then, the temperature of the center of the potatoes was measured as quickly as possible after the tray was removed from the oven.

In two of the heating studies, the tray of frozen russet potatoes included a flexible film during heating, and in one of the heating studies, the tray of frozen russet potatoes did not include a flexible film during heating. In two of the heating studies, each tray of ice included 550 g of ice, and in one of the heating studies, each tray of ice included 700 g of ice.

The results of this heating study are shown in Table 7.

TABLE 7

| | | | Temp. of the center |
|---|---|---|---|
| | | | of the potatoes after |
| | | | heating |
| Tray 1 | Tray 2 | Tray 3 | (in ° F.) |
| 550 g of russet | 550 g of ice | 550 g of ice | 195.8 |
| potatoes with flexible | | | |
| film | | | |
| 550 g of russet | 550 g of ice | 550 g of ice | 181.7 |
| potatoes without | | | |
| flexible film | | | |
| 550 g of russet | 700 g of ice | 700 g of ice | 168.2 |
| potatoes with flexible | | | |
| film | | | |

As shown in Table 7, the temperature of the center of the potatoes decreased when the weight of the ice in the other two trays was increased. This indicates that the mass of other meals in the oven may reduce the heating efficiency of a modular meal component.

As also shown in Table 7, the temperature of the center of the potatoes decreased when a flexible film was used. This indicates that the flexible film may increase the heating efficiency of a modular meal component.

### Example 4

Three examples of the modular meal component disclosed herein were prepared.

The first example of the modular meal component included broccoli as the meal component and cheese sauce as the sauce component. The broccoli was 1-inch broccoli florets that were individually quick frozen (IQF). The cheese sauce had a viscosity of 480 cP. The viscosity of the cheese sauce was measured with a Brookfield DV3T viscometer using a H2 spindle, at 10 RPM and a temperature of 71° F.

The general formulation of the first example modular meal component is shown in Table 8, with the wt % of each ingredient that was used (based on the total weight of the combination of the meal component and the sauce component).

TABLE 8

| | First example |
|---|---|
| | modular meal |
| | component |
| Ingredient | (wt %) |
| 1-inch IQF Broccoli | 47.00 |
| Florets | |
| Cheese Sauce | 45.00 |
| Shredded Cheddar | 3.00 |
| Cheese (Topping) | |
| Breadcrumb | 5.00 |
| (Topping) | |

The first example modular meal component reached at least 167° F. when three aluminum (7.75 inches (length) by 9.75 inches (width) by 1.77 inches (depth)) trays of the first example modular meal component were heated from frozen in a conventional oven for 30 minutes at 425° F.

The second example of the modular meal component included potatoes as the meal component and olive oil and seasoning sauce as the sauce component. The seasoning sauce had a viscosity of 1,850 cP. The viscosity of the seasoning sauce was measured with a Brookfield DV3T viscometer using a H2 spindle, at 10 RPM and a temperature of 68° F.

The general formulation of the second example modular meal component is shown in Table 9, with the wt % of each ingredient that was used (based on the total weight of the combination of the meal component and the sauce component).

TABLE 9

| | Second |
|---|---|
| | example |
| | modular meal |
| | component |
| Ingredient | (wt %) |
| IQF Roasted Rounded Red | 54.69 |
| Potatoes | |
| Diced Onions | 20.00 |
| Olive Oil | 11.00 |
| Parmesan Cheese | 6.00 |
| Double Toasted Panko | 7.50 |
| Breadcrumbs | |
| Food Grade Salt | 0.25 |
| Garlic Powder | 0.25 |
| IQF Parsley Flakes | 0.25 |
| Ground Black Pepper | 0.06 |

The second example modular meal component reached at least 167° F. when three aluminum (7.75 inches (length) by 9.75 inches (width) by 1.77 inches (depth)) trays of the second example modular meal component were heated from frozen in a conventional oven for 30 minutes at 425° F.

The third example of the modular meal component included chicken as the meal component and honey barbeque sauce as the sauce component. The chicken was vertical-cut chicken breasts that were individually quick frozen (IQF). The honey barbeque sauce had a viscosity of 13,800 cP. The viscosity of the honey barbeque sauce was measured with a Brookfield DV3T viscometer using a H2 spindle, at 10 RPM and a temperature of 75° F.

The general formulation of the third example modular meal component is shown in Table 10, with the wt % of each ingredient that was used (based on the total weight of the combination of the meal component and the sauce component).

TABLE 10

| | First example |
|---|---|
| | modular meal |
| | component |
| Ingredient | (wt %) |
| Vertical-Cut IQF | 51.00 |
| Chicken Breasts | |
| Honey Barbeque | 49.00 |
| Sauce | |

The third example modular meal component reached at least 167° F. when three aluminum (7.75 inches (length) by 9.75 inches (width) by 1.77 inches (depth)) trays of the third example modular meal component were heated from frozen in a conventional oven for 30 minutes at 425° F.

### Example 5

Nine additional examples of the modular meal component disclosed herein were prepared. Each of the additional example modular meal components included an aluminum tray with a width at the top of about 9.75 inches, a width at the bottom of about 8.5 inches, a length at the top of about 7.75 inches, a length at the bottom of about 6.5 inches, a depth of about 1.75 inches, and a black and gold epoxy lacquer coating (AlucoatO CS, from Coppice Alupack Ltd.). Each of the modular meal components also included KPEEL™ 7G+AF (a heat-sealable polyester film with an anti-fog treatment available from KM Packaging Services Ltd.) as the flexible film.

The first additional example of the modular meal component was a barbeque pork modular meal component that included pork as the meal component and barbeque sauce as the sauce component. The barbeque pork modular meal component included about 4.5 servings (about 140 g each). The weight ratio of the pork to the barbeque sauce in the barbeque pork modular meal component was 1.5:1.

The pork was shredded, seasoned, and fully cooked (i.e., cooked to an internal temperature of at least 165° F.). The pork was then individually quick frozen (IQF).

The general formulation of the barbeque pork modular meal component is shown in Table 11, with the wt % of each ingredient that was used (based on the total weight of the combination of the meal component and the sauce component).

TABLE 11

| | Barbeque pork modular meal component | |
|---|---|---|
| Ingredient | (wt %) | |
| IQF Pork | 60.00 | |
| Barbeque Sauce | 40.00 | |
| | Water | 19.35 |
| | Sugar | 7.20 |
| | Tomato Paste | 8.00 |
| | Molasses | 0.80 |
| | Vinegar | 3.20 |
| | Corn Starch | 0.60 |
| | Salt | 0.34 |
| | Spices and Flavors | 0.51 |

| | |
|---|---|
| Total | 100.00 |

The barbeque sauce ingredients were combined and blended to form a generally homogenous sauce. The barbeque sauce had a viscosity of 9.5 cm when measured at 150° F. with a Bostwick Consistometer (CSC Scientific 2492500) using a 100 g sample and a 30-second time interval, a viscosity of 4.5 cm when measured at 70° F. with the Bostwick Consistometer using a 100 g sample and a 30-second time interval, a total solids content of 39% when measured at 150° F., and a total solids content of 42% when measured at 70° F. Total solids were measured herein by a digital refractometer from Bellingham & Stanley. The barbeque sauce had a moisture content of 70.5%.

The barbeque pork modular meal component was prepared by adding the barbeque sauce to the tray, then adding the pork atop the barbeque sauce, and then hermetically sealing the flexible film to the upper flange of the tray.

The barbeque pork modular meal component reached at least 165° F. when three modular meal components were heated from frozen in a conventional oven for 30 minutes at 425° F.

The second additional example of the modular meal component was an Italian meatballs with marinara modular meal component that included beef as the meal component and marinara sauce as the sauce component. The Italian meatballs with marinara modular meal component also included cheese as a topping. The Italian meatballs with marinara modular meal component included about 4.5 servings (about 140 g each). The weight ratio of the beef to the marinara sauce was about 2.13:1.

The beef was Italian meatballs that were cooked and then individually quick frozen (IQF).

The general formulation of the Italian meatballs with marinara modular meal component is shown in Table 12, with the wt % of each ingredient that was used (based on the total weight of the combination of the meal component, the sauce component, and the topping).

TABLE 12

| | Italian meatballs with marinara modular meal | |
|---|---|---|
| | component | |
| Ingredient | (wt %) | |
| IQF Italian meatballs | 64.00 | |
| Marinara sauce | 30.00 | |
| | Water | 18.00 |
| | Olive Oil | 0.15 |
| | Diced Onions | 0.90 |
| | Sugar | 0.21 |
| | Cheeses | 0.45 |
| | Diced Tomatoes | 3.90 |
| | Tomato Paste | 4.80 |
| | Corn Starch | 0.38 |
| | Salt | 0.30 |
| | Herbs, Spices, and Flavors | 0.91 |

| | |
|---|---|
| Cheeses (Topping) | 6.00 |
| Total | 100.00 |

The marinara sauce ingredients were combined and blended to form a generally homogenous sauce. The marinara sauce had a viscosity of 12 cm when measured at 150° F. with a Bostwick Consistometer (CSC Scientific 2492500) using a 100 g sample and a 30-second time interval, a viscosity of 9 cm when measured at 70° F. with the Bostwick Consistometer using a 100 g sample and a 30-second time interval, a total solids content of 11% when measured at 150° F., and a total solids content of 15% when measured at 70° F. The marinara sauce had a moisture content of 87.93%.

The Italian meatballs with marinara modular meal component was prepared by adding the marinara sauce to the tray, then adding the beef atop the marinara sauce, then adding the cheeses atop the beef, and then hermetically sealing the flexible film to the upper flange of the tray.

The Italian meatballs with marinara modular meal component reached at least 165° F. when three modular meal components were heated from frozen in a conventional oven for 30 minutes at 425° F.

The third additional example of the modular meal component was a honey barbeque chicken modular meal component that included chicken as the meal component and honey barbeque sauce as the sauce component. The honey barbeque chicken modular meal component included about 4.5 servings (about 140 g each). The weight ratio of the chicken to the honey barbeque sauce in the honey barbeque chicken modular meal component was about 1.86:1.

The chicken was chicken breast that was seasoned and fully cooked (i.e., cooked to an internal temperature of at least 165° F.) and then individually quick frozen (IQF).

The general formulation of the honey barbeque chicken modular meal component is shown in Table 13, with the wt % of each ingredient that was used (based on the total weight of the combination of the meal component and the sauce component).

TABLE 13

| | Honey barbeque chicken modular meal | |
|---|---|---|
| | component | |
| Ingredient | (wt %) | |
| IQF Chicken Breast | 65.00 | |
| Honey Barbeque Sauce | 35.00 | |
| | Water | 17.44 |
| | Sugar | 4.20 |
| | Tomato Paste | 5.60 |
| | Honey | 4.20 |
| | Apple Cider Vinegar | 1.75 |
| | Corn Starch | 1.05 |
| | Salt | 0.33 |
| | Spices and Flavors | 0.43 |

| | |
|---|---|
| Total | 100.00 |

The honey barbeque sauce ingredients were combined and blended to form a generally homogenous sauce. The honey barbeque sauce had a viscosity of 9.5 cm when measured at 150° F. with a Bostwick Consistometer (CSC Scientific 2492500) using a 100 g sample and a 30-second time interval, a viscosity of 4 cm when measured at 70° F. with the Bostwick Consistometer using a 100 g sample and a 30-second time interval, a total solids content of 33% when measured at 150° F., and a total solids content of 36% when measured at 70° F. The honey barbeque sauce had a moisture content of 68%.

The honey barbeque chicken modular meal component was prepared by adding the honey barbeque sauce to the tray, then adding the chicken atop the honey barbeque sauce, and then hermetically sealing the flexible film to the upper flange of the tray.

The honey barbeque chicken modular meal component reached at least 165° F. when three modular meal components were heated from frozen in a conventional oven for 30 minutes at 425° F.

The fourth additional example of the modular meal component was an Italian cauliflower modular meal component and included cauliflower and red bell pepper as the meal component and olive oil as the sauce component. The Italian cauliflower modular meal component also included breadcrumbs and cheese as toppings. The Italian cauliflower modular meal component included about 5 servings (about 85 g each). The weight ratio of the cauliflower and red bell pepper to the olive oil was about 13.92:1.

The cauliflower was cauliflower florets that were blanched and then individually quick frozen (IQF). The red bell pepper was diced and blanched and then individually quick frozen (IQF).

The general formulation of the Italian cauliflower modular meal component is shown in Table 14, with the wt % of each ingredient that was used (based on the total weight of the combination of the meal component, the sauce component, and the toppings).

TABLE 14

| | Italian cauliflower |
|---|---|
| | modular meal component |
| Ingredient | (wt %) |
| IQF Cauliflower Florets | 75.50 |
| IQF Diced Red Bell | 8.00 |
| Pepper | |
| Olive Oil sauce | 6.00 |
| Herbs and Spices | 2.50 |
| Breadcrumbs (Topping) | 3.00 |
| Cheeses (Topping) | 5.00 |
| Total | 100.00 |

The Italian cauliflower modular meal component was prepared by mixing the cauliflower, red bell pepper, olive oil, and herbs and spices, separately mixing the breadcrumbs and cheeses, adding the cauliflower, red bell pepper, olive oil, and herbs and spices mixture to the tray, then adding the breadcrumbs and cheeses mixture to the tray atop the cauliflower, red bell pepper, olive oil, and herbs and spices mixture, and then hermetically sealing the flexible film to the upper flange of the tray.

The Italian cauliflower modular meal component reached at least 165° F. when three modular meal components were heated from frozen in a conventional oven for 30 minutes at 425° F.

The fifth additional example of the modular meal component was a savory green beans modular meal component that included green beans as the meal component and savory sauce as the sauce component. The savory green beans modular meal component also included breadcrumbs as a topping. The savory green beans modular meal component included about 4 servings (about 110 g each). The weight ratio of the green beans to the savory sauce was about 2.5:1.

The green beans were 1-inch cut green beans that were blanched and then individually quick frozen (IQF).

The general formulation of the savory green beans modular meal component is shown in Table 15, with the wt % of each ingredient that was used (based on the total weight of the combination of the meal component, the sauce component, and the topping).

TABLE 15

| | Savory green beans modular meal component | |
|---|---|---|
| Ingredient | (wt %) | |
| IQF Green Beans | 70.00 | |
| Savory Sauce | 28.00 | |
| | Water | 19.08 |
| | Corn Starch | 0.56 |
| | Chicken Base | 1.12 |
| | Whey Protein Powder | 0.56 |
| | Cheese | 1.12 |
| | Half & Half | 1.54 |
| | Butter | 0.98 |
| | Onions | 1.05 |
| | Mushroom Base | 1.12 |
| | Sodium Phosphate | 0.14 |
| | Herbs, Spices, and | 0.73 |
| | Flavors | |

| | |
|---|---|
| Breadcrumbs | 2.00 |
| (Topping) | |
| Total | 100.00 |

The savory sauce ingredients were combined and blended to form a generally homogenous sauce. The savory sauce had a viscosity of 13.5 cm when measured at 150° F. with a Bostwick Consistometer (CSC Scientific 2492500) using a 100 g sample and a 30-second time interval, and a total solids content of 16% when measured at 150° F. The savory sauce had a moisture content of 83.55%.

The savory green beans modular meal component was prepared by adding the savory sauce to the tray, then adding the green beans atop the savory sauce, then adding the breadcrumbs to the tray atop the green beans, and then hermetically sealing the flexible film to the upper flange of the tray.

The savory green beans modular meal component reached at least 165° F. when three modular meal components were heated from frozen in a conventional oven for 30 minutes at 425° F.

The sixth additional example of the modular meal component was a cheddar broccoli modular meal component and included broccoli as the meal component and cheese sauce as the sauce component. The cheddar broccoli modular meal component also included breadcrumbs and cheese as toppings. The cheddar broccoli modular meal component included about 5 servings (about 109 g each). The weight ratio of the broccoli to the cheese sauce was about 1.04:1.

The broccoli was 1-inch broccoli florets that were blanched and then individually quick frozen (IQF).

The general formulation of the cheddar broccoli modular meal component is shown in Table 16, with the wt % of each ingredient that was used (based on the total weight of the combination of the meal component, the sauce component, and the toppings).

TABLE 16

| | Cheddar broccoli modular meal component | |
|---|---|---|
| Ingredient | (wt %) | |
| IQF Broccoli | 47.00 | |
| Cheese Sauce | 45.00 | |
| | Water | 23.90 |
| | Cheese and Cheese | 13.73 |
| | Paste | |
| | Whey Protein | 1.13 |
| | Corn Starch | 0.45 |
| | Half & Half | 4.50 |
| | Salt | 0.18 |
| | Sodium Phosphate | 0.14 |
| | Spices and Flavors | 0.97 |

| | |
|---|---|
| Breadcrumbs (Topping) | 5.00 |
| Cheese (Topping) | 3.00 |
| Total | 100.00 |

The cheese sauce ingredients were combined and blended to form a generally homogenous sauce. The cheese sauce had a viscosity of 9.5 cm when measured at 150° F. with a Bostwick Consistometer (CSC Scientific 2492500) using a 100 g sample and a 30-second time interval, and a total solids content of 16% when measured at 150° F. The cheese sauce had a moisture content of 74.49%.

The cheddar broccoli modular meal component was prepared by adding the broccoli to the tray, then adding the cheese sauce to the tray atop the broccoli, then adding the breadcrumbs and cheese to the tray atop the cheese sauce, and then hermetically sealing the flexible film to the upper flange of the tray.

The cheddar broccoli modular meal component reached at least 165° F. when three modular meal components were heated from frozen in a conventional oven for 30 minutes at 425° F.

The seventh additional example of the modular meal component was a scalloped potatoes modular meal component and included potatoes as the meal component and scalloped potato sauce as the sauce component. The scalloped potatoes modular meal component also included a cheese, bacon, and onion blend as a topping. The scalloped potatoes modular meal component included about 4 servings (about 140 g each). The weight ratio of the potatoes to the scalloped potato sauce was about 1:1.

The potatoes were 3/16-inch sliced potatoes that were blanched and then dehydrofrozen.

The general formulation of the scalloped potatoes modular meal component is shown in Table 17, with the wt % of each ingredient that was used (based on the total weight of the combination of the meal component, the sauce component, and the topping).

TABLE 17

| | Scalloped potatoes modular meal component | |
|---|---|---|
| Ingredient | (wt %) | |
| Dehydrofrozen Potatoes | 44.00 | |
| Scalloped Potatoes Sauce | 44.00 | |
| | Water | 17.38 |
| | Half & Half | 10.65 |
| | Butter | 2.20 |
| | Cheese | 10.12 |
| | Whey Protein | 0.88 |
| | Salt | 0.35 |
| | Sodium Phosphate | 0.22 |
| | Corn Starch | 0.70 |
| | Spices and Flavors | 1.50 |

| | |
|---|---|
| Cheese, Bacon, and Onion | 12.00 |
| Blend (Topping) | |
| Total | 100.00 |

The scalloped potatoes sauce ingredients were combined and blended to form a generally homogenous sauce. The scalloped potato sauce had a viscosity of 10 cm when measured at 150° F. with a Bostwick Consistometer (CSC Scientific 2492500) using a 100 g sample and a 30-second time interval, a viscosity of 8.5 cm when measured at 70° F. with the Bostwick Consistometer using a 100 g sample and a 30-second time interval, a total solids content of 22% when measured at 150° F., and a total solids content of 25% when measured at 70° F. The scalloped potatoes sauce had a moisture content of 73%.

The scalloped potatoes modular meal component was prepared by adding about half of the scalloped potato sauce to the tray, then adding the potatoes atop the scalloped potato sauce, then adding the remaining about half of the scalloped potato sauce atop the potatoes, then adding the cheese, bacon, and onion blend atop the remaining about half of the scalloped potato sauce, and then hermetically sealing the flexible film to the upper flange of the tray.

The scalloped potatoes modular meal component reached at least 165° F. when three modular meal components were heated from frozen in a conventional oven for 30 minutes at 425° F.

The eighth additional example of the modular meal component was a mac and cheese modular meal component and included pasta as the meal component and cheese sauce as the sauce component. The mac and cheese modular meal component also included a cheese blend as a topping. The mac and cheese modular meal component included about 3.5 servings (about 195 g each). The weight ratio of the pasta to the cheese sauce was about 1.57:1.

The pasta was blanched pasta shells.

The general formulation of the mac and cheese modular meal component is shown in Table 18, with the wt % of each ingredient that was used (based on the total weight of the combination of the meal component, the sauce component, and the topping).

TABLE 18

| | Mac and cheese modular meal component | |
|---|---|---|
| Ingredient | (wt %) | |
| Blanched pasta | 52.5 | |
| Cheese Sauce | 33.5 | |
| | Water | 13.33 |
| | Soybean Oil | 1.34 |
| | Cheese | 9.45 |
| | Whey Protein | 0.34 |
| | Half & Half | 6.70 |
| | Butter | 1.68 |
| | Corn Starch | 0.42 |
| | Salt | 0.07 |
| | Flavors | 0.15 |

| | |
|---|---|
| Cheese Blend (Topping) | 14.00 |
| Total | 100.00 |

The cheese sauce ingredients were combined and blended to form a generally homogenous sauce. The cheese sauce had a viscosity of 12 cm when measured at 150° F. with a Bostwick Consistometer (CSC Scientific 2492500) using a 100 g sample and a 30-second time interval, a viscosity of 6.5 cm when measured at 70° F. with the Bostwick Consistometer using a 100 g sample and a 30-second time interval, a total solids content of 33% when measured at 150° F., and a total solids content of 35% when measured at 70° F. The cheese sauce had a moisture content of 65.3%.

The mac and cheese modular meal component was prepared by mixing the pasta and cheese sauce, adding the pasta and cheese sauce mixture to the tray, then adding the cheese blend to the tray atop pasta and cheese sauce mixture, and then hermetically sealing the flexible film to the upper flange of the tray.

The mac and cheese modular meal component reached at least 165° F. when three of modular meal components were heated from frozen in a conventional oven for 30 minutes at 425° F.

The ninth additional example of the modular meal component was a bread sticks modular meal component and included bread sticks as the meal component and soybean oil as the sauce component. The bread sticks modular meal component also included a garlic cheese blend as a topping. The bread sticks modular meal component included about 5 servings (about 90 g each). The weight ratio of the bread sticks to the soybean oil was about 20.21:1.

The bread sticks were a loaf of five bread sticks that were parbaked (baked to about 80% of a full bake).

The general formulation of the bread sticks modular meal component is shown in Table 19, with the wt % of each ingredient that was used (based on the total weight of the combination of the meal component, the sauce component, and the topping).

TABLE 19

| | Bread sticks modular meal |
|---|---|
| | component |
| Ingredient | (wt %) |
| Bread Sticks | 66.70 |
| Soybean Oil | 3.30 |
| Garlic Cheese Blend | 30.00 |
| (Topping) | |

The bread sticks modular meal component was prepared by adding the soybean oil to coat the tray, then adding the bread sticks atop the soybean oil, then adding the garlic cheese blend atop the bread sticks, and then hermetically sealing the flexible film to the upper flange of the tray.

The bread sticks modular meal component reached at least 165° F. when three modular meal components were heated from frozen in a conventional oven for 30 minutes at 425° F.

The total sugar (per serving), total protein (per serving), total fat (per serving), total saturated fat (per serving), and total sodium (per serving) included in each of the nine modular meal components were obtained and are shown in Table 20.

TABLE 20

| Modular meal | Total | Total | Total | Total | Total |
|---|---|---|---|---|---|
| component | sugar (per | protein (per | fat (per | saturated fat | sodium (per |
| (“MMC”) | serving) | serving) | serving) | (per serving) | serving) |
| Barbeque pork | 12.70 g | 22.20 g | 6.83 g | 0.02 g | 544.24 mg |
| MMC | | | | | |
| Italian meatballs | 2.53 g | 16.70 g | 16.00 g | 9.53 g | 802.19 mg |
| with marinara | | | | | |
| MMC | | | | | |
| Honey barbeque | 7.53 g | 23.78 g | 7.37 g | 0.02 g | 563.82 mg |
| chicken MMC | | | | | |
| Italian | 0.76 g | 3.75 g | 6.48 g | 1.50 g | 229.63 mg |
| cauliflower MMC | | | | | |
| Savory green | 0.50 g | 0.65 g | 0.42 g | 0.25 g | 51.36 mg |
| beans MMC | | | | | |
| Cheddar broccoli | 2 g | 6 g | 7 g | 4 g | 340 mg |
| MMC | | | | | |
| Scalloped | 1.55 g | 9.94 g | 8.08 g | 7.36 g | 682.58 mg |
| potatoes MMC | | | | | |
| Mac and cheese | 1.56 g | 12.50 g | 13.11 g | 8.91 g | 417.08 mg |
| MMC | | | | | |
| Bread sticks | 1.00 g | 9.19 g | 2.81 g | 0.01 g | 631.35 mg |
| MMC | | | | | |

The total moisture content of each of the nine modular meal components also obtained and is shown in Table 21.

TABLE 21

| | Total |
|---|---|
| Modular meal component | Moisture |
| (“MMC”) | content |
| Barbeque pork MMC | 67.00% |
| Italian meatballs with | 64.00% |
| marinara MMC | |
| Honey barbeque chicken | 69.00% |
| MMC | |
| Italian cauliflower MMC | 81.00% |
| Savory green beans MMC | 87.50% |
| Cheddar broccoli MMC | 78.00% |
| Scalloped potatoes MMC | 63.40% |
| Mac and cheese MMC | 62.00% |
| Bread sticks MMC | 49.00% |

### Example 5

Additional modular meal components were prepared to test the effect of different sauce formulations and different sauce placement on heating efficiency. Each of the modular meal components included an aluminum tray with a width at the top of about 9.75 inches, a width at the bottom of about 8.5 inches, a length at the top of about 7.75 inches, a length at the bottom of about 6.5 inches, a depth of about 1.75 inches, and a black and gold epoxy lacquer coating (AlucoatO CS, from Coppice Alupack Ltd.). Each of the modular meal components also included KPEEL™ 7G+AF (a heat-sealable polyester film with an anti-fog treatment available from KM Packaging Services Ltd.) as the flexible film.

Different formulations of the sauce component were used in the modular meal components. The meal component and the sauce component included in each of the modular meal components are shown in Table 22. Characteristics of the sauce components are shown in Table 23.

Different sauce placements were also used in the modular meal components. In some of the modular meal components, the sauce component was place in the bottom of the tray and the meal component was placed atop the sauce component (i.e., “bottom” sauce component placement). In some examples, the meal component was placed in the bottom of the tray and the sauce component was placed atop the meal component (i.e., “top” sauce component placement). In some examples, the sauce component was mixed with the meal component and the mixture of the sauce component and the meal component was placed in the tray (i.e., “mixed” sauce component placement). In some examples, about half of the sauce component was place in the bottom of the tray, the meal component was placed atop the about half of the sauce component, and the remaining amount of the sauce component was placed atop the meal component (i.e., “top and bottom split” sauce component placement). The sauce component placement of each of the modular meal components is also indicated in Table 22.

TABLE 22

| | | | Sauce |
|---|---|---|---|
| Modular meal component | Meal | Sauce | component |
| (“MMC”) | component | component | placement |
| Barbeque pork | Pork | Barbeque | Bottom |
| (MMC 10) | | sauce 1 | |
| Barbeque pork | Pork | Barbeque | Top |
| (MMC 11) | | sauce 1 | |
| Barbeque pork | Pork | Barbeque | Bottom |
| (MMC 12) | | sauce 2 | |
| Barbeque pork | Pork | Barbeque | Top |
| (MMC 13) | | sauce 2 | |
| Barbeque pork | Pork | Barbeque | Bottom |
| (MMC 14) | | sauce 3 | |
| Barbeque pork | Pork | Barbeque | Top |
| (MMC 15) | | sauce 3 | |
| Italian meatballs with marinara | Beef | Marinara | Bottom |
| (MMC 16) | | sauce 1 | |
| Italian meatballs with marinara | Beef | Marinara | Top |
| (MMC 17) | | sauce 1 | |
| Italian meatballs with marinara | Beef | Marinara | Bottom |
| (MMC 18) | | sauce 2 | |
| Italian meatballs with marinara | Beef | Marinara | Top |
| (MMC 19) | | sauce 2 | |
| Honey chicken | Chicken | Honey sauce 1 | Bottom |
| (MMC 20) | | | |
| Honey chicken | Chicken | Honey sauce 1 | Top |
| (MMC 21) | | | |
| Honey chicken | Chicken | Honey sauce 2 | Bottom |
| (MMC 22) | | | |
| Honey chicken | Chicken | Honey sauce 2 | Top |
| (MMC 23) | | | |
| Cheddar broccoli | Broccoli | Cheese sauce | Bottom |
| (MMC 24) | | | |
| Cheddar broccoli | Broccoli | Cheese sauce | Top |
| (MMC 25) | | | |
| Mac and cheese | Pasta | Mac and | Bottom |
| (MMC 26) | | cheese sauce 1 | |
| Mac and cheese | Pasta | Mac and | Top |
| (MMC 27) | | cheese sauce 1 | |
| Mac and cheese | Pasta | Mac and | Mixed |
| (MMC 28) | | cheese sauce 1 | |
| Mac and cheese | Pasta | Mac and | Bottom |
| (MMC 29) | | cheese sauce 2 | |
| Mac and cheese | Pasta | Mac and | Top |
| (MMC 30) | | cheese sauce 2 | |
| Mac and cheese | Pasta | Mac and | Mixed |
| (MMC 31) | | cheese sauce 2 | |
| Scalloped potatoes | Potatoes | Cream sauce | Top |
| (MMC 32) | | | |
| Scalloped potatoes | Potatoes | Cream sauce | Top and |
| (MMC 33) | | | bottom |
| | | | split |
| Scalloped potatoes | Potatoes | Cream sauce | Bottom |
| (MMC 34) | | | |

Barbeque sauce 1 was the barbeque sauce used in Example 5 (formulation shown in Table 11). Barbeque sauce 2 was Kraft® Original barbeque sauce. Barbeque sauce 3 was Ray's No Sugar Added® barbeque sauce. Marinara sauce 1 was Prego Farmer's Market® marinara sauce. Marinara sauce 2 was the marinara sauce used in Example 5 (formulation shown in Table 12). Honey sauce 1 was the honey barbeque sauce used in Example 5 (formulation shown in Table 13). Honey sauce 2 was Kraft® Hint of Honey barbeque sauce. Cheese sauce was the cheese sauce used in Example 5 (formulation shown in Table 16). Mac and cheese sauce 1 was the cheese sauce used in Example 5 (formulation shown in Table 18). Mac and cheese sauce 2 was Ragu® Double Cheddar cheese sauce. Cream sauce was the scalloped potatoes sauce used in Example 5 (formulation shown in Table 17).

The viscosity of each of the sauce components used in the modular meal components was measured at 70° F. with a Bostwick Consistometer (CSC Scientific 2492500) using a 100 g sample and a 30 seconds time interval. The total solids content of each of the sauce components used in the modular meal components was measured at 70° F. using a digital refractometer from Bellingham & Stanley. The total fat (per 100 g), total sugar (per 100 g), and total protein (per 100 g) of each of the sauce components used in the modular meal components were also obtained. The viscosity, total solids, total fat, total sugar, and total protein of each of the sauce components used in the modular meal components are shown in Table 23.

TABLE 23

| | | | | | Total |
|---|---|---|---|---|---|
| | Viscosity | Total solids | Total fat | Total sugar | protein |
| Sauce component | (at 70° F.) | (at 70° F.) | (per 100 g) | (per 100 g) | (per 100 g) |
| Barbeque sauce 1 | 4.5 cm | 42% | 0 g | 21 g | 0 g |
| Barbeque sauce 2 | 7 cm | 40% | 0 g | 12 g | 0 g |
| Barbeque sauce 3 | 12 cm | 19.37% | 0 g | 1 g | 1 g |
| Marinara sauce 1 | 16 cm | 8.56% | 5 g | 4 g | 2 g |
| Marinara sauce 2 | 9 cm | 15% | 6 g | 5 g | 2 g |
| Honey sauce 1 | 4 cm | 36% | 0 g | 24 g | 1 g |
| Honey sauce 2 | 7 cm | 31% | 0 g | 8 g | 0 g |
| Cheese sauce | 7.5 cm | 18% | 11 g | 1.5 g | 8 g |
| Mac and cheese sauce 1 | 6.5 cm | 35% | 18 g | 6 g | 6.5 g |
| Mac and cheese sauce 2 | 9 cm | 28% | 9 g | 1 g | 2 g |
| Cream sauce | 8.5 cm | 25% | 13 g | 2 g | 5 g |

Two or three samples of each of the modular meal components were frozen. The initial temperature of each sample from the freezer was measured. Then, each sample was heated in a conventional oven for 30 minutes at 425° F. with two other frozen modular meal components. During the 30-minute heating, there was no rotating, stirring, or other intervention of any of the samples. After the 30-minute heating, the temperatures of the meal component were measured as quickly as possible after the trays were removed from the oven. In each sample, the temperature in each of ten equally-sized zones was measured and recorded. A grid defining the ten equally-sized zones was created by dividing the width of a tray into five equal sections and the length of a tray into two equal sections. The temperature of each zone was measured by inserting the thermocouple into the thickest portion of the meal component avoiding air pockets. The testing order for each tray was randomized. Each sample was given a pass/fail score based on the temperatures of the meal component. If the sample achieved an internal temperature of at least 165° F. in each zone, the sample was given a passing score. If the sample did not achieve an internal temperature of at least 165° F. in each zone, the sample was given a failing score.

The net weight (i.e., the weight of the meal component and the sauce component combined without the weight of the tray or flexible film), oven position (i.e., whether the modular meal component was placed on a top or bottom rack in the oven), and initial temperature of each sample are shown in Table 24 through Table 33. The temperatures of the meal component in each zone and a temperature pass/fail score for each sample are also indicated in Table 24 through Table 33.

The net weight, oven position, sauce component placement, initial temperature, temperature in each zone after heating, and the temperature pass/fail score for two barbeque pork modular meal component samples MMC 10 and MMC 11 are shown in Table 24.

TABLE 24

| | MMC 10 | | | MMC 11 | | |
|---|---|---|---|---|---|---|
| | S1 | S2 | S3 | S1 | S2 | S3 |
| Net Weight (in g) | 636.8 | 638.9 | 642.6 | 633.2 | 634.2 | 632.8 |
| Oven position | Top | Top | Bottom | Top | Top | Top |
| Sauce component | Bottom | Bottom | Bottom | Top | Top | Top |
| placement | | | | | | |
| Initial temp. | 10.0 | 5.5 | 6.4 | 5.2 | 8.1 | 6.4 |
| (in ° F.) | | | | | | |
| Temp. in zone 1 | 204.1 | 209.7 | 210.7 | 208.0 | 209.8 | 209.1 |
| (in ° F.) | | | | | | |
| Temp. in zone 2 | 200.5 | 192.6 | 210.7 | 203.5 | 207.9 | 192.7 |
| (in ° F.) | | | | | | |
| Temp. in zone 3 | 209.3 | 194.7 | 209.7 | 210.0 | 208.9 | 208.9 |
| (in ° F.) | | | | | | |
| Temp. in zone 4 | 196.7 | 196.3 | 208.8 | 188.6 | 172.2 | 186.6 |
| (in ° F.) | | | | | | |
| Temp. in zone 5 | 186.9 | 206.1 | 208.0 | 191.8 | 169.7 | 206.4 |
| (in ° F.) | | | | | | |
| Temp. in zone 6 | 200.5 | 209.7 | 204.1 | 207.7 | 190.2 | 208.9 |
| (in ° F.) | | | | | | |
| Temp. in zone 7 | 198.1 | 194.7 | 208.8 | 201.9 | 208.0 | 190.4 |
| (in ° F.) | | | | | | |
| Temp. in zone 8 | 204.8 | 201.7 | 206.8 | 208.2 | 179.4 | 201.6 |
| (in ° F.) | | | | | | |
| Temp. in zone 9 | 206.4 | 203.2 | 205.3 | 208.6 | 201.7 | 209.1 |
| (in ° F.) | | | | | | |
| Temp. in zone 10 | 204.0 | 204.8 | 205.7 | 204.8 | 201.2 | 203.7 |
| (in ° F.) | | | | | | |
| Lowest temp. | 186.9 | 192.6 | 204.1 | 188.6 | 169.7 | 186.6 |
| (in ° F.) | | | | | | |
| Average temp. | 201.13 | 201.35 | 207.86 | 203.31 | 194.9 | 201.74 |
| (in ° F.) | | | | | | |
| Temp. Pass/Fail | Pass | Pass | Pass | Pass | Pass | Pass |

As shown in Table 24, each barbeque pork modular meal component sample that included barbeque sauce 1 (MMC 10: S1, S2, and S3; and MMC 11: S1, S2, and S3) was able to reach a temperature of at least 165° F. when heated from frozen for 30 minutes at 425° F. Each barbeque pork modular meal component sample that included barbeque sauce 1 was able to reach a temperature of at least 165° F. regardless of whether the sauce component had a bottom or top placement.

The net weight, oven position, sauce component placement, initial temperature, temperature in each zone after heating, and the temperature pass/fail score for barbeque pork modular meal components MMC 12 and MMC 13 are shown in Table 25.

TABLE 25

| | MMC 12 | | | MMC 13 | | |
|---|---|---|---|---|---|---|
| | S1 | S2 | S3 | S1 | S2 | S3 |
| Net Weight (in g) | 633.8 | 632.6 | 632.4 | 631.2 | 632.6 | 633.1 |
| Oven position | Top | Top | Top | Top | Top | Top |
| Sauce component | Bottom | Bottom | Bottom | Top | Top | Top |
| placement | | | | | | |
| Initial temp. | 9.7 | 9.1 | 6.8 | 8.4 | 8.2 | 9.1 |
| (in ° F.) | | | | | | |
| Temp. in zone 1 | 205.7 | 211.3 | 210.4 | 200.5 | 209.1 | 209.5 |
| (in ° F.) | | | | | | |
| Temp. in zone 2 | 211.6 | 208.9 | 211.0 | 210.0 | 207.1 | 210.4 |
| (in ° F.) | | | | | | |
| Temp. in zone 3 | 208.2 | 209.8 | 211.4 | 202.8 | 166.0 | 210.7 |
| (in ° F.) | | | | | | |
| Temp. in zone 4 | 197.4 | 209.1 | 197.8 | 185.0 | 170.0 | 206.0 |
| (in ° F.) | | | | | | |
| Temp. in zone 5 | 206.4 | 209.7 | 210.8 | 205.7 | 208.4 | 205.3 |
| (in ° F.) | | | | | | |
| Temp. in zone 6 | 206.4 | 187.0 | 209.1 | 205.5 | 211.8 | 201.0 |
| (in ° F.) | | | | | | |
| Temp. in zone 7 | 199.4 | 210.0 | 209.1 | 201.7 | 184.1 | 185.0 |
| (in ° F.) | | | | | | |
| Temp. in zone 8 | 196.3 | 209.5 | 209.8 | 205.5 | 160.0 | 193.8 |
| (in ° F.) | | | | | | |
| Temp. in zone 9 | 198.6 | 210.4 | 164.0 | 188.4 | 163.0 | 207.0 |
| (in ° F.) | | | | | | |
| Temp. in zone 10 | 205.0 | 205.3 | 165.0 | 205.9 | 209.8 | 205.9 |
| (in ° F.) | | | | | | |
| Lowest temp. | 196.3 | 187.0 | 164.0 | 185.0 | 160.0 | 185.0 |
| (in ° F.) | | | | | | |
| Average temp. | 203.5 | 207.1 | 199.84 | 201.1 | 188.93 | 203.46 |
| (in ° F.) | | | | | | |
| Temp. Pass/Fail | Pass | Pass | Fail | Pass | Fail | Pass |

As shown in Table 25, at least one barbeque pork modular meal component sample that included barbeque sauce 2 (MMC 12: S3 and MMC 13: S2) was unable to reach a temperature of at least 165° F. when heated from frozen for 30 minutes at 425° F. At least one barbeque pork modular meal component sample that included barbeque sauce 2 was unable to reach a temperature of at least 165° F. regardless of whether the sauce component had a bottom or top placement.

The net weight, oven position, sauce component placement, initial temperature, temperature in each zone after heating, and the temperature pass/fail score for barbeque pork modular meal component samples MMC 14 and MMC 15 are shown in Table 26.

TABLE 26

| | MMC 14 | | | MMC 15 | | |
|---|---|---|---|---|---|---|
| | S1 | S2 | S3 | S1 | S2 | S3 |
| Net Weight (in g) | 632.0 | 632.6 | 632.7 | 631.7 | 632.9 | 633.2 |
| Oven position | Top | Top | Top | Top | Top | Top |
| Sauce component | Bottom | Bottom | Bottom | Top | Top | Top |
| placement | | | | | | |
| Initial temp. | 5.1 | 7.2 | 7.3 | 5.5 | 7.5 | 6.5 |
| (in ° F.) | | | | | | |
| Temp. in zone 1 | 209.1 | 208.5 | 207.1 | 207.4 | 207.0 | 210.7 |
| (in ° F.) | | | | | | |
| Temp. in zone 2 | 208.2 | 208.2 | 190.4 | 208.9 | 197.2 | 207.4 |
| (in ° F.) | | | | | | |
| Temp. in zone 3 | 203.5 | 205.9 | 202.4 | 178.0 | 205.4 | 206.8 |
| (in ° F.) | | | | | | |
| Temp. in zone 4 | 205.0 | 201.9 | 203.0 | 130.1 | 189.1 | 200.8 |
| (in ° F.) | | | | | | |
| Temp. in zone 5 | 207.5 | 188.8 | 205.9 | 174.1 | 193.8 | 200.1 |
| (in ° F.) | | | | | | |
| Temp. in zone 6 | 201.9 | 194.9 | 196.5 | 196.6 | 199.4 | 190.4 |
| (in ° F.) | | | | | | |
| Temp. in zone 7 | 204.1 | 200.5 | 186.5 | 184.1 | 165.0 | 195.6 |
| (in ° F.) | | | | | | |
| Temp. in zone 8 | 196.2 | 203.0 | 193.8 | 192.4 | 148.0 | 185.4 |
| (in ° F.) | | | | | | |
| Temp. in zone 9 | 191.3 | 208.2 | 197.6 | 194.9 | 164.0 | 198.1 |
| (in ° F.) | | | | | | |
| Temp. in zone 10 | 206.2 | 204.6 | 202.8 | 179.4 | 169.7 | 196.0 |
| (in ° F.) | | | | | | |
| Lowest temp. | 191.3 | 188.8 | 186.5 | 130.1 | 148.0 | 185.4 |
| (in ° F.) | | | | | | |
| Average temp. | 203.3 | 202.45 | 198.6 | 184.59 | 183.86 | 199.13 |
| (in ° F.) | | | | | | |
| Temp. Pass/Fail | Pass | Pass | Pass | Fail | Fail | Pass |

As shown in Table 26, each barbeque pork modular meal component sample that included barbeque sauce 3 and had a bottom sauce component placement (MMC 14: S1, S2, and S3) was able to reach a temperature of at least 165° F. when heated from frozen for 30 minutes at 425° F. As also shown in Table 26, at least one barbeque pork modular meal component sample that included barbeque sauce 3 and had a top sauce component placement (MMC 15: S1 and S2) was unable to reach a temperature of at least 165° F. when heated from frozen for 30 minutes at 425° F. This indicates that having a bottom sauce component placement can improve the heating efficiency of a modular meal component.

As shown in Tables 24 through 26, each barbeque pork modular meal component sample that included barbeque sauce 1 was able to reach a temperature of at least 165° F. regardless of whether the sauce component had a bottom or top placement, and at least one barbeque pork modular meal component sample that included barbeque sauce 2 and at least one barbeque pork modular meal component sample that included barbeque sauce 3 was unable to reach a temperature of at least 165° F.

As shown in Table 23, barbeque sauce 1 was more viscous than barbeque sauce 2 and barbeque sauce 3. It is believed that a more viscous sauce component conducts heat to the meal component better than a less viscous sauce component. As also shown in Table 23, barbeque sauce 1 had higher total solids and higher sugar content than barbeque sauce 2 and barbeque sauce 3, which contributed to the higher viscosity of barbeque sauce 1. The results in Tables 24 through 26 indicate that the viscosity and total solids content of a sauce component can be selected to improve the heating efficiency of a modular meal component.

The net weight, oven position, sauce component placement, initial temperature, temperature in each zone after heating, and the temperature pass/fail score for Italian meatballs with marinara modular meal component samples MMC 16 through MMC 19 are shown in Table 27.

TABLE 27

| | MMC 16 | | | MMC 17 | | | MMC 18 | | MMC 19 | |
|---|---|---|---|---|---|---|---|---|---|---|
| | S1 | S2 | S3 | S1 | S2 | S3 | S1 | S2 | S1 | S2 |
| Net Weight (in g) | 642.0 | 637.5 | 641.2 | 636.0 | 638.1 | 640.7 | 642.7 | 641.3 | 637.2 | 639.8 |
| Oven position | Top | Top | Top | Top | Top | Top | Top | Top | Top | Top |
| Sauce component | Bottom | Bottom | Bottom | Top | Top | Top | Bottom | Bottom | Top | Top |
| placement | | | | | | | | | | |
| Initial temp. | 8.1 | 9.1 | 9.5 | 9.0 | 9.1 | 5.0 | 6.4 | 7.3 | 6.3 | 6.4 |
| (in ° F.) | | | | | | | | | | |
| Temp. in zone 1 | 205.9 | 205.1 | 204.0 | 209.5 | 205.9 | 208.2 | 207.8 | 202.7 | 205.0 | 208.0 |
| (in ° F.) | | | | | | | | | | |
| Temp. in zone 2 | 208.7 | 207.7 | 208.0 | 209.1 | 206.4 | 200.5 | 202.5 | 208.0 | 205.9 | 207.0 |
| (in ° F.) | | | | | | | | | | |
| Temp. in zone 3 | 209.5 | 209.1 | 209.1 | 209.7 | 209.5 | 210.0 | 208.0 | 209.3 | 180.7 | 205.7 |
| (in ° F.) | | | | | | | | | | |
| Temp. in zone 4 | 184.1 | 184.1 | 184.5 | 168.8 | 162.0 | 177.8 | 168.7 | 167.5 | 140.0 | 140.4 |
| (in ° F.) | | | | | | | | | | |
| Temp. in zone 5 | 194.2 | 194.2 | 204.4 | 206.4 | 208.2 | 208.1 | 198.0 | 206.4 | 203.0 | 202.9 |
| (in ° F.) | | | | | | | | | | |
| Temp. in zone 6 | 204.9 | 204.9 | 207.3 | 208.4 | 201.9 | 209.5 | 201.4 | 202.1 | 203.0 | 201.6 |
| (in ° F.) | | | | | | | | | | |
| Temp. in zone 7 | 183.2 | 183.2 | 188.5 | 189.3 | 174.7 | 164.0 | 165.2 | 196.7 | 174.6 | 165.9 |
| (in ° F.) | | | | | | | | | | |
| Temp. in zone 8 | 194.5 | 194.5 | 204.6 | 203.7 | 206.6 | 198.0 | 202.8 | 206.1 | 179.2 | 205.3 |
| (in ° F.) | | | | | | | | | | |
| Temp. in zone 9 | 205.9 | 205.9 | 206.2 | 207.3 | 198.9 | 207.0 | 208.5 | 207.7 | 194.0 | 195.4 |
| (in ° F.) | | | | | | | | | | |
| Temp. in zone 10 | 206.6 | 206.6 | 206.6 | 203.5 | 200.5 | 190.0 | 200.7 | 207.5 | 185.9 | 181.4 |
| (in ° F.) | | | | | | | | | | |
| Lowest temp. | 183.2 | 183.2 | 184.5 | 168.8 | 162.0 | 164.0 | 165.2 | 167.5 | 140.0 | 140.4 |
| (in ° F.) | | | | | | | | | | |
| Average temp. | 199.75 | 199.53 | 202.32 | 201.57 | 197.46 | 197.31 | 196.36 | 201.4 | 187.13 | 191.36 |
| (in ° F.) | | | | | | | | | | |
| Temp. Pass/Fail | Pass | Pass | Pass | Pass | Fail | Fail | Pass | Pass | Fail | Fail |

As shown in Table 27, each Italian meatballs with marinara modular meal component sample that had a bottom sauce component placement (MMC 16: S1, S2, and S3 and MMC 18: S1 and S2) was able to reach a temperature of at least 165° F. when heated from frozen for 30 minutes at 425° F. As also shown in Table 27, at least one Italian meatballs with marinara modular meal component sample that had a top sauce component placement (MMC 17: S2 and S3 and MMC 19: S1 and S2). It was found that, when the sauce component had a top placement in the Italian meatballs with marinara modular meal component samples, the frozen sauce component formed ice around the meal component. As shown in Table 23, both marinara sauce 1 and marinara sauce 2 were less viscous and had low amounts of total solids. It is believed that low viscosity and low total solids of marinara sauce 1 and marinara sauce 2 caused, at least in part, most of the Italian meatballs with marinara modular meal component samples that had a top sauce component placement to be unable to reach a temperature of at least 165° F. These results further indicate that having a bottom sauce component placement can improve the heating efficiency of a modular meal component. These results further indicate a bottom sauce component placement may enable a modular meal component to reach a temperature of at least 165° F. when the sauce component has a low viscosity or total solids.

The net weight, oven position, sauce component placement, initial temperature, temperature in each zone after heating, and the temperature pass/fail score for honey chicken modular meal component samples MMC 20 and MMC 21 are shown in Table 28.

TABLE 28

| | MMC 20 | | MMC 21 | | |
|---|---|---|---|---|---|
| | S1 | S2 | S1 | S2 | S3 |
| Net Weight (in g) | 632.3 | 632.6 | 633.1 | 634.6 | 634.4 |
| Oven position | Top | Top | Top | Top | Top |
| Sauce component | Bottom | Bottom | Top | Top | Top |
| placement | | | | | |
| Initial temp. | 9.9 | 10.0 | 8.6 | 4-10 | 4-10 |
| (in ° F.) | | | | | |
| Temp. in zone 1 | 210.6 | 207.9 | 210.0 | 194.9 | 201.0 |
| (in ° F.) | | | | | |
| Temp. in zone 2 | 209.3 | 209.8 | 206.1 | 197.0 | 199.9 |
| (in ° F.) | | | | | |
| Temp. in zone 3 | 170.9 | 208.4 | 205.2 | 195.0 | 203.0 |
| (in ° F.) | | | | | |
| Temp. in zone 4 | 197.6 | 198.7 | 200.3 | 199.0 | 200.0 |
| (in ° F.) | | | | | |
| Temp. in zone 5 | 200.8 | 202.6 | 207.6 | 201.0 | 167.6 |
| (in ° F.) | | | | | |
| Temp. in zone 6 | 207.9 | 208.9 | 208.6 | 193.0 | 176.0 |
| (in ° F.) | | | | | |
| Temp. in zone 7 | 199.2 | 189.6 | 185.0 | 198.0 | 198.0 |
| (in ° F.) | | | | | |
| Temp. in zone 8 | 201.0 | 206.2 | 207.7 | 194.0 | 203.0 |
| (in ° F.) | | | | | |
| Temp. in zone 9 | 205.0 | 181.9 | 207.7 | 201.0 | 203.0 |
| (in ° F.) | | | | | |
| Temp. in zone 10 | 184.1 | 205.5 | 205.7 | 197.0 | 186.0 |
| (in ° F.) | | | | | |
| Lowest temp. | 170.9 | 181.9 | 185 | 193.0 | 167.6 |
| (in ° F.) | | | | | |
| Average temp. | 198.64 | 201.95 | 204.39 | 196.99 | 193.75 |
| (in ° F.) | | | | | |
| Temp. Pass/Fail | Pass | Pass | Pass | Pass | Pass |

As shown in Table 28, each honey chicken modular meal component sample that included honey sauce 1 (MMC 20: S1 and S2 and MMC 21: S1, S2, and S3) was able to reach a temperature of at least 165° F. when heated from frozen for 30 minutes at 425° F. Each honey chicken modular meal component sample that included honey sauce 1 was able to reach a temperature of at least 165° F. regardless of whether the sauce component had a bottom or top placement.

The net weight, oven position, sauce component placement, initial temperature, temperature in each zone after heating, and the temperature pass/fail score for honey chicken modular meal component samples MMC 22 and MMC 23 are shown in Table 29.

TABLE 29

| | MMC 22 | | | MMC 23 | | |
|---|---|---|---|---|---|---|
| | S1 | S2 | S3 | S1 | S2 | S3 |
| Net Weight (in g) | 629.2 | 632.4 | 628 | 635.2 | 633.9 | 636.9 |
| Oven position | Top | Top | Top | Top | Top | Top |
| Sauce component | Bottom | Bottom | Bottom | Top | Top | Top |
| placement | | | | | | |
| Initial temp. | 4-10 | 4-10 | 4-10 | 4-10 | 4-10 | 4-10 |
| (in ° F.) | | | | | | |
| Temp. in zone 1 | 210.0 | 206.2 | 202.6 | 195.6 | 192.4 | 194.9 |
| (in ° F.) | | | | | | |
| Temp. in zone 2 | 207.0 | 205.9 | 196.7 | 171.0 | 181.1 | 179.1 |
| (in ° F.) | | | | | | |
| Temp. in zone 3 | 209.5 | 197.1 | 192.4 | 203.0 | 182.3 | 120.0 |
| (in ° F.) | | | | | | |
| Temp. in zone 4 | 208.4 | 198.0 | 201.0 | 180.0 | 191.5 | 187.7 |
| (in ° F.) | | | | | | |
| Temp. in zone 5 | 203.0 | 198.8 | 197.8 | 141.0 | 150.4 | 138.4 |
| (in ° F.) | | | | | | |
| Temp. in zone 6 | 206.2 | 204.6 | 194.7 | 172.9 | 189.7 | 170.1 |
| (in ° F.) | | | | | | |
| Temp. in zone 7 | 209.3 | 198.7 | 197.4 | 198.3 | 194.8 | 186.7 |
| (in ° F.) | | | | | | |
| Temp. in zone 8 | 202.3 | 198.3 | 199.9 | 175.1 | 170.0 | 179.2 |
| (in ° F.) | | | | | | |
| Temp. in zone 9 | 204.4 | 198.5 | 185.9 | 192.9 | 187.8 | 181.2 |
| (in ° F.) | | | | | | |
| Temp. in zone 10 | 205.7 | 201.0 | 182.5 | 189.9 | 193.6 | 169.9 |
| (in ° F.) | | | | | | |
| Lowest temp. | 202.3 | 197.1 | 182.5 | 141.0 | 150.4 | 120.0 |
| (in ° F.) | | | | | | |
| Average temp. | 206.58 | 200.71 | 195.09 | 181.97 | 183.36 | 170.72 |
| (in ° F.) | | | | | | |
| Temp. Pass/Fail | Pass | Pass | Pass | Fail | Fail | Fail |

As shown in Table 29, each chicken modular meal component sample that included honey sauce 2 and had a bottom sauce component placement (MMC 22: S1, S2, and S3) was able to reach a temperature of at least 165° F. when heated from frozen for 30 minutes at 425° F. As also shown in Table 29, at least one honey chicken modular meal component sample that included honey sauce 2 and had a top sauce component placement (MMC 23: S1, S2, and S3) was unable to reach a temperature of at least 165° F. when heated from frozen for 30 minutes at 425° F. This further indicates that having a bottom sauce component placement can improve the heating efficiency of a modular meal component.

As shown in Tables 28 and 29, each honey chicken modular meal component sample that included honey sauce 1 was able to reach a temperature of at least 165° F. regardless of whether the sauce component had a bottom or top placement, and at least one honey chicken modular meal component sample that included honey sauce 2 was unable to reach a temperature of at least 165° F. As shown in Table 23, honey sauce 1 was more viscous than honey sauce 2. As also shown in Table 23, honey sauce 1 had higher total solids and higher sugar content than honey sauce 2. It is believed that the higher total solids and higher sugar content of honey sauce 1 caused honey sauce 1 to be more viscous and that the greater viscosity of honey sauce 1 enabled it conduct heat to the meal component better than the less viscous honey sauce 2. These results further indicate that that the viscosity and total solids content of a sauce component can be selected to improve the heating efficiency of a modular meal component.

The net weight, oven position, sauce component placement, initial temperature, temperature in each zone after heating, and the temperature pass/fail score for cheddar broccoli modular meal component samples MMC 24 and MMC 25 are shown in Table 30.

TABLE 30

| | MMC 24 | | | MMC 25 | | |
|---|---|---|---|---|---|---|
| | S1 | S2 | S3 | S1 | S2 | S3 |
| Net Weight (in g) | 548.2 | 548.7 | 548.1 | 547.3 | 547.8 | 549.1 |
| Oven position | Top | Top | Top | Top | Top | Top |
| Sauce component | Bottom | Bottom | Bottom | Top | Top | Top |
| placement | | | | | | |
| Initial temp. | 7.0 | 5.5 | 5.5 | 5.7 | 7.3 | 7.0 |
| (in ° F.) | | | | | | |
| Temp. in zone 1 | 194.4 | 171.0 | 207.0 | 180.3 | 207.3 | 200.9 |
| (in ° F.) | | | | | | |
| Temp. in zone 2 | 196.2 | 178.0 | 207.4 | 207.3 | 209.3 | 206.2 |
| (in ° F.) | | | | | | |
| Temp. in zone 3 | 198.5 | 192.0 | 203.5 | 206.1 | 207.3 | 209.3 |
| (in ° F.) | | | | | | |
| Temp. in zone 4 | 198.7 | 198.0 | 206.2 | 190.8 | 196.0 | 176.7 |
| (in ° F.) | | | | | | |
| Temp. in zone 5 | 175.3 | 196.8 | 207.3 | 197.2 | 187.9 | 192.4 |
| (in ° F.) | | | | | | |
| Temp. in zone 6 | 204.5 | 198.6 | 189.3 | 201.9 | 198.1 | 195.6 |
| (in ° F.) | | | | | | |
| Temp. in zone 7 | 201.6 | 194.0 | 194.5 | 183.6 | 199.0 | 194.0 |
| (in ° F.) | | | | | | |
| Temp. in zone 8 | 202.3 | 190.2 | 190.4 | 205 | 188.8 | 189.9 |
| (in ° F.) | | | | | | |
| Temp. in zone 9 | 199.6 | 208.3 | 206.1 | 203.4 | 194.7 | 199.0 |
| (in ° F.) | | | | | | |
| Temp. in zone 10 | 197.4 | 171.3 | 199.8 | 193.3 | 175.8 | 199.2 |
| (in ° F.) | | | | | | |
| Lowest temp. | 175.3 | 171.0 | 189.3 | 180.3 | 175.8 | 176.7 |
| (in ° F.) | | | | | | |
| Average temp. | 196.85 | 189.82 | 201.15 | 196.89 | 196.42 | 196.32 |
| (in ° F.) | | | | | | |
| Temp. Pass/Fail | Pass | Pass | Pass | Pass | Pass | Pass |

As shown in Table 30, each cheddar broccoli modular meal component sample (MMC 24: S1, S2, and S3 and MMC 25: S1, S2, and S3) was able to reach a temperature of at least 165° F. when heated from frozen for 30 minutes at 425° F. Each cheddar broccoli modular meal component sample was able to reach a temperature of at least 165° F. regardless of whether the sauce component had a bottom or top placement.

The net weight, oven position, sauce component placement, initial temperature, temperature in each zone after heating, and the temperature pass/fail score for mac and cheese modular meal component samples MMC 26 through MMC 28 are shown in Table 31.

Each sample of MMC 26 through MMC 28 was also given a “quality characteristics” score on a pass/fail basis, indicating whether the mac and cheese in the modular meal component had acceptable texture and organoleptic properties. The quality characteristics score (“QCS pass/fail”) for each sample of MMC 26 through MMC 28 is also shown in Table 31.

TABLE 31

| | MMC 26 | | | MMC 27 | | | MCC 28 | | |
|---|---|---|---|---|---|---|---|---|---|
| | S1 | S2 | S3 | S1 | S2 | S3 | S1 | S2 | S3 |
| Net Weight (in g) | 679.0 | 679.2 | 680.5 | 681.4 | 682.8 | 697.3 | 679.5 | 680.3 | 682.1 |
| Oven position | Top | Top | Top | Top | Top | Top | Top | Top | Top |
| Sauce component | Bottom | Bottom | Bottom | Top | Top | Top | Mixed | Mixed | Mixed |
| placement | | | | | | | | | |
| Initial temp. | 9.1 | 5.7 | 10.0 | 8.8 | 9.1 | 6.3 | 7.4 | 8.4 | 5.4 |
| (in ° F.) | | | | | | | | | |
| Temp. in zone 1 | 205.3 | 209.8 | 203.4 | 199.7 | 203.5 | 197.6 | 206.0 | 206.1 | 206.1 |
| (in ° F.) | | | | | | | | | |
| Temp. in zone 2 | 207.3 | 205.9 | 196.3 | 204.1 | 194.2 | 208.0 | 210.0 | 207.0 | 208.4 |
| (in ° F.) | | | | | | | | | |
| Temp. in zone 3 | 208.2 | 207.0 | 183.8 | 189.5 | 200.1 | 204.3 | 201.7 | 202.5 | 205.7 |
| (in ° F.) | | | | | | | | | |
| Temp. in zone 4 | 200.1 | 190.9 | 200.5 | 157.1 | 152.2 | 184.0 | 187.8 | 195.5 | 200.7 |
| (in ° F.) | | | | | | | | | |
| Temp. in zone 5 | 201.7 | 198.9 | 204.8 | 201.0 | 199.2 | 182.7 | 205.7 | 202.1 | 208.2 |
| (in ° F.) | | | | | | | | | |
| Temp. in zone 6 | 206.8 | 202.5 | 197.1 | 201.0 | 204.1 | 201.0 | 201.0 | 200.3 | 200.5 |
| (in ° F.) | | | | | | | | | |
| Temp. in zone 7 | 195.6 | 185.7 | 191.5 | 161.0 | 172.8 | 162.0 | 180.1 | 188.1 | 192.7 |
| (in ° F.) | | | | | | | | | |
| Temp. in zone 8 | 186.6 | 188.2 | 204.1 | 188.0 | 182.1 | 188.4 | 191.8 | 200.5 | 203.4 |
| (in ° F.) | | | | | | | | | |
| Temp. in zone 9 | 205.0 | 196.0 | 162.0 | 182.8 | 189.8 | 188.2 | 201.0 | 183.0 | 200.7 |
| (in ° F.) | | | | | | | | | |
| Temp. in zone 10 | 203.4 | 188.4 | 205.2 | 180.5 | 190.4 | 160.5 | 197.8 | 203.5 | 205.4 |
| (in ° F.) | | | | | | | | | |
| Lowest temp. | 186.6 | 185.7 | 162.0 | 157.1 | 152.2 | 160.5 | 180.1 | 183.0 | 192.7 |
| (in ° F.) | | | | | | | | | |
| Average temp. | 202.0 | 197.33 | 194.87 | 186.47 | 188.84 | 187.67 | 198.29 | 198.86 | 203.18 |
| (in ° F.) | | | | | | | | | |
| Temp. Pass/Fail | Pass | Pass | Fail | Fail | Fail | Fail | Pass | Pass | Pass |
| QCS Pass/Fail | Fail | Fail | Fail | Fail | Fail | Fail | Pass | Pass | Pass |

As shown in Table 31, at least one mac and cheese modular meal component sample that included mac and cheese sauce 1 and had a bottom sauce component placement (MMC 26: S3) was unable to reach a temperature of at least 165° F. when heated from frozen for 30 minutes at 425° F. As also shown in Table 31, at least one mac and cheese modular meal component sample that included mac and cheese sauce 1 and had a top sauce component placement (MMC 27: S1, S2, and S3) was unable to reach a temperature of at least 165° F. when heated from frozen for 30 minutes at 425° F. As further shown in Table 31, each mac and cheese modular meal component sample that included mac and cheese sauce 1 and had a mixed sauce component placement (MMC 28: S1, S2, and S3) was able to reach a temperature of at least 165° F. when heated from frozen for 30 minutes at 425° F. This indicates that having a mixed sauce component placement can provide suitable heating efficiency of a modular meal component.

Further, as shown in Table 31, at least one mac and cheese modular meal component sample that included mac and cheese sauce 1 and had a bottom sauce component placement (MMC 26: S1, S2, and S3) and at least one mac and cheese modular meal component sample that included mac and cheese sauce 1 and had a top sauce component placement (MMC 27: S1, S2, and S3) were unable to achieve a passing score for quality characteristics. In the mac and cheese modular meal component samples with a bottom sauce component placement, the pasta was dry and would not be considered “acceptable” to be eaten by a consumer. In the mac and cheese modular meal component samples with a top sauce component placement, the pasta had cold spots and would not be considered “acceptable” to be eaten by a consumer.

As also shown in Table 31, each mac and cheese modular meal component sample that included mac and cheese sauce 1 and had a mixed sauce component placement (MMC 28: S1, S2, and S3) was able to achieve a passing score for quality characteristics. This indicates that mac and cheese modular meal components can be configured and formulated to reach a temperature of at least 165° F. and have a passing score for quality characteristics.

The net weight, oven position, sauce component placement, initial temperature, temperature in each zone after heating, and the temperature pass/fail score for mac and cheese modular meal component samples MMC 29 through MMC 31 are shown in Table 32.

Each sample of MMC 29 through MMC 31 was also given a quality characteristics score on a pass/fail basis, indicating whether the mac and cheese in the modular meal component had acceptable texture and organoleptic properties. The quality characteristics score (“QCS pass/fail”) for each sample of MMC 29 through MMC 31 is also shown in Table 32.

TABLE 32

| | MMC 29 | | | MMC 30 | | | MCC 31 | | |
|---|---|---|---|---|---|---|---|---|---|
| | S1 | S2 | S3 | S1 | S2 | S3 | S1 | S2 | S3 |
| Net Weight (in g) | 675.1 | 676.1 | 676.1 | 680.7 | 682.7 | 680.5 | 680.9 | 681.7 | 680.6 |
| Oven position | Top | Top | Top | Top | Top | Top | Top | Top | Top |
| Sauce component | Bottom | Bottom | Bottom | Top | Top | Top | Mixed | Mixed | Mixed |
| placement | | | | | | | | | |
| Initial temp. | 9.1 | 8.1 | 8.5 | 8.0 | 7.1 | 6.1 | 9.0 | 8.6 | 8.8 |
| (in ° F.) | | | | | | | | | |
| Temp. in zone 1 | 203.4 | 198.9 | 203.5 | 203.2 | 205.5 | 204.6 | 206.8 | 200.8 | 206.8 |
| (in ° F.) | | | | | | | | | |
| Temp. in zone 2 | 201.5 | 201.6 | 204.1 | 194.0 | 195.3 | 196.5 | 207.1 | 182.1 | 196.5 |
| (in ° F.) | | | | | | | | | |
| Temp. in zone 3 | 195.4 | 197.8 | 206.2 | 202.5 | 177.1 | 195.6 | 207.8 | 202.6 | 205.6 |
| (in ° F.) | | | | | | | | | |
| Temp. in zone 4 | 200.8 | 193.3 | 197.1 | 33.0 | 89.0 | 143.5 | 186.1 | 197.4 | 151.0 |
| (in ° F.) | | | | | | | | | |
| Temp. in zone 5 | 184.8 | 197.4 | 200.1 | 189.3 | 196.2 | 182.0 | 204.1 | 203.4 | 189.4 |
| (in ° F.) | | | | | | | | | |
| Temp. in zone 6 | 190.8 | 189.0 | 200.1 | 190 | 200.0 | 194.9 | 203.8 | 171.0 | 185.5 |
| (in ° F.) | | | | | | | | | |
| Temp. in zone 7 | 180.7 | 199.9 | 196.4 | 131.0 | 137.8 | 171.0 | 191.3 | 161.5 | 201.4 |
| (in ° F.) | | | | | | | | | |
| Temp. in zone 8 | 198.0 | 196.3 | 182.3 | 185.4 | 186.8 | 190.2 | 193.1 | 170.8 | 175.5 |
| (in ° F.) | | | | | | | | | |
| Temp. in zone 9 | 196.0 | 196.9 | 198.5 | 182.5 | 194.0 | 196.7 | 200.3 | 173.6 | 192.0 |
| (in ° F.) | | | | | | | | | |
| Temp. in zone 10 | 202.0 | 205.7 | 190.2 | 185.7 | 186.3 | 180.3 | 196.5 | 186.0 | 187.4 |
| (in ° F.) | | | | | | | | | |
| Lowest temp. | 180.7 | 189.0 | 182.3 | 33.0 | 89.0 | 143.5 | 186.1 | 161.5 | 151.0 |
| (in ° F.) | | | | | | | | | |
| Average temp. | 195.34 | 197.68 | 197.85 | 169.66 | 176.8 | 185.53 | 199.69 | 184.92 | 189.11 |
| (in ° F.) | | | | | | | | | |
| Temp. Pass/Fail | Pass | Pass | Pass | Fail | Fail | Fail | Pass | Fail | Fail |
| QCS Pass/Fail | Fail | Fail | Fail | Fail | Fail | Fail | Fail | Fail | Fail |

As shown in Table 32, each mac and cheese modular meal component sample that included mac and cheese sauce 2 and had a bottom sauce component placement (MMC 29: S1, S2, and S3) was able to reach a temperature of at least 165° F. when heated from frozen for 30 minutes at 425° F. It was found that, while the mac and cheese modular meal component samples that included mac and cheese sauce 2 and had a bottom sauce component placement were able to reach a temperature of at least 165° F., they were not able to achieve a passing score for quality characteristics. The pasta was dry and would not be considered “acceptable” to be eaten by a consumer. This indicates that for some modular meal components a bottom sauce component placement may be undesirable even if the modular meal component is able to reach a temperature of at least 165° F.

As also shown in Table 32, at least one mac and cheese modular meal component sample that included mac and cheese sauce 2 and had a top sauce component placement (MMC 30: S1, S2, and S3) was unable to reach a temperature of at least 165° F. when heated from frozen for 30 minutes at 425° F. As further shown in Table 32, at least one mac and cheese modular meal component sample that included mac and cheese sauce 2 and had a mixed sauce component placement (MMC 31: S1, S2, and S3) was unable to reach a temperature of at least 165° F. when heated from frozen for 30 minutes at 425° F. Further, at least one mac and cheese modular meal component sample that included mac and cheese sauce 2 and had a top sauce component placement (MMC 30: S1, S2, and S3) and at least one mac and cheese modular meal component sample that included mac and cheese sauce 2 and had a mixed sauce component placement (MMC 31: S1, S2, and S3) were unable to achieve a passing score for quality characteristics. In these mac and cheese modular meal component samples, the pasta had cold spots and would not be considered “acceptable” to be eaten by a consumer.

As shown in Tables 31 and 32, each mac and cheese modular meal component sample that included mac and cheese sauce 1 and had a mixed sauce component placement was able to reach a temperature of at least 165° F., and the mac and cheese modular meal component samples that included mac and cheese sauce 2 and/or had a bottom or top sauce component placement were unable to reach a temperature of at least 165° F. and/or were unable to achieve a passing score for quality characteristics. As shown in Table 23, mac and cheese sauce 1 was more viscous and had higher total solids and higher sugar than mac and cheese sauce 2. It is believed that the higher total solids and higher sugar of mac and cheese sauce 1 caused mac and cheese sauce 1 to be more viscous and that the greater viscosity of mac and cheese sauce 1 enabled it conduct heat to the meal component better than the less viscous mac and cheese sauce 2. These results further indicate that formulating a sauce component to be more viscous can improve the heating efficiency of a modular meal component.

As shown in Table 23, mac and cheese sauce 1 also had higher total fat than mac and cheese sauce 2. It is believed that the higher total fat enabled mac and cheese sauce 1 to be less insulating and conduct more heat to the pasta. These results indicate that the fat content of a sauce component can be selected to improve the heating efficiency of a modular meal component.

The net weight, oven position, sauce component placement, initial temperature, temperature in each zone after heating, and the temperature pass/fail score for scalloped potatoes modular meal component samples MMC 32 through MMC 34 are shown in Table 33.

Each sample of MMC 32 through MMC 34 was also given a quality characteristics score on a pass/fail basis, indicating whether the scalloped potatoes in the modular meal component have acceptable texture and organoleptic properties. The quality characteristics score (“QCS pass/fail”) for each sample of MMC 32 through MMC 34 is also shown in Table 33.

TABLE 33

| | MMC 32 | | | MMC 33 | | | MCC 34 | | |
|---|---|---|---|---|---|---|---|---|---|
| | S1 | S2 | S3 | S1 | S2 | S3 | S1 | S2 | S3 |
| Net Weight (in g) | 564.0 | 563.8 | 564.5 | 562.7 | 563.9 | 564.3 | 562.5 | 562.2 | 562.8 |
| Oven position | Top | Top | Top | Top | Top | Top | Top | Top | Top |
| Sauce component | Top | Top | Top | Top and | Top and | Top and | Bottom | Bottom | Bottom |
| placement | | | | bottom | bottom | bottom | | | |
| | | | | split | split | split | | | |
| Initial temp. | 7.5 | 5.7 | 6.1 | 9.9 | 6.6 | 7.0 | 9.9 | 7.7 | 9.7 |
| (in ° F.) | | | | | | | | | |
| Temp. in zone 1 | 207.9 | 207.5 | 202.3 | 195.4 | 208.8 | 207.5 | 205.9 | 202.6 | 207.9 |
| (in ° F.) | | | | | | | | | |
| Temp. in zone 2 | 205.8 | 209.8 | 207.0 | 207.5 | 210.2 | 206.2 | 204.8 | 205.9 | 209.0 |
| (in ° F.) | | | | | | | | | |
| Temp. in zone 3 | 208.4 | 206.0 | 207.0 | 209.5 | 208.1 | 207.2 | 208.2 | 207.0 | 209.1 |
| (in ° F.) | | | | | | | | | |
| Temp. in zone 4 | 194.9 | 205.2 | 181.9 | 202.8 | 187.7 | 195.3 | 207.9 | 208.2 | 208.8 |
| (in ° F.) | | | | | | | | | |
| Temp. in zone 5 | 205.9 | 210.2 | 207.3 | 201.2 | 205.2 | 195.4 | 208.2 | 205.5 | 208.2 |
| (in ° F.) | | | | | | | | | |
| Temp. in zone 6 | 210.2 | 207.1 | 205.7 | 207.3 | 206.1 | 205.9 | 204.6 | 206.8 | 208.6 |
| (in ° F.) | | | | | | | | | |
| Temp. in zone 7 | 202.6 | 209.1 | 189.3 | 207.1 | 207.9 | 185.7 | 205.0 | 205.0 | 204.3 |
| (in ° F.) | | | | | | | | | |
| Temp. in zone 8 | 203.9 | 209.1 | 202.3 | 201.6 | 202.6 | 207.3 | 207.7 | 204.3 | 200.0 |
| (in ° F.) | | | | | | | | | |
| Temp. in zone 9 | 207.3 | 205.2 | 200.1 | 197.6 | 194.9 | 199.9 | 205.0 | 206.8 | 203.7 |
| (in ° F.) | | | | | | | | | |
| Temp. in zone 10 | 200.8 | 208.2 | 205.5 | 195.1 | 202.3 | 199.8 | 201.7 | 203.5 | 203.4 |
| (in ° F.) | | | | | | | | | |
| Lowest temp. | 194.9 | 205.2 | 181.9 | 195.1 | 187.7 | 185.7 | 201.7 | 202.6 | 200.0 |
| (in ° F.) | | | | | | | | | |
| Average temp. | 204.77 | 207.74 | 200.84 | 202.51 | 203.38 | 201.02 | 205.9 | 205.56 | 206.3 |
| (in ° F.) | | | | | | | | | |
| Temp. Pass/Fail | Pass | Pass | Pass | Pass | Pass | Pass | Pass | Pass | Pass |
| QCS Pass/Fail | Fail | Fail | Fail | Pass | Pass | Pass | Fail | Fail | Fail |

As shown in Table 33, each scalloped potatoes meal component sample was able to reach a temperature of at least 165° F. when heated from frozen for 30 minutes at 425° F. Each scalloped potatoes meal component sample was able to reach a temperature of at least 165° F. regardless of whether the sauce component had a top, top and bottom split, or bottom placement. It was found that, while the scalloped potatoes meal component samples that had a top sauce component placement (MMC 32: S1, S2, and S3) or a bottom sauce component placement (MMC 34: S1, S2, and S3) were able to reach a temperature of at least 165° F., they were not able to achieve a passing score for quality characteristics. The potatoes pieces were hard, tasted raw and would not be considered “acceptable” to be eaten by a consumer. This further indicates that for some modular meal components a top sauce component placement and/or a bottom sauce component placement may be undesirable even if the modular meal component is able to reach a temperature of at least 165° F.

Further, as shown in Table 33, each scalloped potatoes meal component sample that had a top and bottom split sauce component placement (MMC 33: S1, S2, and S3) was able to achieve a passing score for quality characteristics. This indicates that scalloped potatoes modular meal components can be configured and formulated to reach a temperature of at least 165° F. and have a passing score for quality characteristics.

### Example 7

Heating studies were performed to determine the effect of tray surface area on heating efficiency. The trays that were tested were a tray with a base surface area of 41 square inches (“41 sq. in. tray”), a tray with a base surface area of 55 square inches (“55 sq. in. tray”), and a tray with a base surface area of 75 square inches (“75 sq. in. tray”). Each tray had the same sidewall surface area. Each tray was an aluminum tray with a black and gold epoxy lacquer coating (AlucoatO CS, from Coppice Alupack Ltd.).

The ability of each tray to transfer heat to the meal component was tested by filling each tray with a uniform weight (the uniform weight being between 550 g and 700 g) and density of mashed potatoes, freezing the filled trays, and then heating the frozen trays, two at time, in a conventional oven at 425° F. The temperatures of the mashed potatoes in the trays were measured after certain time intervals of heating to generate a heating curve for each of the trays.

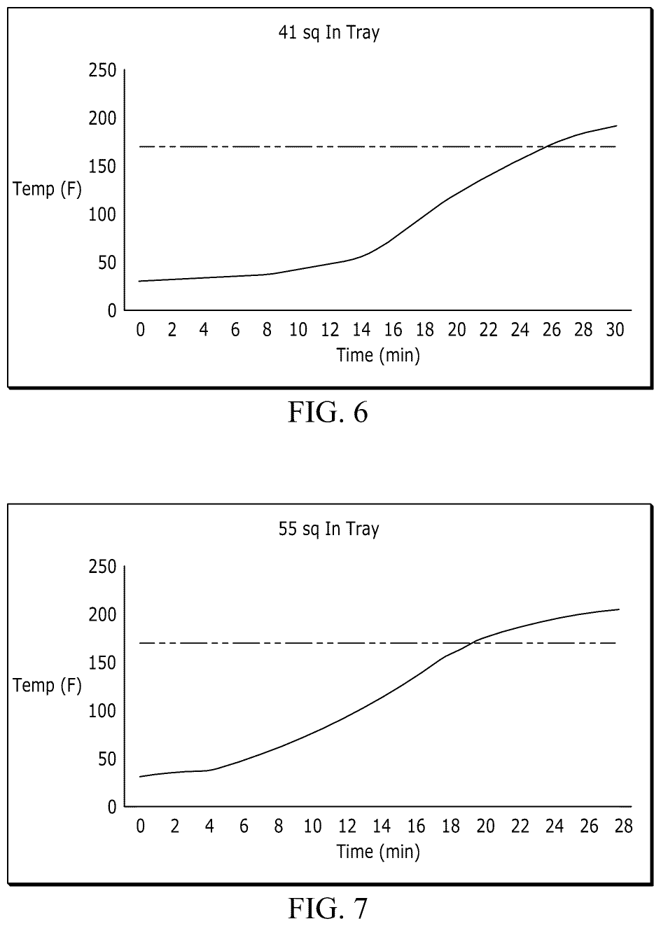

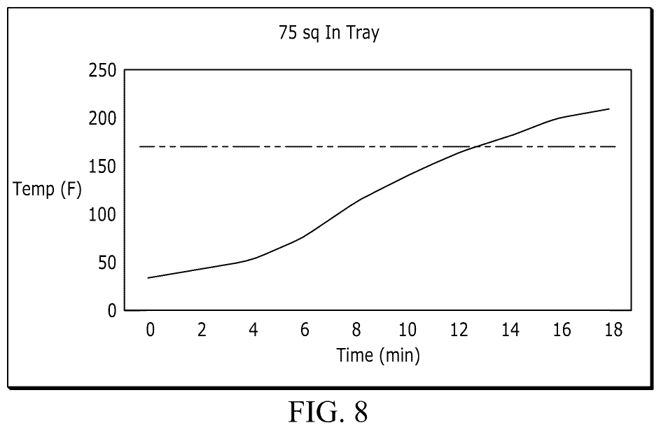

The heating curve of the 41 sq. in. tray is shown in FIG. 6. The heating curve of the 55 sq. in. tray is shown in FIG. 7. The heating curve of the 75 sq. in. tray is shown in FIG. 8. In each of FIG. 6 through FIG. 8, a horizontal phantom line denotes the temperature threshold of 170° F.

A heating rate for each of the trays was also determined and is shown in Table 34.

TABLE 34

| | Heating |
|---|---|
| | rate |
| Tray | (º F./minute) |
| 41 sq. in. tray | 12.3 |
| 55 sq. in. tray | 14.5 |
| 75 sq. in. tray | 21.8 |

As shown in FIG. 6 through FIG. 8 and in Table 34, a higher surface area resulted in more efficient transfer of heat to the mashed potatoes.

It is to be understood that the ranges provided herein include the stated range and any value or sub-range within the stated range. For example, a range of from about 20 minutes to about 60 minutes should be interpreted to include not only the explicitly recited limits of from about 20 minutes to about 60 minutes, but also to include individual values, such as 21.35 minutes, 25.5 minutes, 30 minutes, 32.75 minutes, 44 minutes, etc., and sub-ranges, such as from about 23 minutes to about 30.5 minutes, from about 28.5 minutes to about 32.7 minutes. from about 29.75 minutes to about 54 minutes, etc. Furthermore, when “about” is utilized to describe a value, this is meant to encompass minor variations (up to +/−10%) from the stated value. Moreover, when “substantially” is used to describe a characteristic or an amount of a component, this is meant to encompass minor variations (up to +/−5%) from the stated characteristic or amount.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1-20. (canceled)

21. A method of making a frozen modular meal system comprising a first modular meal component and a second modular meal component, the method comprising:
configuring and/or formulating the first and second modular meal components to each include a combination of a meal component and a sauce component that is capable of reaching at least 165° F. when heated from frozen for a heating time period within the range of from about 20 minutes to about 40 minutes and at a heating temperature within the range of about 350° F. to about 450° F.; and
making each of the first and second modular meal components by:
adding each of the meal component and the sauce component to a tray to form the modular meal component; and
freezing each of the modular meal components.

22. The method as defined in claim 21, wherein making each of the first and second modular meal components further comprises precooking each of the meal component and the sauce component.

23. The method as defined in claim 21, wherein making each of the first and second modular meal components further comprises hermetically sealing the meal component and the sauce component within the tray with a flexible film.

24. The method as defined in claim 21, wherein in each of the first and second modular meal components, the tray has:
a width within the range of about 5 inches to about 10 inches;
a length within the range of about 5 inches to about 8 inches; and
a depth within the range of about 1 inch to about 3 inches.

25. The method as defined in claim 21, wherein each of the first and second modular meal components are configured and/or formulated to reach at least 165° F. when heated from frozen in a conventional oven for a same heating time period within the range of from about 20 minutes to about 40 minutes and at a same heating temperature within the range of about 350° F. to about 450° F.

26. The method as defined in claim 21, wherein configuring and/or formulating the first and second modular meal components comprises formulating the at least two modular meal components to include 3 to 6 servings of the meal component

27. The method as defined in claim 21, wherein the method further comprises configuring and/or formulating a third modular meal component to include a combination of a meal component and a sauce component capable of reaching at least 165° F. when heated from frozen for a heating time period within the range of from about 20 minutes to about 40 minutes and at a heating temperature within the range of about 350° F. to about 450° F.

28. The method as defined in claim 21, wherein:
in at least one of the first and second meal components, the meal component comprises the protein component, and the protein component includes one or more of chicken, beef, pork, finfish, shellfish, or plant-based protein; or
in at least one of the first and second meal components, the meal component comprises the starch component, and the starch component includes one or more of potatoes, pasta, rice, or bread; or
in at least one of the first and second meal components, the meal component comprises the vegetable component, and the vegetable component includes one or more of broccoli, green beans, asparagus, corn, carrots, cauliflower, Brussel sprouts, or edamame.

29. A method of making a frozen modular meal system comprising a first, second, and third frozen modular meal component, the method comprising:
formulating the first modular meal component to include a combination of a first meal component and a first sauce component that is capable of reaching at least 165° F. when heated from frozen for a heating time period within the range of from about 20 minutes to about 40 minutes and at a heating temperature within the range of about 350° F. to about 450° F.;
formulating the second modular meal component to include a combination of a second meal component and a second sauce component that is capable of reaching at least 165° F. when heated for the same heating time period and the same heating temperature as the first modular meal component;
formulating the third modular meal component to include a combination of a third meal component and a third sauce component that is capable of reaching at least 165° F. when heated for the same heating time period and the same heating temperature as the first and second modular meal components;
preparing the first modular meal component by adding each of the first meal component and the first sauce component to a first tray to form the first modular meal component;
preparing the second modular meal component by adding each of the second meal component and the second sauce component to a second tray to form the second modular meal component;
preparing the third modular meal component by adding each of the third meal component and the third sauce component to a third tray to form the third modular meal component; and
freezing the first, second, and third modular meal components.

30. The method as defined in claim 29, wherein the heating time period for the first modular meal component is about 25 to about 35 minutes and the heating temperature is about 350° F. to about 450° F.

31. The method as defined in claim 29, wherein making each of the first, second, and third modular meal components further comprises precooking each of the meal component and the sauce component.

32. The method as defined in claim 29, wherein preparing each of the first, second, and third modular meal components further comprises hermetically sealing the meal component and the sauce component within the tray with a flexible film.

33. The method as defined in claim 29, wherein in each of the first, second, and third modular meal components, the tray has:
a width within the range of about 5 inches to about 10 inches;
a length within the range of about 5 inches to about 8 inches; and
a depth within the range of about 1 inch to about 3 inches.

34. The method as defined in claim 29, wherein at least two of the first, second, and third modular meal components are formulated to include 3 to 6 servings of the meal component

35. The method as defined in claim 29, wherein:
in at least one of the first, second, and third modular meal components, the meal component comprises the protein component, and the protein component includes one or more of chicken, beef, pork, finfish, shellfish, or plant-based protein; or
in at least one of the first, second, and third modular meal components, the meal component comprises the starch component, and the starch component includes one or more of potatoes, pasta, rice, or bread; or
in at least one of the first, second, and third modular meal components, the meal component comprises the vegetable component, and the vegetable component includes one or more of broccoli, green beans, asparagus, corn, carrots, cauliflower, Brussel sprouts, or edamame.

36. The method as defined in claim 29, wherein:
in one of the first, second, and third modular meal components, the meal component comprises the protein component, and the protein component includes one or more of chicken, beef, pork, finfish, shellfish, or plant-based protein;
in one of the first, second, and third modular meal components, the meal component comprises the starch component, and the starch component includes one or more of potatoes, pasta, rice, or bread; and
in one of the first, second, and third modular meal components, the meal component comprises the vegetable component, and the vegetable component includes one or more of broccoli, green beans, asparagus, corn, carrots, cauliflower, Brussel sprouts, or edamame.

37. The method as defined in claim 29, wherein in at least one of the first, second, and third frozen modular meal components, the sauce component includes a cheese sauce, a marinara sauce, a sweet and sour sauce, a barbeque sauce, a gravy, a tartar sauce, a mushroom sauce, a pesto sauce, a cream sauce, a fajita sauce, a teriyaki sauce, milk, honey, oil, butter, lemon juice, lime juice, or a combination thereof.

38. The method as defined in claim 29, wherein the total solids content, total fat content, and viscosity of the first sauce component are different from the total solids content, total fat content, and viscosity of the second sauce component.
